(19) United States
(12) Patent Application Publication
(10) Pub. No.: US 2017/0083889 A1
(43) Pub. Date: Mar. 23, 2017

(54) USER EQUIPMENT, SERVICE PROVIDING DEVICE, POS TERMINAL, PAYMENT SYSTEM INCLUDING THE SAME, CONTROL METHOD THEREOF, AND NON-TRANSITORY COMPUTER READABLE STORAGE MEDIUM STORING COMPUTER PROGRAM RECORDED THEREON

(71) Applicant: SK Planet Co., Ltd., Seongnam-si (KR)

(72) Inventor: Sebyung KWAK, Seoul (KR)

(21) Appl. No.: 15/261,064

(22) Filed: Sep. 9, 2016

(30) Foreign Application Priority Data
Sep. 21, 2015 (KR) 10-2015-0133416
Sep. 21, 2015 (KR) 10-2015-0133417
Sep. 21, 2015 (KR) 10-2015-0133418
Oct. 23, 2015 (KR) 10-2015-0147766
Nov. 23, 2015 (KR) 10-2015-0163843

(51) Int. Cl. G06Q 20/20; G06Q 20/38; G06Q 20/32; G06Q 20/34

(52) U.S. Cl. CPC G06Q 20/204; G06Q 20/34; G06Q 20/382; G06Q 20/3223; H04W 4/14

(57) ABSTRACT

Provided are user equipment, a service providing device, a POS terminal, a payment system including the same, a control method thereof, and a non-transitory computer readable storage medium storing a computer program recorded thereon. According to the present invention, when the partial payment is performed, an allotment is collected through a temporary account from participants who participate the partial payment, the representative payer performs the payment function through a carried user equipment when all required allotments are collected, and then when the payment function is normally performed, the representative payer provides the previously collected allotment to the user equipment, and distributes the previously generated points in accordance with the allotment for every participant when the point is generated in accordance with performing of the payment function, thereby invigorating the partial payment service.

### CROSS-REFERENCE TO RELATED APPLICATION

This application claims the benefit of Korean Application Nos. 10-2015-0133416, 10-2015-0133417 and 10-2015-0133418 filed on Sep. 21, 2015, Korean Application No. 10-2015-0147766 filed on Oct. 23, 2015 and Korean Application No. 10-2015-0163843 filed on Nov. 23, 2015 with the Korean Intellectual Property Office, the disclosure of which is incorporated herein by reference.

### BACKGROUND OF THE INVENTION

1. Field of the Invention

The present invention relates to user equipment, a service providing device, a POS terminal, a payment system including the same, a control method thereof, and a non-transitory computer readable storage medium storing a computer program recorded thereon. Specifically, the present invention relates to user equipment, a service providing device, a POS terminal, a payment system including the same, a control method thereof, and a non-transitory computer readable storage medium storing a computer program recorded thereon which collect allotments through temporary account from participants which participate a partial payment at the time of performing partial payment, performs a payment function through user equipment processed by a representative payer when all necessary allotments are collected and then provide the previously collected allotments to the user equipment processed by the representative payer when the payment function is normally performed, and distribute previously generated points in accordance with the allotments for every participant when a point is generated in accordance with the performing of the payment function.

2. Description of the Related Art

Even though various Dutch-pay related applications are appearing. According to most of the applications, targets who want to participate are individually selected and then an allotment of a total payment amount which is paid by an individual participant is input. Alternatively, equally divided allotment is designated and individual participants pay own allotments through terminals which are carried by individual participants.

However, according to the above-described method, a Dutch pay method of the related art which simply collects the cash to pay the bill is used using a terminal. Further, a POS terminal also supports the partial payment so that needs to use the service through a complicated manipulation are low.

When the individual allotments are provided through the Dutch pay, a personal payment amount is so small so that it does not reach a reference amount for taking a discount or an accumulation benefit according to usage of a payment means. Therefore, the situation when the discount or the benefit cannot be received frequently occurs so that an opportunity of lowering a total payment amount is lost.

Therefore, a partial payment method by which a payment by one of partial payment participants who may have an optimal discount benefit for the total payment amount makes a payment as a representative payer and then the remaining participants provide their allotments to the representative payer has been discussed. However, in this case, the payment is personal payment between the representative payer and participants, rather than payment between an actual seller and participants so that the above-described payment may not be performed. Further, various payment means are used, so that a service providing device does not manage the payment situation. Furthermore, the representative payer may have all the points generated as a result of the payment.

Further, in the case of the above-described Dutch treat method, a non-subscriber which does not subscribe the partial payment service or an electronic wallet service which interlocks with the partial payment service cannot be a participant of the partial payment so that the partial payment service may not be widely used.

### RELATED ART DOCUMENT

### Patent Document

Korean Unexamined Patent Application Publication No. 10-2013-0089896 (entitled: Portable terminal including Dutch payment function, payment terminal, and payment agency server, payment method and payment agency method using the same)

### SUMMARY OF THE INVENTION

An object of the present invention is to provide user equipment, a service providing device, a POS terminal, a payment system including the same, a control method thereof, and a non-transitory computer readable storage medium storing a computer program recorded thereon which allow a representative payer to make a payment using user equipment carried by the representative payer when partial payment is performed and then remaining participants to accurately provide allotments to the representative payer and also allow a user who is not a member of the related service to participate the partial payment.

Another object of the present invention is to provide user equipment, a service providing device, a POS terminal, a payment system including the same, a control method thereof, and a non-transitory computer readable storage medium storing a computer program recorded thereon which divide points generated according to representative payment to transmit the divided points to the participants.

Another object of the present invention is to provide user equipment, a service providing device, a POS terminal, a payment system including the same, a control method thereof, and a non-transitory computer readable storage medium storing a computer program recorded thereon which allow remaining participants for representative payment of partial payment to transmit allotments to a temporary account prior to actual payment and transmit the collected total allotments to a representative payer when the representative payer actually makes a payment.

Another object of the present invention is to provide user equipment, a service providing device, a POS terminal, a payment system including the same, a control method thereof, and a non-transitory computer readable storage medium storing a computer program recorded thereon which allow a service providing device including payment means information for a user who participates partial payment to recommend an optimal partial payment method in consideration of a benefit for every payment means and an allotment for every participant when the partial payment is performed.

Another object of the present invention is to provide user equipment, a service providing device, a POS terminal, a payment system including the same, a control method thereof, and a non-transitory computer readable storage medium storing a computer program recorded thereon which readjust an allotment for every participant which is set in advance according to payment means related with a plurality of user equipment which participates partial payment when partial payment is performed or allow one or more user equipment which is a representative payer to make a payment as a representative and allow the remaining participants to transmit allotments (or adjusted allotments) to which a discounted amount is applied to the one or more user equipment which is the representative payer.

Another object of the present invention is to provide user equipment, a service providing device, a POS terminal, a payment system including the same, a control method thereof, and a non-transitory computer readable storage medium storing a computer program recorded thereon which when a user who carries user equipment visits a store, provide a check-in service for visiting the store by a service providing device, and when all user equipment of a group including the user equipment visit the store, perform a product recommending function, a promotion information providing function based on previous purchase records of the group.

Another object of the present invention is to provide user equipment, a service providing device, a POS terminal, a payment system including the same, a control method thereof, and a non-transitory computer readable storage medium storing a computer program recorded thereon which effectively select participants which participate partial payment among information on users who actually visit the store when partial payment is performed.

Another object of the present invention is to provide user equipment, a service providing device, a POS terminal, a payment system including the same, a control method thereof, and a non-transitory computer readable storage medium storing a computer program recorded thereon which display information on one or more user equipment on a phone book of the user equipment among a plurality of user equipment which is in a check-in status in a store when partial payment is performed, register the user equipment as partial payment participants for partial payment by interlocking with at least one user equipment selected from one or more displayed user equipment, collect an allotment for every participant from users who participate the partial payment when the partial payment is performed in a service providing device, collects payment means information which is issued in advance for every user equipment which is a user, and perform a payment function according to the allotment for every participant and payment means information for every participant by interlocking with the user equipment, a POS terminal, and a payment server.

Another object of the present invention is to provide user equipment, a service providing device, a POS terminal, a payment system including the same, a control method thereof, and a non-transitory computer readable storage medium storing a computer program recorded thereon which quickly recognize a partial payment situation when an offline payment is performed through a mobile terminal to provide a partial payment service to a user.

Another object of the present invention is to provide user equipment, a service providing device, a POS terminal, a payment system including the same, a control method thereof, and a non-transitory computer readable storage medium storing a computer program recorded thereon which allow all users who participate partial payment when offline payment is performed to easily perform partial payment only by authentication using each mobile terminal without directly making a payment through a POS.

Another object of the present invention is to provide user equipment, a service providing device, a POS terminal, a payment system including the same, a control method thereof, and a non-transitory computer readable storage medium storing a computer program recorded thereon which primarily perform authentication through a mobile on members who perform partial payment and perform additional authentication on a part of the members in a POS, to safely performing offline partial payment.

According to an aspect of the present invention, a payment system includes a POS terminal which transmits information on one or more products to be paid and identification information of the POS terminal when partial payment for one or more products is performed; a service providing device which performs partial payment participating registration result for a plurality of user equipment which participates partial payment, creates a temporary account for partial payment, sets an allotment for every participant based on a total payment amount for one or more products to be paid and the number of the plurality of user equipment which participate the partial payment, and transmits the allotment for every participant and information on the temporary account to the plurality of user equipment which participates the partial payment; and a plurality of user equipment which transmits the allotment set for every participant to the temporary account based on the allotment for every participant and the information on the temporary account transmitted from the service providing device.

In an embodiment of the present invention, the temporary account may be an account through which predetermined points commonly used in a plurality of predetermined sites are received, an account through which cash is transferred, and an account through which points and/or cash are received.

In an embodiment of the present invention, the allotment for every participant may be set any one of an equally splitting method, a method for registering for every user equipment at the time of partial payment participating registration, and a method for setting for every user equipment after checking an actual payment amount.

In an embodiment of the present invention, the service providing device may transmit the information on the allotment for every participant and the temporary account to the user equipment which is not a member of the service providing device in the form of a text message, based on identification information of the user equipment corresponding to the non-member.

In an embodiment of the present invention, the allotment may include at least one of points available in a predetermined specific site and cash.

In an embodiment of the present invention, when all actual payment amount is collected to the temporary account, the service providing device may transmit one or more benefit information, a recommended card list including one or more recommended cards, one or more product information to be paid, and an actual payment amount to the payment representing user equipment which is set from the plurality of user equipment, and the payment representing user equipment may receive a payment card type in accordance with user input and a PIN number corresponding to the payment card type the payment card type and transmits the payment card type, the PIN number, and identification information of the payment representing user equipment.

In an embodiment of the present invention, the service providing device may check the card information corresponding to the PIN number transmitted from the payment representing user equipment, user information, and benefit information, transmits the one or more product information to be paid, the actual payment amount, the card information corresponding to the PIN number, the user information, and the benefit information, and the payment server performs a payment function on the actual payment amount corresponding to one or more product information to be paid based on the card information, the user information, and the benefit information and transmit a payment function performed result and accumulated points accumulated in accordance with performing of the payment function to the service providing device.

In an embodiment of the present invention, the service providing device may transmit the payment function performed result to the plurality of user equipment which participates the partial payment and distribute the accumulated points based on the allotment for every participant when accumulated points accumulated in accordance with the performing of the payment function are generated.

According to another aspect of the present invention, a control method includes: transmitting information on one or more products to be paid and identification information of a POS terminal when partial payment for one or more products is performed, by means of the POS terminal; performing a partial payment participating registration procedure by interlocking with a service providing device, by means of a plurality of user equipment; creating a temporary account for partial payment, by means of the service providing device; setting an allotment for every participant, based on a total payment amount for one or more products to be paid and the number of a plurality of user equipment which participates partial payment, by means of the service providing device; transmitting the allotment for every participant and information of the temporary account to the plurality of user equipment which participates partial payment, by means of the service providing device; and transmitting the allotment set for every participant to the temporary account based on the allotment for every participant and the information on the temporary account by means of the plurality of user equipment.

In an embodiment of the present invention, the method may further include: when all actual payment amount is collected to the temporary account, transmitting one or more benefit information, a recommended card list including one or more recommended cards, one or more product information to be paid, and an actual payment amount to the payment representing user equipment which is set from the plurality of user equipment, by means of the service providing device, and receiving a payment card type in accordance with user input and a PIN number corresponding to the payment card, by means of the payment representing user equipment; transmitting the payment card type, the PIN number, and identification information of the payment representing user equipment, by the payment representing user equipment; checking the card information corresponding to the PIN number transmitted from the representative user equipment, user information, and benefit information, by means of the service providing device; transmitting one or more product information to be paid, the actual payment amount, the card information corresponding to the PIN number, the card information, the user information, and the benefit information, by means of the service providing device; performing a payment function on the actual payment amount corresponding to the product information to be paid based on the card information, the user information, and the benefit information, by means of the payment server; transmitting a payment function performed result and accumulated points accumulated in accordance with performing of a payment function to the service providing device, by means of the payment server; transmitting the payment function performed result to the plurality of user equipment which participates the partial payment, by means of the service providing device; providing the collected actual payment amount to the representative payment user equipment, by means of the service providing device; and distributing the accumulated points based on the allotment for every participants when accumulated points accumulated in accordance with performing of a payment function is generated, by means of the service providing device.

According to another aspect of the present invention, a computer program executing the methods according to the aforementioned embodiments may be stored in a non-transitory computer readable storage medium storing a computer program recorded thereon.

According to the present invention, it is possible to allow a representative payer to make a payment using user equipment carried by the representative payer when partial payment is performed and then remaining participants to accurately provide allotments to the representative payer and also allow a user who is not a member of the related service to participate the partial payment. Therefore, the partial payment service may be invigorated.

According to the present invention, it is possible to divide points generated according to representative payment to transmit the divided points to the participants, so that all participants who participate the partial payment satisfy.

According to the present invention, it is possible to allow remaining participants for representative payment of partial payment to transmit allotments to a temporary account prior to actual payment and transmit the collected total allotments to a representative payer when the representative payer actually makes a payment. Therefore, the usage of the partial payment may be promoted.

According to the present invention, it is possible to allow a service providing device including payment means information for a user who participates partial payment to recommend an optimal partial payment method in consideration of a benefit for every payment means and an allotment for every participant when the partial payment is performed. Therefore, actual payment cost discount benefit may be achieved and satisfaction of the user may be enhanced.

According to the present invention, it is possible to readjust an allotment for every participant which is set in advance according to payment means related with a plurality of user equipment which participates partial payment when partial payment is performed or allow one or more user equipment which is a representative payer to make a payment as a representative and allow the remaining participants to transmit allotments (or adjusted allotments) to which a discounted amount is applied to the one or more user equipment which is the representative payer. Therefore, a benefit which may not be allowed when the allotment for every participant is distributed may be provided.

According to the present invention, when a user who carries user equipment visits a store, provide a check-in service for visiting the store by a service providing device, and when all user equipment of a group including the user equipment visit the store, perform a product recommending function, a promotion information providing function based on previous purchase records of the group. Therefore, not only the personal check-in status, but also a group heck-in status is checked to perform the group check-in so that a separate service for the group is provided, thereby increasing a marketing effect and increasing a convenience and satisfaction of the user.

According to the present invention, it is possible to effectively select participants which participate partial payment among information on users who actually visit the store when partial payment is performed, so that participants of the partial payment service may be easily selected.

According to the present invention, it is possible to display information on one or more user equipment on a phone book of the user equipment among a plurality of user equipment which is in a check-in status in a store when partial payment is performed, register the user equipment as partial payment participants for partial payment by interlocking with at least one user equipment selected from one or more displayed user equipment, collect an allotment for every participant from users who participate the partial payment when the partial payment is performed in a service providing device, collects payment means information which is issued in advance for every user equipment which is a user, and perform a payment function according to the allotment for every participant and payment means information for every participant by interlocking with the user equipment, a POS terminal, and a payment server. Therefore, a user in the phone book of the user equipment among the users who visit the store and other user located in the same beacon area are filtered so that the number of user lists is reduced so that it is easy to select the participants.

According to the present invention, it is possible to quickly recognize a partial payment situation when an offline payment is performed through a mobile terminal to provide a partial payment service to a use. Therefore, it is possible to provide the partial payment service to the user.

According to the present invention, it is possible to allow all users who participate partial payment when offline payment is performed to easily perform partial payment only by authentication using each mobile terminal without directly making a payment through a POS.

According to the present invention, it is possible to primarily perform authentication through a mobile on members who perform partial payment and perform additional authentication on a part of the members in a POS, to safely performing offline partial payment,

### BRIEF DESCRIPTION OF DRAWINGS

FIG. 1 is a block diagram illustrating a configuration of a payment system according to an exemplary embodiment of the present invention.

FIG. 2 is a block diagram illustrating a configuration of user equipment according to an exemplary embodiment of the present invention.

FIG. 3 is a block diagram illustrating a configuration of a payment system according to another exemplary embodiment of the present invention.

FIGS. 4 and 5 are flow charts illustrating a control method of a payment system according to a first exemplary embodiment of the present invention.

FIGS. 6 and 7 are views illustrating a screen of user equipment according to an exemplary embodiment of the present invention.

FIGS. 8 and 9 are flow charts illustrating a control method of a payment system according to a second exemplary embodiment of the present invention.

FIG. 10 is a view illustrating a screen of user equipment according to an exemplary embodiment of the present invention.

FIGS. 11 and 12 are flow charts illustrating a control method of a payment system according to a third exemplary embodiment of the present invention.

FIG. 13 is a view illustrating a screen of user equipment according to an exemplary embodiment of the present invention.

FIGS. 14 and 15 are flow charts illustrating a control method of a payment system according to a fourth exemplary embodiment of the present invention.

FIGS. 16 and 17 are views illustrating a screen of user equipment according to an exemplary embodiment of the present invention.

FIGS. 18 and 20 are flow charts illustrating a control method of a payment system according to a fifth exemplary embodiment of the present invention.

FIGS. 21 and 22 are views illustrating a screen of user equipment according to an exemplary embodiment of the present invention.

FIG. 23 is a block diagram illustrating an offline payment system using an application payment.

FIGS. 24 to 28 are views illustrating a payment proceeding screen using an offline payment system illustrated in FIG. 23.

FIG. 29 is a block diagram illustrating an offline partial payment processing device according to an exemplary embodiment of the present invention.

FIG. 30 is a block diagram illustrating a mobile terminal according to an exemplary embodiment of the present invention.

FIG. 31 is a view illustrating a partial payment recommendation screen according to an exemplary embodiment of the present invention.

FIG. 32 is a view illustrating a mobile authentication screen when partial payment is performed according to an exemplary embodiment of the present invention.

FIG. 33 is a flowchart illustrating an offline partial payment processing method according to a sixth exemplary embodiment of the present invention from a service side.

FIG. 34 is a flowchart illustrating an offline partial payment processing method according to a seventh exemplary embodiment of the present invention from a terminal side.

FIG. 35 is a detailed flowchart illustrating an offline partial payment processing method according to an eighth exemplary embodiment of the present invention from a server side.

### DETAILED DESCRIPTION OF THE PREFERRED EMBODIMENTS

It is noted that technical terms used in the present invention are used to just describe a specific embodiment and do not intend to limit the present invention. Further, if the technical terms used in the present invention are not particularly defined as other meanings in the present invention, the technical terms should be appreciated as meanings generally appreciated by those skilled in the art and should not be appreciated as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

In addition, singular expressions used in the present invention include plurals expressions unless they have definitely opposite meanings. In the present invention, it should not analyzed that a term such as “comprising” or “including” particularly includes various components or various steps disclosed in the specification and some component or some steps among them may be not included or additional components or steps may be further included.

In addition, terms including ordinal numbers, such as ‘first’ and ‘second’, used in the present invention can be used to describe various components, but the components should not be limited by the terms. The above terms are used only to discriminate one component from the other components. For example, a first component may be named a second component and similarly, the second component may also be named the first component, without departing from the scope of the present invention.

Hereinafter, preferable exemplary embodiment of the present invention will be described in more detail with reference to the accompanying drawings. Like reference numerals refer to like elements for easy overall understanding and a duplicated description of like elements will be omitted.

Further, in the following description, a detailed explanation of known related technologies may be omitted to avoid unnecessarily obscuring the subject matter of the present invention. Further, it is noted that the accompanying drawings are only for easily understanding the spirit of the present invention and it should not be interpreted that the spirit of the present invention is limited by the accompanying drawings.

Hereinafter, exemplary embodiments according to the present disclosure will be described in detail with reference to the accompanying drawings, and the same or similar components are denoted by the same reference numerals regardless of reference numerals, and repeated description thereof will be omitted.

In describing the present disclosure, when it is determined that a detailed description of a related publicly known technology may obscure the gist of the present disclosure, the detailed description thereof will be omitted. Further, it is noted that the accompanying drawings are used just for easily appreciating the spirit of the present disclosure and it should not be interpreted that the spirit of the present disclosure is limited by the accompanying drawings.

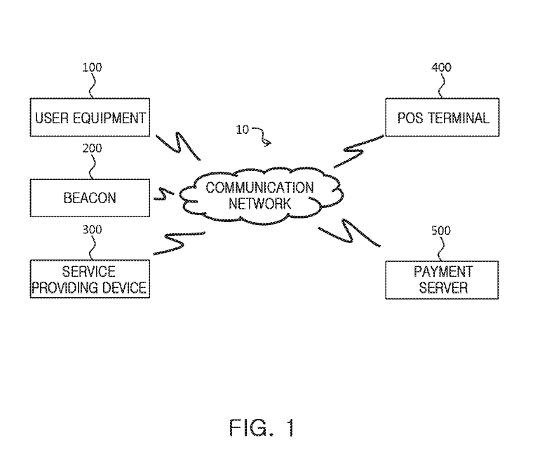

FIG. 1 is a block diagram illustrating a configuration of a payment system 10 according to an exemplary embodiment of the present invention.

As illustrated in FIG. 1, a payment system 10 is configured by user equipment 100, a beacon 200, a service providing device 300, a POS terminal 400, and a payment server 500. However, all the components of the payment system 10 illustrated in FIG. 1 are not essential components, but the payment system 10 may be implemented by more components or less components than the components illustrated in FIG. 1.

When user equipment 100 which maintains a check-in state in a store equipped with a beacon 200 performs a partial payment function, the user equipment 100 displays identification information of a plurality of user equipment 100 which checks in the store, transmitted from a service providing device 300. Next, when at least one other user equipment 100 is selected among identification information of the plurality of user equipment 100 displayed on the user equipment 100, the other user equipment registers as a partial payment participant for partial payment through a partial payment participant registration room created in the service providing device 300 by interlocking the user equipment 100, at least one other user equipment 100, and the service providing device 300. Next, after normally performing the partial payment participant registration process, the service providing device 300 checks a payment card type related with a plurality of user equipment 100 which participates the partial payment, a PIN number, identification information of the user equipment 100, a total payment amount for one or more products or services selected by a user of the user equipment 100, and information on one or more products or services to be paid by interlocking with the POS terminal 400. Next, the service providing device 300 transmits information on one or more products or services to be paid, an allotment for every participant, card information (or card information for every user equipment) corresponding to a PIN number for every user equipment, user information (or user information for every user equipment), or benefit information (or benefit information for every user equipment) to the payment server 500 to perform partial payment. Next, the payment server 500 performs a payment function for a payment amount corresponding to the allotment for every participant for every user equipment which participates the partial payment based on the information transmitted from the service providing device 300 and provides a payment function performing result for every user equipment to the plurality of user equipment 100 which participates the partial payment through the service providing device 300.

The user equipment 100 may be applied to various terminals such as a smart phone, a portable terminal, a mobile terminal, a personal digital assistant (PDA), a portable multimedia player (PMP) terminal, a telematics terminal, a navigation terminal, a personal computer, a notebook computer, a slate PC, a tablet PC, an Ultrabook, a wearable device (for example, including a smart watch, a smart glass, or a head mounted display (HMD)), a Wibro terminal, an internet protocol television (IPTV) terminal, a smart TV, a digital broadcasting terminal, a television, a 3D television, a home theater system, an audio video navigation (AVN) terminal, an audio/video (A/V) system, or a flexible terminal.

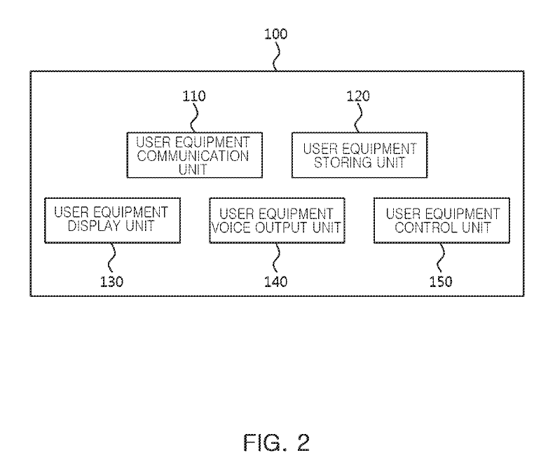

As illustrated in FIG. 2, the user equipment 100 is configured by a user equipment communication unit 110, a user equipment storing unit 120, a user equipment display unit 130, a user equipment voice output unit 140, and a user equipment control unit 150. However, all the components of the user equipment 100 illustrated in FIG. 2 are not essential components, but the user equipment 100 may be implemented by more components or less components than the components illustrated in FIG. 2.

The user equipment communication unit 110 connects an arbitrary internal component with at least one arbitrary external terminal through a wired/wireless communication network to communicate each other. In this case, the arbitrary external terminal may include the beacon 200, the service providing device 300, the POS terminal 400, and the payment server 500. Here, a wireless internet technique includes wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS). The user equipment communication unit 110 transmits and receives data in accordance with at least one wireless Internet technique within a range including also Internet techniques which are not described above. Further, a short range communication technology may include Bluetooth, RFID (radio frequency identification), IrDA (infrared data association), UWB (ultra-wideband), ZigBee, NFC (near field communication), USC (ultra sound communication), VLC (visible light communication), Wi-Fi, Wi-Fi direct or the like. Furthermore, the wired communication technique may include power line communication (PLC), USB communication, Ethernet, serial communication, an optical/coaxial cable, or the like.

The user equipment communication unit 110 may transmit information with any terminal through a universal serial bus (USB).

The user equipment communication unit 110 transmits and receives a wireless signal to and from a base station, the beacon 200, the service providing device 300, the POS terminal 400, and the payment serve 500 on a mobile communication network built according to technical standards for mobile communication or communication schemes (for example, global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), or the like).

Further, the user equipment communication unit 110 receives identification information (or unique identification information of a store provided with the beacon 200) of the beacon 200 which is transmitted from the beacon 200, by the control of the user equipment control unit 150.

The user equipment storing unit 120 stores various user interfaces UI and graphic user interfaces GUI.

Further, the user equipment storing unit 120 stores data and programs required to operate the user equipment 100.

That is, the user equipment storing unit 120 may store a plurality of application programs (or applications) which are driven in the user equipment 100 and data and commands for operation of the user equipment 100. At least some of the application programs may be downloaded from an external service providing device through wireless communication. Further, at least some of the application programs may be provided on the user equipment 100 since a releasing time in order to support a basic function (for example, phone call receiving and sending functions, message receiving and transmitting functions) of the user equipment 100. In the meantime, the application program is stored in the user equipment storing unit 120 and provided in the user equipment 100 to be driven to perform an operation (or a function) of the user equipment 100 by the user equipment control unit 150.

Further, the user equipment storing unit 120 may include at least one storing medium of a flash memory type, a hard disk type, a multimedia card micro type, a card type memory (for example, an SD or XD memory), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM). Further, the user equipment 100 may operate a web storage which performs a storing function of the user equipment storing unit 120 on the Internet or operate in association with the web storage.

Further, the user equipment storing unit 120 stores identification information (or unique identification information of a store provided with the beacon 200) of the beacon 200 which is received through the user equipment communication unit 110, by the control of the user equipment control unit 150.

The user equipment display device 130 may display various contents such as various menu screens using a user interface and/or graphic user interface stored in the user equipment storing unit 120, by the control of the user equipment control unit 150. Here, the contents displayed on the user equipment display unit 130 may include a menu screen including various texts, image data (including various information data), and data such as icons, list menus, or a combo boxes. The user equipment display unit 130 may be a touch screen.

Further, the user equipment display unit 130 may include at least one of a liquid crystal display (LCD), a thin film transistor liquid crystal display (TFT LCD), an organic light emitting diode (OLED), a flexible display, a field emission display (FED), a three dimensional display (3D display), an e-ink display, and a light emitting diode (LED).

Further, the user equipment display unit 130 may be configured as a stereoscopic display unit which displays a stereoscopic image.

A 3D display scheme such as a stereoscopic type (a glass type), an auto stereoscopic type (a glassless type), or a projection scheme (a holographic type) may be applied to the stereoscopic display unit.

Further, the user equipment display unit 130 displays identification information (or unique identification information of a store provided with the beacon 200) of the beacon 200 which is received through the user equipment communication unit 110, by the control of the user equipment control unit 150.

The user equipment voice output unit 140 outputs voice information included in a signal processed by the user equipment control unit 150. Here, the user equipment voice output unit 140 may include a receiver, a speaker, a buzzer, and the like.

Further, the user equipment voice output unit 140 outputs a guide voice generated by the user equipment control unit 150.

Further, the user equipment voice output unit 140 outputs voice information corresponding to identification information (or unique identification information of a store provided with the beacon 200) of the beacon 200 which is received through the user equipment communication unit 110, by the control of the user equipment control unit 150.

The user equipment control unit 150 performs an overall control function of the user equipment 100.

The user equipment control unit 150 performs an overall control function of the user equipment 100 using a program and data stored in the user equipment storing unit 120. The user equipment control unit 150 may include a RAM, a ROM, a CPU, a GPU, and a bus and the RAM, the ROM, the CPU, and the GPU are connected to each other through the bus. The CPU accesses the user equipment storing unit 120 to perform booting using an O/S stored in the user equipment storing unit 120 and performs various operations using various programs, contents, and data stored in the user equipment storing unit 120.

Further, the user equipment control unit 150 interlocks with the service providing device 300 to perform a member joining procedure for the user of the user equipment 100.

When the member joining procedure is performed, the user equipment control unit 150 normally completes the member joining procedure for the service providing device 300 only by completing the authentication function through a self-authentication unit (for example, including a mobile phone, a credit card, I-PIN, e-mail, and the like).

Further, when a user who carries the user equipment 100 enters a store, the user equipment control unit 150 controls the user equipment communication unit 110 to receive the identification information (or unique identification information of a store provided with the beacon 200) of the beacon 200 transmitted from the beacon 200.

Further, the user equipment control unit 150 transmits the received unique identification information of the beacon 200 (or the unique identification information of a store provided with the beacon 200) and identification information of the user equipment 100 to the service providing device 300 through the user equipment communication unit 110. Here, the identification information of the user equipment 100 includes a mobile directory number (MDN), a mobile IP, a mobile MAC, a subscriber identify module (Sim) card unique information, and a serial number.

Further, when a user of the user equipment control unit 150 is not a member who is registered in advance in the service providing device 300, the user equipment control unit 150 performs the member joining procedure for the user equipment 100 (or a user of the user equipment 100) based on guide information related with the member joining procedure provided from the service providing device 300.

Further, when the user of the user equipment control unit 150 is a member who is registered in advance in the service providing device 300, the user equipment control unit 150 receives one or more advertisement information, one or more benefit information, or a recommended card list transmitted from the service providing device 300 in response to the transmitted unique identification information (or unique identification information of a store provided with the beacon 200) of the beacon 200 and the identification information of the user equipment 100 through the user equipment communication unit 110. Here, the benefit information includes coupon information, membership benefit information, discount benefit information, and accumulation benefit information. Further, the recommended card list includes at least one card to which the benefit information is applied, among a plurality of cards (or one or more cards) which is issued in advance to the user equipment 100.

Further, the user equipment control unit 150 outputs at least one of the received advertisement information, benefit information, and recommended card list through the user equipment display unit 130 and/or the user equipment voice output unit 140.

Further, the user equipment control unit 150 checks one payment card (or unique identification information of the payment card) selected from the plurality of payment cards which is registered (or issued) in a specific app which is installed in advance in the user equipment 100.

The user equipment control unit 150 may checks the payment card selected from the recommended card list transmitted from the service providing device 300.

The user equipment control unit 150 may create the recommended card list including at least one card to which the benefit information may be applied, among a plurality of payment cards which is registered in advance in the user equipment 100, based on one or more benefit information provided from the service providing device 300 and display the created recommended card list on the user equipment display unit 130. Further, the user equipment control unit 150 may check one payment card selected from the recommended card list displayed on the user equipment display unit 130.

The user equipment control unit 150 receives a pin number (personal identification number) in accordance with the user input through a specific app which is installed in advance in the user equipment 100. Here, the PIN number may be a PIN number corresponding to the checked payment card type.

Further, the user equipment control unit 150 transmits the checked payment card type (or unique identification information of the payment card), the PIN number, and the identification information of the user equipment 100 to the service providing device 300 through the user equipment communication unit 110.

The user equipment control unit 150 receives a token transmitted from the service providing device 300 in response to the PIN number which is transmitted in advance, through the user equipment communication unit 110.

The user equipment control unit 150 creates a barcode (or a quick response code (QR code)) including the received token (or token information) and the identification information of the user equipment 100.

The user equipment control unit 150 stores the created barcode (or QR code) in the user equipment storing unit 120.

When a predetermined method is selected as a payment method through a specific app which is installed in advance in the user equipment 100, the user equipment control unit 150 transmits the barcode information (or the QR code information) corresponding to the barcode (or a QR code) which is previously created to the POS terminal 400 through the user equipment communication unit 110. here, the barcode information corresponding to the barcode (or QR code information corresponding to the QR code) includes the token (or token information) or identification information of the user equipment 100. In this case, the payment method includes cash payment, credit card payment, or electronic payment and the predetermined method may be electronic payment.

As described above, when the user equipment 100 and the POS terminal 400 are connected through a wired/wireless communication scheme, the barcode information (or QR code information) may be transmitted from the user equipment 100 to the POS terminal 400.

In contrast, when the user equipment 100 and the POS terminal 400 are not connected through a wired/wireless communication scheme, if the user of the user equipment 100 selects a payment method which is previously set through a specific app which is installed in advance in the user equipment 100, a barcode (or a QR code) displayed on the user equipment display unit 130 may be recognized (scanned/tagged) by the POS terminal 400.

Further, after performing a payment function on one or more products (or services) to be paid which are selected by a user of the user equipment 100 based on the barcode information (or the QR code information) which is previously transmitted, the user equipment control unit 150 receives a payment function performing result transmitted from the POS terminal 400 (or the service providing device 300) through the user equipment communication unit 110 in response to the barcode information (or the QR code information) which is previously transmitted.

Further, the user equipment control unit 150 outputs the received payment function performing result through the user equipment display unit 130 and/or the user equipment voice output unit 140.

The user equipment 100 may be applied to various terminals such as a smart phone, a portable terminal, a mobile terminal, a personal digital assistant (PDA), a portable multimedia player (PMP) terminal, a telematics terminal, a navigation terminal, a personal computer, a notebook computer, a slate PC, a tablet PC, an Ultrabook, a wearable device (for example, including a smart watch, a smart glass, or a head mounted display (HMD)), a Wibro terminal, an internet protocol television (IPTV) terminal, a smart TV, a digital broadcasting terminal, a television, a 3D television, a home theater system, an audio video navigation (AVN) terminal, an audio/video (A/V) system, or a flexible terminal.

As illustrated in FIG. 2, the user equipment 100 is configured by a user equipment communication unit 110, a user equipment storing unit 120, a user equipment display unit 130, a user equipment voice output unit 140, and a user equipment control unit 150. However, all the components of the user equipment 100 illustrated in FIG. 2 are not essential components, but the user equipment 100 may be implemented by more components or less components than the components illustrated in FIG. 2.

The user equipment communication unit 110 connects an arbitrary internal component with at least one arbitrary external terminal through a wired/wireless communication network to communicate each other. In this case, the arbitrary external terminal may include the beacon 200, the service providing device 300, the POS terminal 400, and the payment server 500. Here, a wireless internet technique includes wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS). The user equipment communication unit 110 transmits and receives data in accordance with at least one wireless Internet technique within a range including also Internet techniques which are not described above. Further, a short range communication technology may include Bluetooth, RFID (radio frequency identification), IrDA (infrared data association), UWB (ultra-wideband), ZigBee, NFC (near field communication), USC (ultra sound communication), VLC (visible light communication), Wi-Fi, Wi-Fi direct or the like. Furthermore, the wired communication technique may include power line communication (PLC), USB communication, Ethernet, serial communication, an optical/coaxial cable, or the like.

The user equipment communication unit 110 may transmit information with any terminal through a universal serial bus (USB).

The user equipment communication unit 110 transmits and receives a wireless signal to and from a base station, the beacon 200, the service providing device 300, the POS terminal 400, and the payment serve 500 on a mobile communication network built according to technical standards for mobile communication or communication schemes (for example, global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), or the like).

Further, the user equipment communication unit 110 receives identification information (or unique identification information of a store provided with the beacon 200) of the beacon 200 which is transmitted from the beacon 200, by the control of the user equipment control unit 150.

The user equipment storing unit 120 stores various user interfaces UI and graphic user interfaces GUI.

Further, the user equipment storing unit 120 stores data and programs required to operate the user equipment 100.

That is, the user equipment storing unit 120 may store a plurality of application programs (or applications) which are driven in the user equipment 100 and data and commands for operation of the user equipment 100. At least some of the application programs may be downloaded from an external service providing device through wireless communication. Further, at least some of the application programs may be provided on the user equipment 100 since a releasing time in order to support a basic function (for example, phone call receiving and sending functions, message receiving and transmitting functions) of the user equipment 100. In the meantime, the application program is stored in the user equipment storing unit 120 and provided in the user equipment 100 to be driven to perform an operation (or a function) of the user equipment 100 by the user equipment control unit 150.

Further, the user equipment storing unit 120 may include at least one storing medium of a flash memory type, a hard disk type, a multimedia card micro type, a card type memory (for example, an SD or XD memory), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM). Further, the user equipment 100 may operate a web storage which performs a storing function of the user equipment storing unit 120 on the Internet or operate in association with the web storage.

Further, the user equipment storing unit 120 stores identification information (or unique identification information of a store provided with the beacon 200) of the beacon 200 which is received through the user equipment communication unit 110, by the control of the user equipment control unit 150.

The user equipment display device 130 may display various contents such as various menu screens using a user interface and/or graphic user interface stored in the user equipment storing unit 120, by the control of the user equipment control unit 150. Here, the contents displayed on the user equipment display unit 130 may include a menu screen including various texts, image data (including various information data), and data such as icons, list menus, or a combo boxes. The user equipment display unit 130 may be a touch screen.

Further, the user equipment display unit 130 may include at least one of a liquid crystal display (LCD), a thin film transistor liquid crystal display (TFT LCD), an organic light emitting diode (OLED), a flexible display, a field emission display (FED), a three dimensional display (3D display), an e-ink display, and a light emitting diode (LED).

Further, the user equipment display unit 130 may be configured as a stereoscopic display unit which displays a stereoscopic image.

A 3D display scheme such as a stereoscopic type (a glass type), an auto stereoscopic type (a glassless type), or a projection scheme (a holographic type) may be applied to the stereoscopic display unit.

Further, the user equipment display unit 130 displays identification information (or unique identification information of a store provided with the beacon 200) of the beacon 200 which is received through the user equipment communication unit 110, by the control of the user equipment control unit 150.

The user equipment voice output unit 140 outputs voice information included in a signal processed by the user equipment control unit 150. Here, the user equipment voice output unit 140 may include a receiver, a speaker, a buzzer, and the like.

Further, the user equipment voice output unit 140 outputs a guide voice generated by the user equipment control unit 150.

Further, the user equipment voice output unit 140 outputs voice information corresponding to identification information (or unique identification information of a store provided with the beacon 200) of the beacon 200 which is received through the user equipment communication unit 110, by the control of the user equipment control unit 150.

The user equipment control unit 150 performs an overall control function of the user equipment 100.

The user equipment control unit 150 performs an overall control function of the user equipment 100 using a program and data stored in the user equipment storing unit 120. The user equipment control unit 150 may include a RAM, a ROM, a CPU, a GPU, and a bus and the RAM, the ROM, the CPU, and the GPU are connected to each other through the bus. The CPU accesses the user equipment storing unit 120 to perform booting using an O/S stored in the user equipment storing unit 120 and performs various operations using various programs, contents, and data stored in the user equipment storing unit 120.

Further, the user equipment control unit 150 interlocks with the service providing device 300 to perform a member joining procedure for the user of the user equipment 100.

When the member joining procedure is performed, the user equipment control unit 150 normally completes the member joining procedure for the service providing device 300 only by completing the authentication function through a self-authentication unit (for example, including a mobile phone, a credit card, I-PIN, e-mail, and the like).

Further, when a user who carries the user equipment 100 enters a store, the user equipment control unit 150 controls the user equipment communication unit 110 to receive the identification information (or unique identification information of a store provided with the beacon 200) of the beacon 200 transmitted from the beacon 200.

Further, the user equipment control unit 150 transmits the received unique identification information of the beacon 200 (or the unique identification information of a store provided with the beacon 200) and identification information of the user equipment 100 to the service providing device 300 through the user equipment communication unit 110. Here, the identification information of the user equipment 100 includes a mobile directory number (MDN), a mobile IP, a mobile MAC, a subscriber identify module (Sim) card unique information, and a serial number.

Further, when a user of the user equipment control unit 150 is not a member who is registered in advance in the service providing device 300, the user equipment control unit 150 performs the member joining procedure for the user equipment 100 (or a user of the user equipment 100) based on guide information related with the member joining procedure provided from the service providing device 300.

Further, when the user of the user equipment control unit 150 is a member who is registered in advance in the service providing device 300, the user equipment control unit 150 receives one or more advertisement information, one or more benefit information, or a recommended card list transmitted from the service providing device 300 in response to the transmitted unique identification information (or unique identification information of a store provided with the beacon 200) of the beacon 200 and the identification information of the user equipment 100 through the user equipment communication unit 110. Here, the benefit information includes coupon information, membership benefit information, discount benefit information, and accumulation benefit information. Further, the recommended card list includes at least one card to which the benefit information is applied, among a plurality of cards (or one or more cards) which is issued in advance to the user equipment 100.

Further, the user equipment control unit 150 outputs at least one of the received advertisement information, benefit information, and recommended card list through the user equipment display unit 130 and/or the user equipment voice output unit 140.

Further, the user equipment control unit 150 checks one payment card (or unique identification information of the payment card) selected from the plurality of payment cards which is registered (or issued) in a specific app which is installed in advance in the user equipment 100.

The user equipment control unit 150 may checks the payment card selected from the recommended card list transmitted from the service providing device 300.

The user equipment control unit 150 may create the recommended card list including at least one card to which the benefit information may be applied, among a plurality of payment cards which is registered in advance in the user equipment 100, based on one or more benefit information provided from the service providing device 300 and display the created recommended card list on the user equipment display unit 130. Further, the user equipment control unit 150 may check one payment card selected from the recommended card list displayed on the user equipment display unit 130.

The user equipment control unit 150 receives a pin number (personal identification number) in accordance with the user input through a specific app which is installed in advance in the user equipment 100. Here, the PIN number may be a PIN number corresponding to the checked payment card type.

Further, the user equipment control unit 150 transmits the checked payment card type (or unique identification information of the payment card), the PIN number, and the identification information of the user equipment 100 to the service providing device 300 through the user equipment communication unit 110.

The user equipment control unit 150 receives a token transmitted from the service providing device 300 in response to the PIN number which is transmitted in advance, through the user equipment communication unit 110.

The user equipment control unit 150 creates a barcode (or a quick response code (QR code)) including the received token (or token information) and the identification information of the user equipment 100.

The user equipment control unit 150 stores the created barcode (or QR code) in the user equipment storing unit 120.

When a predetermined method is selected as a payment method through a specific app which is installed in advance in the user equipment 100, the user equipment control unit 150 transmits the barcode information (or the QR code information) corresponding to the barcode (or a QR code) which is previously created to the POS terminal 400 through the user equipment communication unit 110. Here, the barcode information corresponding to the barcode (or QR code information corresponding to the QR code) includes the token (or token information) or identification information of the user equipment 100. In this case, the payment method includes cash payment, credit card payment, or electronic payment and the predetermined method may be electronic payment.

As described above, when the user equipment 100 and the POS terminal 400 are connected through a wired/wireless communication scheme, the barcode information (or QR code information) may be transmitted from the user equipment 100 to the POS terminal 400.

In contrast, when the user equipment 100 and the POS terminal 400 are not connected through a wired/wireless communication scheme, if the user of the user equipment 100 selects a payment method which is previously set through a specific app which is installed in advance in the user equipment 100, a barcode (or a QR code) displayed on the user equipment display unit 130 may be recognized (scanned/tagged) by the POS terminal 400.

Further, after performing a payment function on one or more products (or services) to be paid which are selected by a user of the user equipment 100 based on the barcode information (or the QR code information) which is previously transmitted, the user equipment control unit 150 receives a payment function performing result transmitted from the POS terminal 400 (or the service providing device 300) through the user equipment communication unit 110 in response to the barcode information (or the QR code information) which is previously transmitted.

Further, the user equipment control unit 150 outputs the received payment function performing result through the user equipment display unit 130 and/or the user equipment voice output unit 140.

Further, the user equipment 100 may further include an interface unit (not illustrated) which functions as an interface with all external apparatuses which are connected to the user equipment 100. For example, the interface unit may be configured by a wired/wireless headset port, an external charger port, a wired/wireless data port, a memory card port, a port connecting devices with identification modules, an audio input/output (I/O) port, a video input/output (I/O) port, an earphone port, and the like. Here, the identification module is a chip which stores various information for authenticating authorization of the user equipment 100 and may include a user identity module (UIM), a subscriber identity module (SIM), a universal subscriber identity module (USIM), and the like. Further, the device provided with the identification module may be prepared in a smart card form. Accordingly, the identification module may be connected with the user equipment 100 through the port. Such an interface unit receives data or power from an external device to transmit the received data or power to each component in the user equipment 100 or transmit the data in the user equipment 100 to the external device.

Further, the interface unit may be a passage through which the power from a cradle is supplied to the corresponding user equipment 100 when the user equipment 100 is connected to an external cradle or a passage through which various command signals input from the cradle by the user is transferred to the corresponding user equipment 100. Various command signals input from the cradle or the corresponding power may also operate by a signal for recognizing that the user equipment 100 is accurately installed on the cradle.

Further, the user equipment 100 may further include an input unit (not illustrated) for receiving a signal according to a button operation of the user or any function selection or receiving a command or a control signal created by an operation such as an operation of touching/scrolling the displayed screen.

The input unit is a means for receiving at least one of a user's command, selection, data, and information and may include a plurality of input keys and function keys for receiving figure or text information and setting various functions.

Further, the input unit may use various devices such as a key pad, a dome switch, a touch pad (a pressure resistive type/a capacitive resistive type), a touch screen, a jog wheel, a jog switch, a jog shuttle, a mouse, a stylus pen, and a touch pen. Particularly, when the user equipment display unit 130 is formed in a touch screen form, some or all of the input functions may be performed by the user equipment display unit 130.

Further, each component unit (or each module) of the user equipment 100 may be software stored on a memory (or the user equipment storing unit 120) of the user equipment 100. The memory may be an internal memory of the user equipment 100 and may an external memory or other types of storing devices. Further, the memory may be a non-volatile memory. The software stored on the memory may include a command set to allow the user equipment 100 to perform a specific operation while executing.

The beacon 200 communicates with the user equipment 100 and the POS terminal 400.

Further, the beacon 200 receives store information relate with the store provided with the beacon 200 or unique identification information of the store provided with the beacon 200 transmitted from the POS terminal 400.

The beacon 200 broadcasts (or transmits) store information or the identification information (or unique identification information of the store provided with the beacon 200) of the beacon 200.

The service providing device 300 communicates with the user equipment 100, the POS terminal 400, and the payment server 500.

Further, the service providing device 300 may include a communication unit (not illustrated), a storing unit (not illustrated), a display unit (not illustrated), a voice output unit (not illustrated), and a control unit (not illustrated) corresponding to the user equipment communication unit 110, the user equipment storing unit 120, the user equipment display unit 130, the user equipment voice output unit 140, the user equipment control unit 150 included in the user equipment 100, respectively.

Further, the service providing device 300 interlocks with the user equipment 100 to perform a member joining procedure for the user of the user equipment 100.

Further, the service providing device 300 receives the unique identification information of the beacon 200 and the identification information of the user equipment 100 transmitted from the user equipment 100.

Further, the service providing device 300 determines (or checks) whether the user corresponding to the user equipment 100 is a member who is registered (joined) in advance in the service providing device 300 based on the received identification information of the user equipment 100.

When the user corresponding to the user equipment 100 is not a member who is registered in advance in the service providing device 300 as a determination result (or a checking result), the service providing device 300 transmits guide information related with the member joining procedure to the user equipment 100.

Further, the service providing device 300 interlocks with the user equipment 100 to perform a member joining procedure for the user equipment 100 (or the user of the user equipment 100).

Further, when the user corresponding to the user equipment 100 is a member who is registered in advance in the service providing device 300 as a determination result (or a checking result), the service providing device 300 checks one or more advertisement information and one or more benefit information which may be provided to the user equipment 100 in the store provided with the beacon 200, among a plurality of advertisement information and a plurality of benefit information which are stored in advance based on the unique identification information of the beacon 200 which is previously received and the identification information of the user equipment 100.

Further, the service providing device 300 creates a recommended card list including one or more recommended cards to which the benefit information may be applied (or reflected) among a plurality of cards issued to the user equipment 100, based on one or more checked benefit information. Here, the benefit information includes coupon information, membership benefit information, discount benefit information, and accumulation benefit information.

The service providing device 300 transmits one or more advertisement information, one or more benefit information, and a recommended card list including one or more recommended cards which may be provided to the user equipment 100 in the store equipped with the checked beacon 200 to the user equipment 100.

That is, when the user corresponding to the user equipment 100 is a member who is registered in advance in the service providing device 300, the service providing device 300 checks store information corresponding to the unique identification information of the beacon 200 among store information for every unique identification information of the plurality of beacons which is stored in advance. Further, the service providing device 300 checks one or more advertisement information and benefit information which may be provided to the user equipment 100 in the store based on the checked store information and the received identification information of the user equipment 100. Further, the service providing device 300 creates the recommended card list including at least one card to which the benefit information is applied, among a plurality of cards (or one or more cards) which is previously issued to the user equipment 100. Further, the service providing device 300 transmits one or more checked advertisement information, one or more checked benefit information, and the created recommended card list to the user equipment 100.

Further, the service providing device 300 receives the payment card type, the PIN number, and the identification information of the user equipment 100 transmitted from the user equipment 100.

Further, the service providing device 300 creates a token (a one-time token, token information, or temporary token) corresponding to the received PIN number. Here, the token is a temporary token and is randomly created corresponding to the PIN number. Further, a usage count or a usage duration may be set in advance. In this case, the service providing device 300 may create a token corresponding to the received PIN number and the payment card type.

Further, the service providing device 300 manages (or stores) the created token by interlocking with the payment card type, the PIN number, and the identification information of the user equipment 100.

Further, the service providing device 300 transmits the created token (or a token corresponding to the PIN number or a token corresponding to the PIN number and the payment card type) to the user equipment 100.

Further, the service providing device 300 receives the barcode information (or QR code information) transmitted from the payment server 500, to perform the authentication function for the user before performing the payment function on one or more products (or services) to be paid which are selected by the user of the user equipment 100.

Further, the service providing device 300 checks whether the token in the barcode information (or the QR code information) is valid, based on the token in the received barcode information (or QR code information) and the identification information of the user equipment 100.

That is, the service providing device 300 checks whether the token in the received barcode information (or QR code information), a token corresponding to the identification information of the user equipment 100, and identification information of the user equipment are included (or present) in the identification information of the user equipment for each of the plurality of tokens stored in advance (or issued in advance).

As described above, the service providing device 300 may verify the validity of the issued token.

When the token in the received barcode information (or QR code information), the token corresponding to the identification information of the user equipment 100, and identification information of the user equipment are not included in the identification information of the user equipment for each of the plurality of tokens which is stored in advance in the service providing device 300 as a checking result, that is, when the token in the received barcode information (or the QR information) is not valid, the service providing device 300 transmits authentication failure information to the payment server 500.

When the token in the received barcode information (or QR code information), the token corresponding to the identification information of the user equipment 100, and identification information of the user equipment are included in the identification information of the user equipment for each of the plurality of tokens which is stored in advance in the service providing device 300 as a checking result, that is, when the token in the received barcode information (or the QR information) is valid, the service providing device 300 transmits card information, user information, benefit information corresponding to the identification information of the user equipment 100 in the received barcode information (or QR code information) to the payment server 500. In this case, the service providing device 300 may transmit card information, user information, and benefit information corresponding to the payment card type related with a valid token (or the payment card type checked based on the token created corresponding to the PIN number and the payment card type/PIN number is managed by interlocking with the token, payment card type, and payment card type checked based on the identification information of the user equipment) to the payment server 500. Here, the card information includes a card number, expiration date, a card verification code (CVC) number, and a user name. The user information includes a user name, birth date, an address, and an image. Further, the benefit information includes coupon information, membership benefit information, discount benefit information, and accumulation benefit information.

That is, when the token in the received barcode information (or QR code information) is valid as the checking result, the service providing device 300 checks the card information, the user information, and the benefit information stored in advance in the service providing device 300 related with the user (or the user equipment 100) corresponding to the identification information of the user equipment 100 in the received barcode information (or QR code information) and transmits the checked card information, user information, and benefit information to the payment server 500. In this case, the service providing device 300 checks the card information, the user information, and the benefit information corresponding to the payment card type which is previously transmitted from the user equipment 100 and transmits the checked card information, user information, and benefit information to the payment server 500.

Further, the service providing device 300 receives a payment function performed result (or payment information) transmitted from the payment server 500.

Further, the service providing device 300 stores the received payment function performed result by interlocking with the identification information of the user equipment 100.

Further, the service providing device 300 may transmit the received payment function performed result to the user equipment 100 corresponding to the identification information of the user equipment 100.

Further, the service providing device 300 receives the payment card type, the PIN number, and the identification information of the user equipment 100 transmitted from the user equipment 100.

Further, after receiving the payment card type, the PIN number, and the identification information of the user equipment 100, the service providing device 300 maintains a stand-by status (or a check-in status) for simple payment.

As described above, the service providing device 300 receives and manages prior information (for example, including the payment card type, the PIN number, and the identification information of the user equipment 100) for simple payment of the user equipment 100 which enters the store equipped with the POS terminal 400.

Further, the service providing device 300 maintains a check-in status with the plurality of user equipment 100 by interlocking (communicating) with the plurality of user equipment 100 which visits the store equipped with the POS terminal 400.

Further, the service providing device 300 receives partial payment request information and the identification information of the user equipment 100 transmitted from the user equipment 100.

Further, the service providing device 300 checks the identification information (for example, including phone numbers of the plurality of user equipment 100) of the plurality of user equipment 100 which is in the check-in status in the store equipped with the POS terminal 400 by interlocking with the POS terminal 400. In this case, the identification information of the plurality of user equipment 100 which is in the check-in status in the store equipped with the POS terminal 400 includes identification information of the user equipment 100.

That is, the service providing device 300 requests the identification information of the user equipment 100 which is in the check-in status in the POS terminal 400 to the POS terminal 400 based on the previously received partial payment request information and receives the identification information of the plurality of user equipment 100 which is in the check-in status in the store equipped with the POS terminal 400 which is transmitted from the POS terminal 400 in response to the request.

In this case, the service providing device 300 may be provided with only identification information of the plurality of user equipment 100 located within a communication range (or a BLE communication range) of the POS terminal 400, from the POS terminal 400.

Further, the service providing device 300 creates a partial payment participant registration room for partial payment based on the previously received partial payment request information. The created partial payment participant registration room is managed by being interlocked (matched) with the identification information of the user equipment 100. Here, the partial payment participant registration room includes information such as a registration room name, a registration room unique number, a maximum number of partial payment participants.

Further, the service providing device 300 transmits the checked identification information of the plurality of user equipment 100 which is in the check-in status in the store equipped with the POS terminal 400 and information on the created partial payment participant registration room to the user equipment 100.

Further, when at least one other user equipment 100 participates the partial payment, the service providing device 300 manages (or controls) a connection relationship with other user equipment 100 which accesses the service providing device 300 (or the partial payment participant registration room created in the service providing device 300), based on the information on the partial payment participant registration room. Here, the at least one other user equipment 100 may be user equipment corresponding to identification information of at least one other user equipment 100 selected by the selection (or control) of the user of the user equipment 100 among identification information (or identification information of a plurality of remaining user equipment 100 excluding identification of the user equipment 100 from identification information of the plurality of user equipment 100) of the plurality of user equipment 100 which is previously provided to the user equipment 100.

Further, the service providing device 300 may perform a registration procedure of the partial payment participants for partial payment in the partial payment participant registration room included in (or corresponding to/according to) the information on the accessed partial payment participant registration room by interlocking with other user equipment 100.

In the exemplary embodiment of the present invention, it is described that the at least one of other user equipment 100 selected by the user equipment 100 performs the partial payment participant registration function for partial payment by interlocking with the service providing device 300, but the exemplary embodiment of the present invention is not limited thereto. One or more user equipment 100 which performs the partial payment is searched and selected from the plurality of user equipment which is in a check-in state in the POS terminal 400 by interlocking with the service providing device 300 and one group is created (or set) with respect to commonly included user equipment among one or more user equipment selected for every user equipment.

For example, when second user equipment and third user equipment are selected by first user equipment included in the plurality of user equipment which is in a check-in status in the POS terminal and the first user equipment and fifth user equipment are selected by fourth user equipment included in the plurality of user equipment which is in a check-in status in the POS terminal, the service providing device 300 automatically creates a partial payment participant registration room in which the first user equipment, the second user equipment, the third user equipment, the fourth user equipment, and the fifth user equipment participate through the first user equipment which is a common participant and transmits information on the created partial payment participant registration room to the first to fifth user equipment, to register as the partial payment participants.

Further, when a predetermined time for partial payment has elapsed (or when a plurality of user equipment corresponding to the maximum number of partial payment participants which is set in advance for the partial payment all registers as partial payment participant), the service providing device 300 transmits a payment related information request signal related with the plurality of user equipment 100 which participates the partial payment to the POS terminal 400. Here, the payment related information request signal includes identification information of the plurality of user equipment which participates the partial payment.

Further, the service providing device 300 receives a payment card type (or a payment card type for every user equipment/a payment card type for every user equipment which participates partial payment) related with the plurality of user equipment 100 which participates the partial payment, the PIN number (or a PIN number for every user equipment), the identification information of the user equipment 100 (or identification information of user equipment for every user equipment), a total payment amount for a product or a service selected by the user of the user equipment 100, or information on one or more products or services to be paid, transmitted from the POS terminal 400 in response to the previously transmitted payment related information request signal related with the plurality of user equipment 100 which participates the partial payment.

Further, the service providing device 300 sets an allotment for every participant based on a total payment amount and the number of the plurality of user equipment 100 which participates the partial payment. In this case, an allotment setting method may include a method of setting by 1/n (or equal split) based on the number of the plurality of user equipment 100, a method of setting an amount (or a ratio of an allotted amount) allotted to each user of an actual payment amount (or a total payment amount) for every user equipment in advance at the time of previously registering as the partial payment participants, and a method of transmitting an actual payment amount (or a total payment amount) to the plurality of user equipment 100 after checking the actual payment amount (or the total payment amount) in the service providing device 300 and receiving an allotted amount for every user equipment which is transmitted to each user equipment as a response thereof. Here, the actual payment amount is an amount obtained by applying benefit information to the payment amount. When the benefit information is not applied, the actual payment amount may be equal to the total payment amount.

Further, the service providing device 300 transmits information on one or more products or services to be paid, an allotment for every participant, card information corresponding to a PIN number for every user equipment, user information, and benefit information to the payment server 500. Here, the card information includes a card number, expiration date, a card verification code (CVC) number, and a user name. The user information includes a user name, birth date, an address, and an image. Further, the benefit information includes coupon information, membership benefit information, discount benefit information, and accumulation benefit information.

Further, after normally performing the payment function on the plurality of user equipment 100, the service providing device 300 receives a payment function performed result (or payment information for every user equipment) for every user equipment and accumulated point information in accordance with the performing of payment function for every user equipment, transmitted from the payment server 500.

Further, the service providing device 300 transmits the payment function performed result and the accumulated point information in accordance with the performing of payment function to the plurality of user equipment 100 which participates the partial payment.

Further, the service providing device 300 may be implemented in a form such as a web server, a database server, and a proxy server. Further, in the service providing device 300, one or more of various software which allows a network load distribution mechanism or a service providing device 300 to operate on the Internet or other networks may be installed, and as a result, the service providing device 300 may be implemented by a computerized system. Further, the network may be an http network and may be a private line, Intranet, or any other networks. Furthermore, the service providing device 300 and the user equipment 100 may be connected to each other by a security network so as to suppress the data from being attacked by any hacker or other third parties. Further, the service providing device 300 may include a plurality of database servers. The database server may be implemented to be separately connected with the service providing device 300 through any type of network connection including a distributed database server architecture.

A processor mounted in the user equipment 100 or the service providing device 300 according to the exemplary embodiment of the present invention may process the program command to execute the method according to the exemplary embodiment of the present invention. In an implemented embodiment, the processor may be a single-threaded processor. In another implemented embodiment, the processor may be a multi-threaded processor. Further, the processor may process the command stored on the memory or the storing device.

The point of sales (POS) terminal 400 communicates with the user equipment 100, the beacon 200, the service providing device 300, and the payment server 500.

Further, the POS terminal 400 may include a communication unit (not illustrated), a storing unit (not illustrated), a display unit (not illustrated), a voice output unit (not illustrated), and a control unit (not illustrated) corresponding to the user equipment communication unit 110, the user equipment storing unit 120, the user equipment display unit 130, the user equipment voice output unit 140, the user equipment control unit 150 included in the user equipment 100, respectively.

Further, the POS terminal 400 transmits store information relate with the store provided with the beacon 200 or unique identification information of the store provided with the beacon 200 to the beacon 200.

The POS terminal 400 scans (or recognizes a barcode attached on a product to be paid) one or more products (or payment products/services) to be paid which are selected by the user of the user equipment 100.

The POS terminal 400 displays product information on one or more scanned (or recognized) products to be paid. Here, the product information includes a product name, a unique product code, a unit price, an amount, a price, a total price, and the like.

In contrast, when the user equipment 100 and the POS terminal 400 are not connected through a wired/wireless communication scheme, if the user of the user equipment 100 selects a payment method which is previously set through a specific app which is installed in advance in the user equipment 100, the POS terminal 400 recognizes (or scans/tags) a barcode (or a QR code) displayed on the user equipment display unit 130.

Further, the POS terminal 400 receives the barcode information (or the QR code information) transmitted from the user equipment 100.

When the POS terminal 400 recognizes a barcode (or a QR code) displayed on the user equipment 100, the POS terminal 400 checks the recognized barcode information (or the QR code information).

The POS terminal 400 displays or stores the received (or checked) barcode information (or QR code information).

The POS terminal 400 transmits information on one or more products to be paid (or recognized product information to be paid), barcode information (or QR code information), and the identification information of the POS terminal 400 to the payment server 500.

The POS terminal 400 receives authentication failure information transmitted from the payment server 500 in response to the barcode information (or QR code information) transmitted to the payment server 500.

The POS terminal 400 displays the received authentication failure information.

Further, the POS terminal 400 may transmit the received authentication failure information to the user equipment 100.

Further, the POS terminal 400 receives user information transmitted from the payment server 500 immediately before performing a payment function on one or more products selected by the user of the user equipment 100 based on the barcode information (or QR code information) transmitted to the payment server 500. Here, the user information includes a user name, birth data, address, and an image related with the user corresponding to the identification information of the user equipment 100.

The POS terminal 400 displays the received user information.

Further, the user of the POS terminal 400 checks an image in the user information displayed on the POS terminal 400 and the user of the user equipment 100 which makes a payment on the product. Thereafter, when the image in the user information matches the user of the user equipment 100, the POS terminal 400 receives information indicating the user matching in accordance with the user input of the POS terminal 400.

The POS terminal 400 transmits received information indicating the user matching, and identification information of the POS terminal 400 to the payment server 500.

Further, when a payment function on one or more products selected by the user of the user equipment 100 is normally performed based on the barcode information (or QR code information) transmitted to the payment server 500, the POS terminal 400 receives a payment function performed result (or payment information) which is transmitted from the payment server 500 in response to the barcode information (or the QR code information) transmitted to the payment server 500. Here, the payment function performed result (or the payment information) includes a product name, a unique product code, a unit price, an amount, a discounted price, whether to apply a coupon, a price, a total price, payment date and time information, and a payment card type.

The POS terminal 400 transmits the received payment function performed result to the user equipment 100.

Further, the POS terminal 400 may output the received payment function performed result through a printed matter such as a receipt.

Further, the POS terminal 400 receives the payment card type, the PIN number, and the identification information of the user equipment 100 transmitted from the user equipment 100.

Further, after receiving the payment card type, the PIN number, and the identification information of the user equipment 100, the POS terminal 400 maintains a stand-by status (or a check-in status) for simple payment.

The POS terminal 400 transmits the received payment card type, PIN number, and identification information of the user equipment 100 to the service providing device 300.

Further, the POS terminal 400 maintains a check-in status with the plurality of user equipment 100 by interlocking (communicating) with the plurality of user equipment 100 which visits the store equipped with the POS terminal 400.

As described above, the POS terminal 400 receives and manages prior information (for example, including the payment card type, the PIN number, and the identification information of the user equipment 100) for simple payment of the user equipment 100 which enters the store equipped with the POS terminal 400.

The POS terminal 400 scans (or recognizes a barcode attached on a product to be paid) one or more products (or payment products) to be paid which are selected by the user of the user equipment 100.

The POS terminal 400 displays product information on one or more scanned (or recognized) products to be paid. Here, the product information includes a product name, a unique product code, a unit price, an amount, a price, a total price, and the like.

Further, the POS terminal 400 checks service information for a service to be paid, which is selected (or used) by the user of the user equipment 100, and displays the checked service information. Here, the service information includes a service name, a unique service code, a unit price, an amount, a price, a total price, and the like.

Further, the POS terminal 400 provides identification information (for example, including phone numbers of the plurality of user equipment 100) of the plurality of user equipment 100 which is in the check-in status in the store equipped with the POS terminal 400 to the service providing device 300 by interlocking with the service providing device 300.

That is, the POS terminal 400 receives a request of identification information of the user equipment which is in a check-in status to the POS terminal 400 of the service providing device 300 and transmits the identification information of the plurality of user equipment 100 which is in a check-in status in the store equipped with the POS terminal 400 to the service providing device 300 in response to the received request.

In this case, the POS terminal 400 may provide only identification information of the plurality of user equipment 100 located within a communication range (or a BLE communication range) of the POS terminal 400, to the service providing device 300.

In this case, the POS terminal 400 may provide identification information of the plurality of user equipment 100 which is located within a communication range (or a BLE communication range) of the POS terminal 400 and maintains a check-in status in the store, to the service providing device 300.

Further, the POS terminal 400 receives the payment related information request signal related with the plurality of user equipment 100 which participates the partial payment, transmitted from the service providing device 300.

Further, the POS terminal 400 transmits a payment card type (or a payment card type for every user equipment/a payment card type for every user equipment which participates partial payment) related with the plurality of user equipment 100, the PIN number (or a PIN number for every user equipment), the identification information of the user equipment 100 (or identification information of user equipment for every user equipment), a total payment amount for a product or a service selected by the user of the user equipment 100, or information on one or more products or services to be paid, to the service providing device 300, in response to the payment related information request signal related with the plurality of user equipment 100 which participates the partial payment.

Further, after normally performing the partial payment function on the plurality of user equipment 100, the POS terminal 400 receives a payment function performed result (or payment information for every user equipment) for every user equipment and accumulated point information in accordance with the performing of payment function for every user equipment, transmitted from the payment server 500. Here, the payment function performed result (or the payment information for every user equipment) for every user equipment includes a product name (or a service name), a unique product code (a unique service code), a unit price, an amount, a discounted price, whether to apply a coupon, a price, an actual payment amount (a total payment price), payment date and time information, and a payment card type.

Further, the POS terminal 400 transmits the payment function performed result and the accumulated point information in accordance with the performing of payment function to the plurality of user equipment 100 which participates the partial payment.

Further, the POS terminal 400 may output the received payment function performed result for every user equipment through a printed matter such as a receipt.

The payment server 500 communicates with the user equipment 100, the service providing device 300, and the POS terminal 400.

Further, the payment server 500 may include a communication unit (not illustrated), a storing unit (not illustrated), a display unit (not illustrated), a voice output unit (not illustrated), and a control unit (not illustrated) corresponding to the user equipment communication unit 110, the user equipment storing unit 120, the user equipment display unit 130, the user equipment voice output unit 140, the user equipment control unit 150 included in the user equipment 100, respectively.

The payment server 500 receives information on one or more products to be paid (or recognized product information to be paid), barcode information (or QR code information), and the identification information of the POS terminal 400 transmitted from the POS terminal 400.

Further, the payment server 500 transmits the received barcode information (or QR code information) to the service providing device 300 in order to perform an authentication procedure related with the user equipment 100.

When the token in the barcode information (or the QR information) which is transmitted to the service providing device 300 is not valid, the payment server 500 receives authentication failure information which is transmitted from the service providing device 300 in response to the barcode information (or the QR information) which is transmitted to the service providing device 300.

Further, the payment server 500 transmits the received authentication failure information to the POS terminal 400.

When the token in the barcode information (or the QR information) which is transmitted to the service providing device 300 is valid, the payment server 500 receives card information, user information, or benefit information (or card information, user information, or benefit information corresponding to the identification information of the user equipment 100 in the barcode information (or the QR information)) which is transmitted from the service providing device 300 in response to the barcode information (or the QR information) which is transmitted to the service providing device 300.

The payment server 500 performs a payment function on the payment amount corresponding to one or more product information to be paid based on the received card information, user information, and benefit information. In this case, the payment server 500 may perform a payment function on a payment amount obtained by applying a benefit amount corresponding to the benefit information transmitted from the service providing device 300 (or benefit information which may be applied to the user of the user equipment 100) to price information on one or more products to be paid.

In this case, immediately before performing the payment function, the payment server 500 transmits the user information transmitted from the service providing device 300 to the POS terminal 400.

When the image in the user information does not match the user of the user equipment 100 who make a payment on the product, the payment server 500 transmits payment cancel information on the one or more product information to the POS terminal 400 or performs the payment function after performing additional authentication procedure on the user equipment 100.

When the image in the user information matches the user of the user equipment 100 who make a payment on the product, the payment server 500 receives the information indicating that the user matches the image transmitted from the POS terminal 400 and the identification information of the POS terminal 400, in response to the user information transmitted to the POS terminal 400.

The payment server 500 performs a payment function on the payment amount corresponding to one or more product information to be paid based on the received card information, user information, benefit information, and the information indicating that the user matches the image.

The payment server 500 transmits the payment function performed result (or payment information) to the POS terminal 400 and the service providing device 300. Here, the payment function performed result (or the payment information) includes a product name, a unique product code, a unit price, an amount, a discounted price, whether to apply a coupon, a price, a total price, payment date and time information, and a payment card type.

Further, the payment server 500 receives information on one or more products or services to be paid, an allotment for every participant, card information corresponding to a PIN number for every user equipment, user information, and benefit information, transmitted from the service providing device 300.

Further, the payment server 500 performs a partial payment function for an allotment for every participant for every user equipment, based on the card information, the user information, and the benefit information corresponding to the received allotment for every participant and the PIN number for every user equipment. In this case, the payment server 500 may perform a payment function on a payment amount (or an actual payment amount) obtained by applying a benefit amount corresponding to the benefit information transmitted from the service providing device 300 (or benefit information which may be applied to the user of the user equipment 100) to the allotment for every participant.

The payment server 500 transmits the payment function performed result (or payment information for every user equipment) for every user equipment to the POS terminal 400 and the service providing device 300. Here, the payment function performed result (or the payment information for every user equipment) for every user equipment includes a product name (or a service name), a unique product code (a unique service code), a unit price, an amount, a discounted price, whether to apply a coupon, a price, an actual payment amount (a total payment price), payment date and time information, and a payment card type.

In this case, when an accumulated point which is accumulated in accordance with the performing of the payment function is generated, the payment server 500 may transmit the payment function performed result for every user equipment and accumulated point information for every user equipment in accordance with the performing of the payment function for every user equipment to the POS terminal 400 and the service providing device 300.

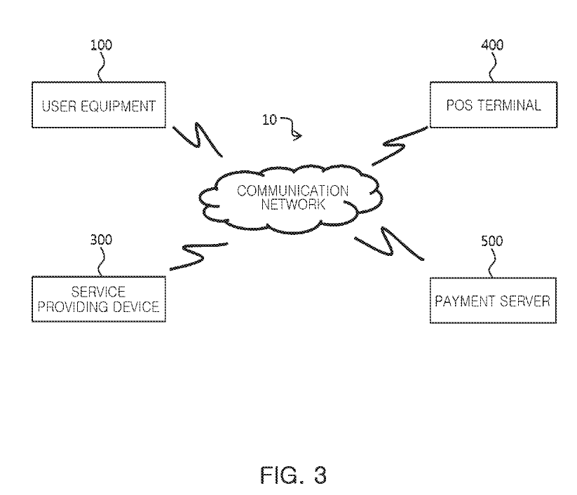

FIG. 3 is a block diagram illustrating a configuration of a payment system 10 according to another exemplary embodiment of the present invention.

As illustrated in FIG. 3, a payment system 10 is configured by a plurality of user equipment 100, a service providing device 300, a POS terminal 400, and a payment server 500. However, all the components of the payment system 10 illustrated in FIG. 3 are not essential components, but the payment system 10 may be implemented by more components or less components than the components illustrated in FIG. 3.

The plurality of user equipment 100 communicates with the service providing device 300 and registers as partial payment participants for partial payment. Next, the service providing device 300 creates a temporary account for partial payment and sets an allotment for every participant which participates the partial payment. Next, the service providing device 300 transmits information on the allotment for every participant and the temporary account to the plurality of user equipment 100 corresponding to the partial payment participants. Next, the plurality of user equipment 100 transmits the allotment according to the allotment for every participant to the temporary account. Next, when the entire amount is collected, the service providing device 300 performs a payment function on the payment amount by interlocking with a payment representing user equipment 100 corresponding to a representative payer, among the plurality of user equipment 100 and the payment server 500. Next, when points in accordance with the payment are generated after performing the payment function, the service providing device 300 distributes the previously generated points according to the allotment for every participants.

The plurality of user equipment 100 communicates with the service providing device 300 and registers as partial payment participants for partial payment. Next, the service providing device 300 collects the allotment for every participant from the plurality of user equipment 100 for the partial payment. Next, the service providing device 300 adjusts the allotment for every participant based on one or more payment cards (or payment means) which are issued in advance to every user equipment, the allotment for every participant, and a discount/predicted award amount for the payment card. Next, the service providing device 300 transmits the adjusted allotment for every participant, a recommended card list including one or more recommended cards for every user equipment, information on one or more product (or service) to be paid, and the benefit information to the plurality of user equipment 100. Next, the plurality of user equipment performs the payment function through the adjusted allotment for every participant and the payment card selected by the user, by interlocking with the service providing device 300 and the payment server 500.

When the user equipment 100 visits the store, the service providing device 300 provides advertisement information, the benefit information, and a recommended card list which can be provided by the store to the user equipment 100. Next, when there is a group related with the user equipment 100 with respect to the store and all of the plurality of user equipment 100 which belongs to the group is in a check-in state in the store, the service providing device 300 provides one or more recommended product information, coupon information, and promotion information which can be provided to the plurality of user equipment which belongs to the group.

The user equipment 100 communicates with the service providing device 300 and the POS terminal 400.

When a user of the plurality of user equipment 100 performs the partial payment function on one or more products and/or services selected (or used) in an online/offline store, each of the plurality of user equipment 100 communicates (or accesses) with the service providing device 300 through the user equipment communication unit 110.

Further, each of the plurality of user equipment 100 registers as a partial payment participant for partial payment. In this case, one (or at least one) user equipment 100 of the plurality of user equipment 100 is registered (or selected) as a representative payer (or payment representing user equipment) which performs an actual payment function. Here, the user equipment 100 registered as a representative payer may be a member which is registered in advance in the service providing device 300.

Further, the plurality of user equipment 100 receives an allotment according to user input (or user selection) for every user equipment based on the actual payment amount (or the total payment amount) provided from the service providing device 300 for partial payment and transmits the received allotment for every participant (or allotment for every user equipment) to the service providing device 300. Here, the actual payment amount is an amount obtained by applying benefit information to the payment amount. When the benefit information is not applied, the actual payment amount may be equal to the total payment amount.

Further, each of the plurality of user equipment 100 receives information on the allotment for every participant and the temporary account transmitted from the service providing device 300.

The user equipment 100 displays the received information on the allotment for every participant and the temporary account.

In this case, when the user equipment 100 is a member which joins the service providing device 300 in advance, the previously received information on the allotment for every participant and the temporary account may be displayed through an app which is installed in advance in the user equipment 100.

Further, when the user equipment 100 is not a member which joins the service providing device 300 in advance, the user equipment 100 displays the previously received information on the allotment for every participant and the temporary account which is transmitted as a text message from the service providing device 300.

As described above, since the temporary account is used, even the non-subscriber who does not join the payment service provided by the service providing device 300 as a member may transmit the allotment through the temporary account through an account of a cyber money (for example, including points or accumulated money available in a specific site) which is used by the non-subscriber. Therefore, the non-subscriber may participate the partial payment.

Further, each of the plurality of user equipment transmits (or transfers) an allotment corresponding to the user equipment among allotments for every participant to the temporary account in accordance with the selection (or input/control) of the user of the user equipment 100. In this case, the allotment includes cyber money (for example, including points or accumulated money available in a specific site) and cash.

When the partial payment is cancelled, the user equipment 100 may additionally register (or transmit) refund information for getting a refund of the previously transmitted allotment when the partial payment is cancelled, in the service providing device 300.

The representative user equipment 100 which is a representative payer among the plurality of user equipment 100 receives one or more product information to be paid, an expected payment amount, one or more benefit information, and a recommended card list including one or more recommended cards transmitted from the service providing device 300.

The payment representing user equipment 100 displays the received one or more product information to be paid, expected payment amount, one or more benefit information, and recommended card list including one or more recommended cards.

Further, the payment representing user equipment 100 receives a payment card type (or unique identification information of the payment card) in accordance with the user input (or user selection) and a PIN number through a specific app which is installed in advance in the payment representing user equipment 100.

That is, the payment representing user equipment 100 checks the payment card type which is selected in accordance with the user input (or user selection) among a plurality of cards which is registered in advance in the payment representing user equipment 100. In this case, the payment representing user equipment 100 may check a payment card type (or unique identification information of the payment card) of a payment card selected from the recommended card list transmitted from the service providing device 300.

Further, the payment representing user equipment 100 receives a PIN number in accordance with the user input (or user selection) through the specific app which is installed in advance in the payment representing user equipment 100. Here, the PIN number may be a PIN number corresponding to the checked payment card type.

Further, the payment representing user equipment 100 transmits the checked payment card type (or unique identification information of the payment card), the PIN number, and the identification information of the payment representing user equipment 100 to the service providing device 300. In this case, after normally performing the partial payment, the payment representing user equipment 100 additionally transmits account information to receive an actual payment amount (or the total payment amount) collected in the service providing device 300 for the partial payment to the service providing device 300.

Further, when the partial payment is normally performed, the payment representing user equipment 100 receives (or checks) the actual payment amount (or the total payment amount) provided from the service providing device 300.

When the partial payment fails, the plurality of user equipment 100 receives partial payment failure information transmitted from the service providing device 300.

Further, the plurality of user equipment 100 displays the received partial payment failure information.

When the partial payment fails, the user equipment 100 which transmits the allotment gets a refund of the previously transmitted allotment from the service providing device 300.

When the partial payment is normally performed, the plurality of user equipment 100 receives the payment function performed result transmitted from the service providing device 300 and displays the received payment function performed result. Here, the payment function performed result (or the payment information) includes a product name (or a service name), a unique product code (a unique service code), a unit price, an amount, a discounted price, whether to apply a coupon, a price, an actual payment amount (a total payment price), payment date and time information, and a payment card type.

Further, when there are accumulated points in accordance with the performing of the payment function (or performing of the partial payment function), each of the plurality of user equipment 100 which participates the partial payment displays (or checks) information on accumulated points which are distributed by the service providing device 300.

Each of the user equipment 100 provides one or more payment card information (or payment cards) issued from the user equipment 100 to the service providing device 300.

Further, each of the plurality of user equipment 100 receives one or more product information to be paid, a final allotment for every participant, a recommended card list for every user equipment, discount benefit information corresponding to a recommended card, and one or more product information to be paid, transmitted from the service providing device 300.

Further, each of the plurality of user equipment 100 displays the received one or more product information to be paid, a final allotment for every participant, recommended card list for every user equipment, discount benefit information corresponding to a recommended card, and one or more product information to be paid.

Further, each of the plurality of user equipment 100 receives a payment card type (or unique identification information of the payment card) in accordance with the user input (or user selection) and a PIN number through a specific app which is installed in advance in the user equipment 100.

That is, each of the plurality of user equipment 100 checks the payment card type which is selected in accordance with the user input (or user selection) among a plurality of cards which is registered in advance in the user equipment 100. In this case, each of the plurality of user equipment 100 may check a payment card type (or unique identification information of the payment card) of a payment card selected from the recommended card list transmitted from the service providing device 300.

Further, each of the plurality of user equipment 100 receives a PIN number in accordance with the user input (or user selection) through the specific app which is installed in advance in the user equipment 100. Here, the PIN number may be a PIN number corresponding to the checked payment card type.

Further, each of the plurality of user equipment 100 transmits the checked payment card type (or unique identification information of the payment card), the PIN number, and the identification information of the user equipment 100 to the service providing device 300.

Further, when the payment function is performed through one (or plural) payment representing user equipment 100 selected among the plurality of user equipment 100 which participates the partial payment, the remaining user equipment excluding the payment representing user equipment 100 among the plurality of user equipment 100 which participates the partial payment receives an allotment for every participant, information on a temporary account, one or more product information to be paid, and representative payer information transmitted from the service providing device 300.

Further, the remaining user equipment 100 displays the received allotment for every participant, information on a temporary account, one or more product information to be paid, and representative payer information.

In this case, the remaining user equipment 100 may display the previously received allotment for every participant, information on a temporary account, one or more product information to be paid, and representative payer information through an app which is installed in advance in the user equipment 100.

As described above, since the temporary account is used, even the non-subscriber who does not join the payment service provided by the service providing device 300 as a member may transmit the allotment through the temporary account through an account of a cyber money (for example, including points or accumulated money available in a specific site) which is used by the non-subscriber. Therefore, the non-subscriber may participate the partial payment.

Further, the remaining user equipment transmits (or transfers) an allotment corresponding to the user equipment among allotments for every participant to the temporary account in accordance with the selection (or input/control) of the user of the user equipment 100. In this case, the allotment includes cyber money (for example, including points or accumulated money available in a specific site) and cash.

When the partial payment is cancelled, the remaining user equipment 100 may additionally register (or transmit) refund information for getting a refund of the previously transmitted allotment when the partial payment is cancelled, in the service providing device 300.

Further, the representative user equipment 100 which is a representative payer among the plurality of user equipment 100 receives one or more product information to be paid, an allotment for every participant, a recommended card list including a recommended card having the greatest benefit, benefit information, and an actual payment amount to which the benefit information is applied transmitted from the service providing device 300.

Further, the payment representing user equipment 100 displays the received one or more product information to be paid, allotment for every participant, recommended card list including a recommended card having the greatest benefit, benefit information, and actual payment amount to which the benefit information is applied.

Further, the payment representing user equipment 100 receives a payment card type (or unique identification information of the payment card) in accordance with the user input (or user selection) and a PIN number through a specific app which is installed in advance in the payment representing user equipment 100.

That is, the payment representing user equipment 100 checks the payment card type which is selected in accordance with the user input (or user selection) among a plurality of cards which is registered in advance in the payment representing user equipment 100. In this case, the payment representing user equipment 100 may check a payment card type (or unique identification information of the payment card) of a payment card selected from the recommended card list transmitted from the service providing device 300.

Further, the payment representing user equipment 100 receives a PIN number in accordance with the user input (or user selection) through the specific app which is installed in advance in the payment representing user equipment 100. Here, the PIN number may be a PIN number corresponding to the checked payment card type.

Further, the payment representing user equipment 100 transmits the checked payment card type (or unique identification information of the payment card), the PIN number, and the identification information of the payment representing user equipment 100 to the service providing device 300.

When the partial payment fails, the plurality of user equipment 100 receives partial payment failure information transmitted from the service providing device 300.

Further, the plurality of user equipment 100 displays the received partial payment failure information.

When the partial payment fails, the user equipment 100 which transmits the allotment gets a refund of the previously transmitted allotment from the service providing device 300.

When the partial payment is normally performed, the plurality of user equipment 100 receives a payment function performed result transmitted from the service providing device 300.

Further, when the partial payment is normally performed in a state when the payment function is performed through one (or plural) payment representing user equipment 100 selected among the plurality of user equipment 100 which participates the partial payment, each of the plurality of user equipment 100 receives the payment function performed result transmitted from the service providing device 300.

Further, each of the plurality of user equipment 100 displays the received payment function performed result. Here, the payment function performed result (or the payment information) includes a product name (or a service name), a unique product code (a unique service code), a unit price, an amount, a discounted price, whether to apply a coupon, a price, an actual payment amount (a total payment price), payment date and time information, and a payment card type.

Further, when the partial payment is normally performed in a state when the payment function is performed through one (or plural) payment representing user equipment 100 selected among the plurality of user equipment 100 which participates the partial payment, the payment representing user equipment 100 receives (or checks) the actual payment amount (or the total payment amount) provided from the service providing device 300.

Further, when there are accumulated points in accordance with the performing of the payment function (or performing of the partial payment function), each of the plurality of user equipment 100 which participates the partial payment displays (or checks) information on accumulated points which are distributed by the service providing device 300.

The user equipment 100 is configured by a user equipment communication unit 110, a user equipment storing unit 120, a user equipment display unit 130, a user equipment voice output unit 140, and a user equipment control unit 150 illustrated in FIG. 2.

The user equipment control unit 150 creates group establishing information for creating a group for a specific store. Here, the group establishing information includes a group name, identification information (or a phone number, one or more phone numbers selected from a phone book stored in advance in the user equipment 100/identification information of other user equipment 100 corresponding to the phone number) of one or more other user equipment 100 which participate the group, a number of limited participants, one or more store information (for example, including a store name, store contact information, store location information) to be checked-in by a group, basic representative payer information when the partial payment is performed, an allotment (allotment/allotted rate at the time of performing for every user, and information indicating whether receive promotion for the group.

Further, the user equipment control unit 150 transmits the created group establishing information and the identification information of the user equipment 100 to the service providing device 300 through the user equipment communication unit 110.

In the meantime, the user equipment control unit 150 transmits the one or more phone number included in the phone book which is stored in the user equipment 100 in advance and the identification information of the user equipment 100 to the service providing device 300 through the user equipment communication unit 110.

Further, the user equipment control unit 150 requests user list information to the service providing device 300 to set a group.

Further, the user equipment control unit 150 receives information (or a phone number corresponding to one or more other user equipment 100/identification information) on one or more other user equipment 100 present in the store where the user equipment 100 is currently located, transmitted from the service providing device 300 in response the previous user list information request through the user equipment communication unit 110.

Further, the user equipment control unit 150 checks whether there is a phone number corresponding to the information on the one or more other user equipment 100, among the phone numbers which are stored in the user equipment 100 in advance.

When there is at least one of phone numbers corresponding to the information on the one or more other user equipment 100, among the phone numbers which are stored in the user equipment 100 in advance, the user equipment control unit 150 transmits the checked information on at least one other user equipment 100 (or a phone number corresponding to the at least one other user equipment 100) and the identification information of the user equipment 100 to the service providing device 300 through the user equipment communication unit 110 in order to request to set a group.

Further, the user equipment control unit 150 receives the information on the set (or created) group transmitted from the service providing device 300 through the user equipment communication unit 110.

Further, the user equipment control unit 150 outputs the received information on the group through the user equipment display unit 130 and/or the user equipment voice output unit 140.

Further, when a user who carries the user equipment 100 enters a store, the user equipment control unit 150 receives the identification information (or unique identification information of the store provided with the beacon 200) of the beacon 200 transmitted from the beacon 200 through the user equipment communication unit 110.

Further, the user equipment control unit 150 transmits the received unique identification information of the beacon 200 (or the unique identification information of a store provided with the beacon 200) and identification information of the user equipment 100 to the service providing device 300 through the user equipment communication unit 110. Here, the identification information of the user equipment 100 includes a mobile directory number (MDN), a mobile IP, a mobile MAC, a subscriber identify module (Sim) card unique information, and a serial number.

Thereafter, the user equipment control unit 150 receives one or more advertisement information, one or more benefit information, and a recommended card list in response to the unique identification information of the beacon 200 which is previously transmitted and the identification information of the user equipment 100 through the user equipment communication unit 110.

Further, the user equipment control unit 150 outputs the received one or more advertisement information, one or more benefit information, and recommended card list through the user equipment display unit 130 and/or the user equipment voice output unit 140.

Further, when the user equipment 100 which visits the store is included in a group which is registered in the store in advance and all of the plurality of user equipment 100 included in the group is in the check-in status on the store, the user equipment control unit 150 receives information indicating that a group check-in for the plurality of user equipment 100 which belongs to the group is performed (or information indicating that the group check-in is performed) which is transmitted from the service providing device 300 through the user equipment communication unit 110.

Further, when the user equipment 100 which visits the store is included in a group which is registered in the store in advance and all of the plurality of user equipment 100 included in the group is in the check-in status on the store, the user equipment control unit 150 receives one or more recommended product information, one or more coupon information (for example, including discount/free coupon), and one or more promotion information which are transmitted from the service providing device 300 through the user equipment communication unit 110.

Further, the user equipment control unit 150 outputs the received information indicating that a group check-in for the plurality of user equipment 100 which belongs to the group is performed (or information indicating that the group check-in is performed), one or more recommended product information, one or more coupon information (for example, including discount/free coupon), and one or more promotion information through the user equipment display unit 130 and/or the user equipment voice output unit 140.

Further, the user equipment control unit 150 performs a payment function (or a partial payment function) on one or more products and/or service selected (or commonly selected) by the plurality of user equipment 100 which belongs to the group (or at least one user equipment 100 among the plurality of user equipment 100 which belongs to the group) by interlocking with the plurality of user equipment 100 which belongs to the group, the service providing device 300, and the payment server 500.

When the payment function is normally performed through the group, the user equipment control unit 150 receives the payment function performed result in accordance with the group check-in transmitted from the service providing device 300 through the user equipment communication unit 110. In this case, the payment function performed result (or the payment information) includes a product name (or a service name), a unique product code (a unique service code), a unit price, an amount, a discounted price, whether to apply a coupon, a price, an actual payment amount (a total payment price), payment date and time information, and a payment card type.

Further, the user equipment control unit 150 outputs the received payment function performing result through the user equipment display unit 130 and/or the user equipment voice output unit 140.

The beacon 200 communicates with the user equipment 100 and the POS terminal 400.

Further, the beacon 200 receives store information relate with the store provided with the beacon 200 or unique identification information of the store provided with the beacon 200 transmitted from the POS terminal 400.

The beacon 200 broadcasts (or transmits) store information or the identification information (or unique identification information of the store provided with the beacon 200) of the beacon 200.

The service providing device 300 communicates with the user equipment 100, the POS terminal 400, and the payment server 500.

Further, when the users of the plurality of user equipment 100 want to perform the partial payment function on the selected product or service (or used/to be purchased), the service providing device 300 communicates with the plurality of user equipment 100.

That is, when the users of the plurality of user equipment 100 which wants to perform the partial payment on one or more products or services in the store equipped with the POS terminal 400 or an online shopping mall expresses an intention of partial payment in the store or online shopping mall, the service providing device 300 receives information indicating the partial payment and identification information of the POS terminal 400 transmitted from the POS terminal 400 (or an online shopping mall server (not illustrated)).

Further, the service providing device 300 creates a partial payment registration room (for example, store A—partial payment registration #123) for partial payment based on the information indicating the partial payment and identification information of the POS terminal 400 transmitted from the POS terminal 400.

Further, the service providing device 300 allows the plurality of user equipment 100 which communicates with the service providing device 300 to access the partial payment registration room to perform a partial payment participant registration procedure for partial payment in the partial payment registration room on the plurality of user equipment 100.

Further, after completing the registration procedure on the partial payment participants (or after creating the partial payment registration room for the partial payment), the service providing device 300 creates a temporary account for the partial payment. In this case, the temporary account may be an account through which predetermined points commonly used in a plurality of predetermined sites are received, an account through which cash is transferred, and an account through which points and/or cash are received.

Further, the service providing device 300 checks a total payment amount for the products or services selected by the users of the plurality of user equipment 100 and one or more product information to be paid by interlocking with the POS terminal 400.

Further, the service providing device 300 sets an allotment for every participant based on a total payment amount and the number of the plurality of user equipment 100 which participates the partial payment. In this case, the service providing device 300 checks a payment card having the greatest benefit among one or more payment cards which are issued to the payment representing user equipment 100 among the plurality of user equipment 100 which participates the partial payment and sets an allotment for every participant for an actual payment amount obtained by applying the benefit to the total payment amount when the payment is made by the checked payment card having the greatest benefit. In this case, an allotment setting method may include a method of setting by 1/n (or equal split) based on the number of the plurality of user equipment 100, a method of setting an amount allotted to each user of an actual payment amount (or a total payment amount) for every user equipment in advance at the time of previously registering as the partial payment participants, and a method of transmitting an actual payment amount (or a total payment amount) to the plurality of user equipment 100 after checking the actual payment amount (or the total payment amount) in the service providing device 300 and receiving an allotted amount for every user equipment which is transmitted to each user equipment as a response thereof. Further, the payment representing user equipment 100 may be one of the plurality of user equipment 100 which participates the partial payment.

Next, the service providing device 300 transmits information on the allotment for every participant and the temporary account to the plurality of user equipment 100 which participates the partial payment.

In this case, the service providing device 300 transmits the information on the allotment for every participant and the temporary account to the user equipment 100 which is not a member of the service providing device 300 in the form of a text message, based on the identification information of the user equipment 100 which previously registers for the partial payment.

Further, the service providing device 300 checks the temporary account to check whether all of the actual payment amount (or total payment amount) is collected.

When all of the actual payment amount (or total payment amount) is not collected as a checking result, the service providing device 300 returns to a step of checking the temporary account to check whether all of the actual payment amounts (or total payment amount) are collected.

Further, when all the actual payment amount (or the total payment amount) is not collected within a predetermined time (for example, 10 minutes) after creating the temporary account (or after transmitting information on the allotment for every participant and the temporary account to the plurality of user equipment 100 in the service providing device 300), the service providing device 300 cancels the partial payment and transmits information indicating that the partial payment is cancelled to the plurality of user equipment 100 which participates the partial payment. Further, when the partial payment is cancelled, the service providing device 300 refunds the previously collected allotment to the user equipment 100 which provides the collected allotment.

Further, when all of the actual payment amount (or total payment amount) is collected as a checking result, the service providing device 300 transmits one or more product information to be paid, an expected payment amount (for example, including an actual payment amount and a total payment amount), discount benefit information, and the recommended card list to the previously registered payment representing user equipment 100. In this case, when the actual payment amount (or the total payment amount) is collected by points available in a predetermined site, even though there is no registered payment representing user equipment 100 among the plurality of user equipment 100, the service providing device 300 collects the points available in a predetermined site from the plurality of user equipment 100 and the performs the payment function through the collected points by interlocking with the payment server 500.

That is, when all the actual payment amount (or the total payment amount) is collected, the service providing device 300 checks one or more benefit information which can be provided to the user equipment 100 in the store equipped with the POS terminal 400, among the plurality of advertisement information and the plurality of benefit information stored in advance, based on the identification information of the previously registered payment representing user equipment 100.

Further, the service providing device 300 creates a recommended card list including one or more recommended cards to which the benefit information may be applied (or reflected) among a plurality of cards issued to the payment representing user equipment 100, based on one or more checked benefit information. Here, the benefit information includes coupon information, membership benefit information, discount benefit information, and accumulation benefit information.

The service providing device 300 transmits one or more benefit information which can be provided to the user equipment 100 which performs the checked partial payment function, a recommended card list including one or more recommended cards, one or more product information to be paid, and an expected payment amount to the user equipment 100 of the representative payer.

Further, the service providing device 300 receives the payment card type (or unique identification information of the payment card), the PIN number, and the identification information of the payment representing user equipment 100 which are transmitted from the payment representing user equipment 100 in response to the previously transmitted one or more benefit information, recommended card list including one or more recommended cards, one or more product information to be paid, and expected payment amount.

Further, the service providing device 300 transmits one or more product information to be paid, an actual payment amount (or the total payment amount), card information corresponding to a PIN number, user information, and benefit information to the payment server 500. Here, the card information includes a card number, expiration date, a card verification code (CVC) number, and a user name. The user information includes a user name, birth date, an address, and an image. Further, the benefit information includes coupon information, membership benefit information, discount benefit information, and accumulation benefit information.

That is, the service providing device 300 receives the payment card type (or unique identification information of the payment card), the PIN number, and identification information of the payment representing user equipment 100 which is transmitted from the payment representing user equipment 100 in response to the one or more benefit information and the recommended card list including one or more recommended cards which are previously transmitted to the payment representing user equipment 100. Further, the service providing device 300 checks card information, user information, and benefit information which are stored in the service providing device 300 in advance, in regard to the PIN number (or the identification information of the payment representing user equipment 100) and transmits the checked card information, user information, benefit information, one or more product information to be paid, and the actual payment amount (or the total payment amount) to the payment service 500.

When the partial payment function is normally performed, the service providing device 300 receives the payment function performed result (or payment information) and accumulated point information in accordance with the performing of the payment function transmitted from the payment server 500 in response to the previously transmitted card information.

Further, the service providing device 300 transmits the payment function performed result (or the payment information) to the plurality of user equipment 100 which participates the partial payment.

Further, the service providing device 300 provides (or transmits) the previously collected actual payment amount (or the total payment amount) to the payment representing user equipment 100 (or a predetermined account of the payment representing user equipment 100).

Further, when there are accumulated points in accordance with the performing of the payment function (or points in accordance with the payment are generated after performing the payment function), the service providing device 300 distributes the accumulated points in accordance with the allotment for every participant.

Further, the service providing device 300 sets an allotment for every participant based on a total payment amount and the number of the plurality of user equipment 100 which participates the partial payment. In this case, an allotment setting method may include a method of setting by 1/n (or equal split) based on the number of the plurality of user equipment 100, a method of setting an amount allotted to each user of an actual payment amount (or a total payment amount) for every user equipment in advance at the time of previously registering as the partial payment participants, and a method of transmitting an actual payment amount (or a total payment amount) to the plurality of user equipment 100 after checking the actual payment amount (or the total payment amount) in the service providing device 300 and receiving an allotted amount for every user equipment which is transmitted to each user equipment as a response thereof. Here, the actual payment amount is an amount obtained by applying benefit information to the payment amount. When the benefit information is not applied, the actual payment amount may be equal to the total payment amount.

Further, the service providing device 300 checks one or more payment card information (or a payment card) for every user equipment which is issued (or registered) in advance for every user equipment to the plurality of user equipment 100.

In this case, the service providing device 300 may collect one or more payment card information which is issued in advance to each of the plurality of user equipment 100.

Further, the service providing device 300 selects one (or plural) payment card (or payment card for every user equipment) having the greatest discount benefit for every user equipment when the payment is performed.

Further, the service providing device 300 calculates a difference between a reference amount of a payment card corresponding to the user equipment to get the discount benefit of the selected payment card for every user equipment and an allotment corresponding to the corresponding user equipment among the allotments for participants.

When the calculated difference is larger than zero (the reference amount of the payment card to get the discount benefit is larger to the allotment corresponding to the user equipment), the service providing device 300 checks (or determines/compares) whether the calculated difference is smaller than the discount amount (or a compensation amount) obtained by applying a discount benefit of the payment card to the allotment corresponding to the user equipment.

When the difference between the reference amount of the payment card to apply the discount benefit of the payment card for every user equipment and the allotment corresponding to the user equipment among the allotments of the participants is equal to or larger than the discounted amount (or a compensation amount) obtained by applying the discount benefit of the payment card to the allotment corresponding to the user equipment as a checking result (or determination/comparison result) (or when the reference amount of the payment card corresponding to the user equipment to apply the discount benefit of the payment card for every user equipment is equal to or smaller than the allotment corresponding to the user equipment or the difference is negative), the service providing device 300 sets the previously set allotment for every participant as a final allotment for every participant.

When the difference between the reference amount of the payment card to apply the discount benefit of the selected payment card for every user equipment and the allotment corresponding to the user equipment among the allotments of the participants is smaller than the discounted amount (or a compensation amount) obtained by applying the discount benefit of the payment card to the allotment corresponding to the user equipment as a checking result (or determination/comparison result) (or when the reference amount of the payment card corresponding to the user equipment which participates the partial payment is larger than the allotment and/or the difference is smaller than the discounted amount), the service providing device 300 raises the allotment of specific user equipment to the reference amount of the payment card related with the specific user equipment to receive the discount benefit so that at least one user equipment in which the difference is smaller than the discounted amount receives the discount benefit and lowers the allotment of one or more user equipment among the remaining user equipment excluding the specific user equipment to adjust the previously set allotment for every participant and then sets the adjusted allotment for every participant as a final allotment for every participant. In this case, the service providing device 300 lowers the allotment of one or more user equipment among the remaining user equipment as much as an amount of the former allotment of the specific user equipment which is raised to the reference amount of the payment card related with the specific user equipment (for example, a difference between the reference amount and the former allotment) to be adjusted to the actual payment amount (or the total payment amount).

Further, the service providing device 300 transmits the set final allotment for every participant, a recommended card list for every user equipment, discount benefit information corresponding to the recommended card (or a recommended payment card), and one or more product information to be paid to the plurality of user equipment 100. In this case, the service providing device 300 may transmit the allotment (or an allotment corresponding to the corresponding user equipment among the final allotments for every participant), the recommended card list (or a recommended card list corresponding to the user equipment among recommended card lists for every participant), discount benefit information corresponding to the recommended card, and one or more product information to be paid for every user equipment.

Further, the service providing device 300 checks one (or plural) payment card having the greatest benefit (for example, including a discount benefit and an accumulation benefit) among a plurality (all) of payment cards which is issued to the plurality of user equipment 100 which participates the partial payment.

In this case, the service providing device 300 collects information on a plurality of payment cards which is issued in advance to the plurality of user equipment 100 and checks one (or plural) payment card having the greatest benefit among the plurality of collected payment cards.

Further, the service providing device 300 selects one (or plural) user equipment 100 to which the payment card having the greatest benefit is issued, among the plurality of user equipment 100 which participates the partial payment, as a represent payer (or a payment representing user equipment) who performs an actual payment function.

Further, the service providing device 300 sets an allotment for every participant based on a total payment amount and the number of the plurality of user equipment 100 which participates the partial payment, with respect to an actual payment amount obtained by applying the benefit to the checked total payment amount.

Further, the service providing device 300 creates a temporary account for partial payment. In this case, the temporary account may be an account through which predetermined points commonly used in a plurality of predetermined sites are received, an account through which cash is transferred, and an account through which points and/or cash are received.

Further, the service providing device 300 transmits the received one or more product information to be paid, allotment for every participant, recommended card list including a recommended card having the greatest benefit, benefit information, and actual payment amount to which the benefit information is applied, to the user equipment (or the payment representing user equipment) 100 of the representative payer.

Further, the service providing device 300 transmits the allotment for every participant, information on the temporary account, one or more product information to be paid, and representative payer information to the remaining user equipment 100 excluding the payment representing user equipment 100 from the plurality of user equipment 100.

Further, the service providing device 300 receives the payment card type, the PIN number, and the identification information of the user equipment 100 which are transmitted for every user equipment, in response to the previously transmitted final allotment for every participant and the recommended card list for every user equipment.

Further, when the service providing device 300 receives all the payment card type, the PIN number, and the identification information of the user equipment 100 from the plurality of user equipment 100 which participates the partial payment, the service providing device 300 transmits one or more product information to be paid, the payment card type, the PIN number, and the identification information of the user equipment 100, the final allotment for every participant, card information corresponding to the PIN number for every user equipment, the user information, and the benefit information to the payment server 500. Here, the card information includes a card number, expiration date, a card verification code (CVC) number, and a user name. The user information includes a user name, birth date, an address, and an image. Further, the benefit information includes coupon information, membership benefit information, discount benefit information, and accumulation benefit information.

That is, the service providing device 300 receives the payment card type, the PIN number, and the identification information of the user equipment 100 which are transmitted for every user equipment, in response to the previously transmitted final allotment for every participant and the recommended card list for every user equipment. Further, the service providing device 300 checks the card information for every user equipment, the user information for every user equipment, and the benefit information for every user equipment which are stored in advance in the service providing device 300, in regard to the PIN number for every user equipment (or identification information for every user equipment) and transmits the checked card information for every user equipment, user information for every user equipment, benefit information for every user equipment, one or more product information to be paid, and final allotment for every participant to the payment server 500.

Further, when all the payment card type, the PIN number, and the identification information of the user equipment 100 are not received from the plurality of user equipment 100 within a predetermined time (for example, 10 minutes) after transmitting the information on the final allotment for every participant from the service providing device 300 to the plurality of user equipment 100, the service providing device 300 cancels the partial payment and transmits information indicating that the partial payment is cancelled to the plurality of user equipment 100 which participates the partial payment.

Further, the service providing device 300 receives the payment card type (or unique identification information of the payment card), the PIN number, and identification information of the payment representing user equipment 100 which is transmitted from the payment representing user equipment 100 in response to the one or more benefit information and the recommended card list including one or more recommended cards which are previously transmitted to the payment representing user equipment 100.

Further, the service providing device 300 checks the temporary account to whether all of the actual payment amount (or total payment amount) is collected. In this case, the service providing device 300 may check whether all amounts excluding the allotment corresponding to the user equipment 100 of the representative payer are collected.

When all the actual payment amounts are not collected (or when all payment amounts excluding the allotment of the payment representing user equipment among the actual payment amounts are not collected) as a checking result, the service providing device 300 returns to a step of checking the temporary account to check whether all the actual payment amounts are collected.

Further, when all the actual payment amount (or the total payment amount) is not collected within a predetermined time (for example, 10 minutes) after creating the temporary account (or after transmitting information on the allotment for every participant and the temporary account to the plurality of user equipment 100 in the service providing device 300), the service providing device 300 cancels the partial payment and transmits information indicating that the partial payment is cancelled to the plurality of user equipment 100 which participates the partial payment. Further, when the partial payment is cancelled, the service providing device 300 refunds the previously collected allotment to the user equipment 100 which provides the collected allotment.

Further, when all the actual payment amounts are collected (or when all payment amounts excluding the allotment of the payment representing user equipment among the actual payment amounts are collected) as a checking result, the service providing device 300 transmits one or more product information to be paid, the actual payment amount (or the total payment amount), the card information, the user information, and the benefit information corresponding to the PIN number (or the identification information of the user equipment 100 of the representative payer) related with the user equipment 100 of the representative payer which is received in advance to the payment server 500. Here, the card information includes a card number, expiration date, a card verification code (CVC) number, and a user name. The user information includes a user name, birth date, an address, and an image. Further, the benefit information includes coupon information, membership benefit information, discount benefit information, and accumulation benefit information.

Further, after normally performing the payment function on the plurality of user equipment 100, the service providing device 300 receives a payment function performed result (or payment information for every user equipment) for every user equipment and accumulated point information in accordance with the performing of payment function for every user equipment, transmitted from the payment server 500. Here, the payment function performed result (or the payment information) includes a product name (or a service name), a unique product code (a unique service code), a unit price, an amount, a discounted price, whether to apply a coupon, a price, an actual payment amount (a total payment price), payment date and time information, and a payment card type.

Further, the service providing device 300 transmits the payment function performed result and the accumulated point information in accordance with the performing of payment function to the plurality of user equipment 100 which participates the partial payment.

Further, the service providing device 300 provides (or transmits) the previously collected actual payment amount (or the total payment amount or a payment amount excluding the allotment of the payment representing user equipment among the actual payment amounts) to the payment representing user equipment 100 (or a predetermined account of the payment representing user equipment 100). In this case, when a plurality of representative payers is selected, the service providing device 300 divides the previous collected actual payment amount in accordance with a ratio paid by the plurality of representative payers and provides the divided payment amount to the plurality of payment representing user equipment 100 corresponding to the plurality of representative payers.

Further, when there are accumulated points in accordance with the performing of the payment function (or points in accordance with the payment are generated after performing the payment function), the service providing device 300 distributes the accumulated points in accordance with the allotment for every participant.

Further, the service providing device 300 sets (or creates) a group for a specific store by interlocking with the plurality of user equipment 100.

Further, the service providing device 300 receives group establishing information and the identification information of the user equipment 100 transmitted from the user equipment 100. Here, the group establishing information includes a group name, identification information (or a phone number, one or more phone numbers selected from a phone book stored in advance in the user equipment 100/identification information of other user equipment 100 corresponding to the phone number) of one or more other user equipment 100 which participate the group, a number of limited participants, one or more store information (for example, including a store name, store contact information, store location information) to be checked-in by a group, basic representative payer information when the partial payment is performed, an allotment (allotment/allotted rate at the time of performing for every user, and information indicating whether receive promotion for the group.

Further, the service providing device 300 sets a group corresponding to the group name based on the received group establishing information.

The service providing device 300 sets a group including at least one user equipment which participates the group among the plurality of user equipment based on the identification information of the plurality of user equipment 100 which previously performs the partial payment function through the specific store.

Further, the service providing device 300 receives one or more phone numbers included in the phone book stored in advance of the user equipment 100 and the identification information of the user equipment 100 which are transmitted from the user equipment 100.

Further, when there is at least one of other user equipment 100 which simultaneously visits (or visits at an approximate time) and simultaneously leaves (leaves the store at an approximate time) the store where the user equipment 100 visits a predetermined number of times or more, among one or more of other user equipment 100 corresponding to one or more phone numbers, the service providing device 300 sets a group including the corresponding user equipment 100 and at least one of other user equipment 100.

Further, when there is a request of the user list information from the user equipment, the service providing device 300 transmits information (or a phone number corresponding to one or more other user equipment 100/identification information) on one or more other user equipment 100 present in the store where the user equipment 100 is currently located to the user equipment 100.

Further, the service providing device 300 receives information (or a phone number corresponding to one or more other user equipment 100) on one or more other user equipment 100 transmitted from the user equipment 100 and the identification information of the user equipment 100 in response to the previously transmitted information on one or more other user equipment 100 present in the store where the user equipment 100 is currently located.

Further, the service providing device 300 sets a group including at least one other user equipment 100 and the corresponding user equipment 100.

After setting the group by the above-described method, the service providing device 300 transmits information on the set (or created) group to the plurality of user equipment 100 included in the group. Here, the information on the group includes a group name, identification information (or a phone number, one or more phone numbers selected from a phone book stored in advance in the user equipment 100/identification information of other user equipment 100 corresponding to the phone number) of one or more other user equipment 100 which participate the group, a number of limited participants, one or more store information (for example, including a store name, store contact information, store location information) to be checked-in by a group, basic representative payer information when the partial payment is performed, an allotment (allotment/allotted rate at the time of performing for every user, and information indicating whether receive promotion for the group.

Further, the service providing device 300 may additionally set (or change/modify) basic representative payer information, an allotment for every participant, information indicating whether to receive promotion for the group at the time of partial payment by interlocking with the plurality of user equipment 100 included in the group, with respect to the previously set (or created) group for a specific store.

Further, the service providing device 300 receives the unique identification information of the beacon 200 and the identification information of the user equipment 100 transmitted from the user equipment 100.

Further, the service providing device 300 checks (or registers/sets/maintains) a check-in status (or a personal check-in status) for a store where the user equipment 100 visits with respect to the user equipment 100.

Further, the service providing device 300 checks one or more advertisement information and one or more benefit information which can be provided to the user equipment 100 in the store equipped with the beacon 200, among a plurality of advertisement information and a plurality of benefit information stored in advance, based on the received unique identification information of the beacon 200 and identification information of the user equipment 100.

That is, the service providing device 300 checks store information corresponding to the unique identification information of the beacon 200 among store information for every unique identification information of a plurality of beacons which is stored in advance. Further, the service providing device 300 checks one or more advertisement information and benefit information which may be provided to the user equipment 100 in the store based on the checked store information and the received identification information of the user equipment 100.

Further, the service providing device 300 creates a recommended card list including one or more recommended cards to which the benefit information may be applied (or reflected) among a plurality of cards issued to the user equipment 100, based on one or more checked benefit information. Here, the benefit information includes coupon information, membership benefit information, and discount benefit information.

The service providing device 300 transmits one or more advertisement information, one or more benefit information, and a recommended card list including one or more recommended cards which may be provided to the user equipment 100 in the store equipped with the checked beacon 200 to the user equipment 100.

As described above, the service providing device 300 performs a check-in function (or a personal check-in function) for individual users of the user equipment 100 and provides promotion information for the personal.

Further, the service providing device 300 checks whether there is a group related with the user equipment 100 in the store where the user equipment 100 visits.

That is, the service providing device 300 checks whether there is a group related with the user equipment 100 in the store where the user equipment 100 visits among one or more groups for every store which is registered (or stored) in advance.

When there is no group related with the user equipment 100 in the store where the user equipment 100 visits as a checking result, the service providing device 300 does not perform a group check-in process.

Further, when there is a group related with the user equipment 100 in the store where the user equipment 100 visits as a checking result, the service providing device 300 determines whether all of the plurality of user equipment 100 which belongs to the group is in the check-in status in the store.

When all of the plurality of user equipment 100 which belongs to the group is not in the check-in status in the store as a determination result, the service providing device 300 returns to a previous step of determining whether all of the plurality of user equipment 100 which belongs to the group is in the check-in status in the store.

Further, when all of the plurality of user equipment 100 which belongs to the group is in the check-in status in the store as a determination result, the service providing device 300 checks one or more recommended product information, one or more coupon information (for example, including a discount/free coupon), one or more promotion information, which can be provided to the group among a plurality of benefit information for every store which is stored in advance, based on previous purchase records of the group and transmits the checked one or more recommended product information, one or more coupon information (for example, including a discount/free coupon), one or more promotion information, which can be provided to the group, to the plurality of user equipment 100 which belongs to the group. In this case, the service providing device 300 may transmit one or more recommended product information, one or more coupon information (for example, including a discount/free coupon), one or more promotion information only to payment representing user equipment 100 which is set in advance for the group.

Further, the service providing device 300 transmits information indicating that group check-in for the plurality of user equipment 100 which belongs to the group is performed (or information indicating that group check-in is performed) to the plurality of user equipment 100 which belongs to the group to notify the group check-in status.

Further, the service providing device 300 may transmit the information indicating that group check-in is performed together with one or more recommended product information, one or more coupon information (for example, including a discount/free coupon), one or more promotion information to the plurality of user equipment 100 which belongs to the group.

Further, when the group is newly created, the service providing device 300 may check one or more recommended product information, one or more coupon information (for example, including a discount/free coupon), one or more promotion information, which can be provided to the group among a plurality of benefit information for every store which is stored in advance and transmit the checked one or more recommended product information, one or more coupon information (for example, including a discount/free coupon), one or more promotion information, which can be provided to the group, to the plurality of user equipment 100 which belongs to the group.

Further, the service providing device 300 performs a payment function (or a partial payment function) on one or more products and/or service selected (or commonly selected) by the plurality of user equipment 100 which belongs to the group (or at least one user equipment 100 among the plurality of user equipment 100 which belongs to the group) by interlocking with the plurality of user equipment 100 which belongs to the group. In this case, the service providing device 300 may immediately perform the partial payment function based on the information which is set in advance for the group (for example, including an allotment for every participant and a payment method (including equal payment and representative payment)). Here, the service providing device 300 may apply a simple payment function to perform the payment function in accordance with the above-described simple payment function by interlocking with the plurality of user equipment 100 which belongs to the group.

Further, the service providing device 300 provides the payment function performed result to the plurality of user equipment 100 which belongs to the group. In this case, the payment function performed result (or the payment information) includes a product name (or a service name), a unique product code (a unique service code), a unit price, an amount, a discounted price, whether to apply a coupon, a price, an actual payment amount (a total payment price), payment date and time information, and a payment card type.

Further, the service providing device 300 manages (or stores) purchasing information of one or more products and/or services paid by the group as a purchasing record of the group together with a purchasing record for each user equipment 100.

The POS terminal 400 communicates with the user equipment 100, the service providing device 300, and the payment server 500.

The POS terminal 400 scans (or recognizes a barcode attached on a product to be paid) one or more products (or payment products) to be paid which are selected by the users of the plurality of user equipment 100.

The POS terminal 400 displays product information on one or more scanned (or recognized) products to be paid. Here, the product information includes a product name, a unique product code, a unit price, an amount, a price, a total price, and the like.

Further, the POS terminal 400 checks service information for a service to be paid, which is selected (or used) by the users of the plurality of user equipment 100, and displays the checked service information. Here, the service information includes a service name, a unique service code, a unit price, an amount, a price, a total price, and the like.

In the exemplary embodiment of the present invention, a POS terminal 400 equipped in the offline store has been described, but the present invention is not limited thereto. Technical configurations of the present invention may be configured by interlocking with the online and/or offline stores.

That is, when the users of the plurality of user equipment 100 which wants to perform the partial payment on one or more products or services in the store equipped with the POS terminal 400 or an online shopping mall expresses an intention of partial payment in the store or online shopping mall, the POS terminal (or an online shopping mall server (not illustrated) communicates with the service providing device 300 and transmits information indicating the partial payment and identification information of the POS terminal 400 to the service providing device 300.

Further, the POS terminal 400 transmits a total payment amount for the products or services selected by the users of the plurality of user equipment 100 and one or more product information to be paid to the service providing device 300.

Further, the POS terminal 400 receives a payment function performed result (or payment information) transmitted from the payment server 500. Here, the payment function performed result (or the payment information) includes a product name (or a service name), a unique product code (a unique service code), a unit price, an amount, a discounted price, whether to apply a coupon, a price, an actual payment amount (a total payment price), payment date and time information, and a payment card type.

The POS terminal 400 transmits the received payment function performed result to the user equipment 100.

Further, the POS terminal 400 may output the received payment function performed result through a printed matter such as a receipt.

The payment server 500 communicates with the user equipment 100, the service providing device 300, and the POS terminal 400.

Further, the payment server 500 receives one or more product information to be paid, an actual payment amount (or the total payment amount), card information corresponding to a PIN number, user information, and benefit information transmitted from the service providing device 300.

The payment server 500 performs a payment function on the actual payment amount (or the total payment amount) corresponding to one or more product information to be paid based on the received card information, user information, and benefit information. In this case, the payment server 500 may perform a payment function on the actual payment amount (or the total payment amount) obtained by applying a benefit amount corresponding to the benefit information transmitted from the service providing device 300 (or benefit information which may be applied to the user of the user equipment 100) to price information on one or more products to be paid.

The payment server 500 transmits the payment function performed result (or payment information) to the POS terminal 400 and the service providing device 300. Here, the payment function performed result (or the payment information) includes a product name (or a service name), a unique product code (a unique service code), a unit price, an amount, a discounted price, whether to apply a coupon, a price, an actual payment amount (a total payment price), payment date and time information, and a payment card type.

In this case, when an accumulated point which is accumulated in accordance with the performing of the payment function is generated, the payment server 500 may transmit the payment function performed result and accumulated point information in accordance with the performing of the payment function to the POS terminal 400 and the service providing device 300.

Further, when the partial payment function is performed according to the allotment for every participant individually set for every user equipment in the plurality of user equipment 100 which participates the partial payment, the payment server 500 receives one or more product information to be paid, the final allotment for every participant, card information, user information, and benefit information corresponding a PIN number for every user equipment which are transmitted from the service providing device 300.

Further, the payment server 500 performs a partial payment function for an allotment for every participant for every user equipment, based on the card information, the user information, and the benefit information corresponding to the received allotment for every participant and the PIN number for every user equipment. In this case, the payment server 500 may perform the payment function on a payment amount (or an actual payment amount) obtained by applying a benefit amount corresponding to the benefit information transmitted from the service providing device 300 (or benefit information which may be applied to the user of the user equipment 100) to the final allotment for every participant.

Further, when the partial payment function is performed by the payment representing user equipment 100 which is a representative payer selected from the plurality of user equipment 100, the payment server 500 receives one or more product information to be paid, the actual payment amount (or the total payment amount) card information, user information, and benefit information corresponding a PIN number (or identification information of the user equipment 100 of the representative payer) which are transmitted from the service providing device 300.

The payment server 500 performs a payment function on the actual payment amount (or the total payment amount) corresponding to one or more product information to be paid based on the received card information, user information, and benefit information. In this case, the payment server 500 may perform a payment function on the actual payment amount (or the total payment amount) obtained by applying a benefit amount corresponding to the benefit information transmitted from the service providing device 300 (or benefit information which may be applied to the user of the user equipment 100) to price information on one or more products to be paid.

The payment server 500 transmits the payment function performed result (or payment information for every user equipment) for every user equipment to the POS terminal 400 and the service providing device 300. Here, the payment function performed result (or the payment information for every user equipment) for every user equipment includes a product name (or a service name), a unique product code (a unique service code), a unit price, an amount, a discounted price, whether to apply a coupon, a price, an actual payment amount (a total payment price), payment date and time information, and a payment card type.

In this case, when an accumulated point which is accumulated in accordance with the performing of the payment function is generated, the payment server 500 may transmit the payment function performed result for every user equipment and accumulated point information for every user equipment in accordance with the performing of the payment function for every user equipment to the POS terminal 400 and the service providing device 300.

As described above, when the partial payment is performed, after making a payment by user equipment which is carried by the representative payer, the remaining participants accurately provide the allotments to the representative payer and a user who is not a member of the related service may also participate the partial payment.

Further, as described above, the points generated according to the representative payment are divided and transmitted to the participants.

Further, as described above, the remaining participants for the representative payment of the partial payment transmit the allotments to a temporary account in advance before an actual payment and the entire collected allotments are transmitted to the representative payer when the representative payer actually makes a payment.

Further, as described above, when the partial payment is performed, a service providing device including a payment means information for a user who participates the partial payment may recommend an optimal partial payment method in consideration of benefits for the payment means and an allotment for every participant.

Further, as described above, it is possible to readjust an allotment for every participant which is set in advance according to payment means related with a plurality of user equipment which participates partial payment when partial payment is performed or allow one or more user equipment which is a representative payer to make a payment as a representative and allow the remaining participants to transmit allotments (or adjusted allotments) to which a discounted amount is applied to the one or more user equipment which is the representative payer.

Further, as described above, when a user who carries user equipment visits a store, the service providing device provides a check-in service for visiting the store, and when all user equipment of a group including the user equipment visit the store, performs a product recommending function, a promotion information providing function based on previous purchase records of the group.

Further, as described above, when the partial payment is performed, it is possible to effectively select participants which participate the partial payment among information on users who actually visit the store.

Further, as described above, when the partial payment is performed, it is possible to display information on one or more user equipment on a phone book of the user equipment among a plurality of user equipment which is in a check-in status in a store, register the user equipment as partial payment participants for partial payment by interlocking with at least one user equipment selected from one or more displayed user equipment, collect an allotment for every participant from users who participate the partial payment when the partial payment is performed in a service providing device, collects payment means information which is issued in advance for every user equipment which is a user, and perform a payment function according to the allotment for every participant and payment means information for every participant by interlocking with the user equipment, a POS terminal, and a payment server.

Hereinafter, a control method of a payment system according to an exemplary embodiment of the present invention will be described in detail with reference to FIGS. 1 to 35.

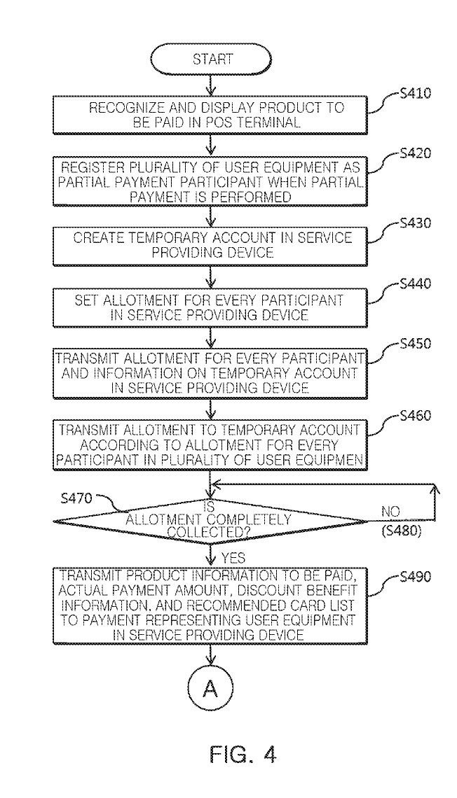

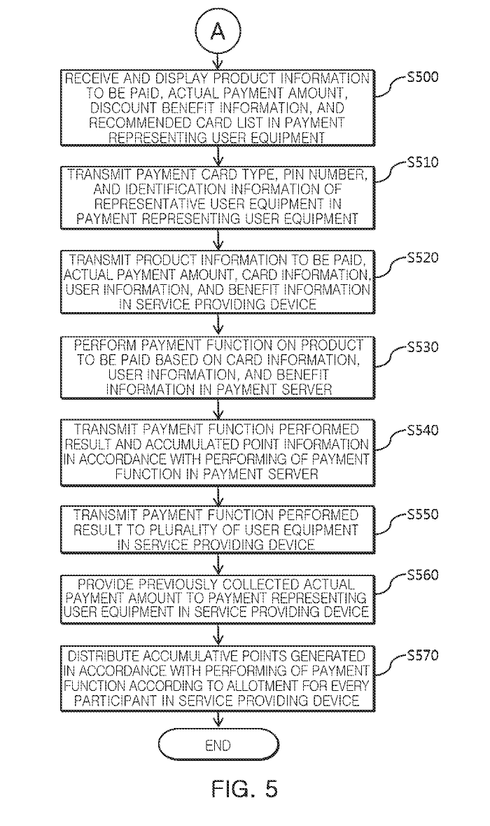

FIGS. 4 and 5 are flow charts illustrating a control method of a payment system according to an exemplary embodiment of the present invention.

First, the POS terminal 400 scans (or recognizes a barcode attached on a product to be paid) one or more products (or payment products) to be paid which are selected by the users of the plurality of user equipment 100.

The POS terminal 400 displays product information on one or more scanned (or recognized) products to be paid. Here, the product information includes a product name, a unique product code, a unit price, an amount, a price, a total price, and the like.

Further, the POS terminal 400 checks service information for a service to be paid, which is selected (or used) by the users of the plurality of user equipment 100, and displays the checked service information. Here, the service information includes a service name, a unique service code, a unit price, an amount, a price, a total price, and the like.

For example, the POS terminal 400 recognizes barcodes attached on eleventh to thirteenth products which are selected by users of the plurality of user equipment 100 and displays product information on the recognized eleventh to thirteenth products.

As another example, the POS terminal 400 displays service information on eleventh to fourteenth services which are used by users of the plurality of another user equipment 100 (S410).

Thereafter, when the users of the plurality of user equipment 100 want to perform the partial payment function on the selected product or service (or used/to be purchased), the service providing device 300 communicates with the plurality of user equipment 100. In this case, one (or at least one) user equipment 100 of the plurality of user equipment 100 is registered (or selected) as a representative payer (or payment representing user equipment) which performs an actual payment function.

That is, when the users of the plurality of user equipment 100 which wants to perform the partial payment on one or more products or services in the store equipped with the POS terminal 400 or an online shopping mall expresses an intention of partial payment in the store or online shopping mall, the POS terminal (or an online shopping mall server (not illustrated) communicates with the service providing device 300 and transmits information indicating the partial payment and identification information of the POS terminal 400 to the service providing device 300. Thereafter, the service providing device 300 creates a partial payment registration room (for example, store A—partial payment registration #123) for partial payment based on the information indicating the partial payment and identification information of the POS terminal 400 transmitted from the POS terminal 400. Next, the plurality of user equipment 100 which accesses the service providing device 300 accesses the created partial payment registration room to register as partial payment participants for the partial payment in the partial payment registration room.

For example, when the partial payment function on eleventh to thirteenth products selected by users of first to fourth user equipment 100 is performed, the first to fourth user equipment 100 accesses the service providing device 300 to register as partial payment participants for the partial payment. In this case, third user equipment 100 among the first to fourth user equipment 100 registers as payment representing user equipment which performs the actual payment function.

As another example, when the partial payment function on eleventh to fourteenth services selected by users of eleventh to fifteenth user equipment 100 is performed, the eleventh to fifteenth user equipment 100 accesses the service providing device 300 to register as partial payment participants for the partial payment. In this case, twelfth user equipment 100 among the eleventh to fifteenth user equipment 100 registers as payment representing user equipment which performs the actual payment function (S420).

Next, the service providing device 300 creates a temporary account for partial payment. In this case, the temporary account may be an account through which predetermined points commonly used in a plurality of predetermined sites are received, an account through which cash is transferred, and an account through which points and/or cash are received.

For example, the service providing device 300 creates a first temporary account (for example, 123-456-789) through which points commonly used in a plurality of predetermined sites for the partial payment are received.

As another example, the service providing device 300 creates a second temporary account (for example, 987-654-321) through which points and cash commonly used in a plurality of predetermined sites for the partial payment are transferred (S430).

Next, the service providing device 300 checks a total payment amount for the products or services selected by the users of the plurality of user equipment 100 and one or more product information to be paid by interlocking with the POS terminal 400.

Further, the service providing device 300 sets an allotment for every participant based on a total payment amount and the number of the plurality of user equipment 100 which participates the partial payment. In this case, the service providing device 300 checks a payment card having the greatest benefit among one or more payment cards which are issued to the payment representing user equipment 100 among the plurality of user equipment 100 which participates the partial payment and sets an allotment for every participant for an actual payment amount obtained by applying the benefit to the total payment amount when the payment is made by the checked payment card having the greatest benefit. In this case, an allotment setting method may include a method of setting by 1/n (or equal split) based on the number of the plurality of user equipment 100, a method of setting an amount allotted to each user of an actual payment amount (or a total payment amount) for every user equipment in advance at the time of previously registering as the partial payment participants, and a method of transmitting an actual payment amount (or a total payment amount) to the plurality of user equipment 100 after checking the actual payment amount (or the total payment amount) in the service providing device 300 and receiving an allotted amount for every user equipment which is transmitted to each user equipment as a response thereof. Further, the payment representing user equipment 100 may be one of the plurality of user equipment 100 which participates the partial payment. Here, the actual payment amount is an amount obtained by applying benefit information to the payment amount. When the benefit information is not applied, the actual payment amount may be equal to the total payment amount.

For example, the service providing device 300 receives a total payment amount (for example, 30000 won) on the eleventh to thirteenth products and product information on the eleventh to thirteenth products transmitted from the POS terminal 400. Further, the service providing device 300 sets an allotment of 13500 won to the third user equipment 100 which is a representative payer and sets an allotment of 4500 won to the remaining first, second, and fourth user equipment 100, in accordance with an actual payment amount (for example, 27000 won obtained by applying 10% discount to a total payment amount of 30000 won) when a payment card AA having the greatest benefit (for example, 10% discount when 30000 won or more is paid by the payment card AA) among the payment cards registered to the third user equipment 100 which is a representative payer is applied to the total payment amount (for example, 30000 won) for the eleventh to thirteenth products and an allotted amount for every user equipment which is set in advance in the first to fourth user equipment which participates the partial payment.

As another example, the service providing device 300 receives a total payment amount (for example, 50,000 won) on the eleventh to fourteenth services and service information on the eleventh to fourteenth services transmitted from the POS terminal 400. Further, the service providing device 300 sets an allotment of 10000 won for every participant which is the same amount for every user equipment according to a predetermined equal split based on the total amount (for example, 50000 won) for the eleventh to fourteenth services and the number of eleventh to fifteenth user equipment 100 which participates the partial payment.

Next, the service providing device 300 transmits information on the allotment for every participant and the temporary account to the plurality of user equipment 100 which participates the partial payment.

In this case, the service providing device 300 transmits the information on the allotment for every participant and the temporary account to the user equipment 100 which is not a member of the service providing device 300 in the form of a text message, based on the identification information of the user equipment 100 which previously registers for the partial payment.

For example, the service providing device 300 transmits first information including a first allotment for every participant (for example, including an allotment of first user equipment of 4500 won, an allotment of second user equipment of 4500 won, an allotment of third user equipment of 13500 won, and an allotment of fourth user equipment of 4500 won) and a first temporary account (for example, 123-456-789) to the first to fourth user equipment 100.

As another example, the service providing device 300 transmits second information including a second allotment for every participant (for example, an allotment of eleventh to fifteenth user equipment of 10000 won) and a second temporary account (for example, 987-654-321) to the eleventh to fifteenth user equipment 100. In this case, the service providing device 300 transmits the second information to the fourteenth user equipment 100 which is not a member of the service providing device 300 in the form of a text message (S450).

Next, the plurality of user equipment 100 receives information on the allotment for every participant and the temporary account which are transmitted from the service providing device 300.

Further, the user equipment 100 displays the received information on the allotment for every participant and the temporary account.

In this case, when the user equipment 100 is a member which joins the service providing device 300 in advance, the user equipment 100 displays the previously received information on the allotment for every participant and the temporary account through an app which is installed in advance in the user equipment 100.

Further, when the user equipment 100 is not a member which joins the service providing device 300 in advance, the user equipment 100 displays the previously received information on the allotment for every participant and the temporary account which is transmitted as a text message from the service providing device 300.

Further, each of the plurality of user equipment transmits (or transfers) an allotment corresponding to the user equipment among allotments for every participant to the temporary account in accordance with the selection (or input/control) of the user of the user equipment 100. In this case, the allotment includes cyber money (for example, including points or accumulated money available in a specific site) and cash.

For example, the first to fourth user equipment 100 receives the first information including the first allotments for every participant (for example, including an allotment of the first user equipment of 4500 won, an allotment of the second user equipment of 4500 won, an allotment of the third user equipment of 13500 won, and an allotment of the fourth user equipment of 4500 won) and the first temporary account (for example, 123-456-789) transmitted from the service providing device 300. Further, the first to fourth user equipment 100 transmits an amount (for example, points) corresponding to the first allotment for every participant to the first temporary account.

As another example, the eleventh to fifteenth user equipment 100 receives the second information including the second allotment for every participant (for example, an allotment of eleventh to fifteenth user equipment of 10000 won) and the second temporary account (for example, 987-654-321) transmitted from the service providing device 300. Further, the eleventh to fifteenth user equipment 100 transmits (or transfers) an amount (for example, including points and cash) corresponding to the second allotment for every participant to the second temporary account (S460).

Next, the service providing device 300 checks the temporary account to check whether all of the actual payment amount (or total payment amount) is collected.

For example, the service providing device 300 checks the first temporary account to check whether the actual payment amount of 27000 won is collected.

As another example, the service providing device 300 checks the second temporary account to check whether the actual payment amount of 50,000 won is collected (S470).

When all of the actual payment amount (or total payment amount) is not collected as a checking result, the service providing device 300 returns to a step (or step S470) of checking the temporary account to check whether all of the actual payment amount (or total payment amount) is collected.

For example, when the actual payment amount of 27000 won is not collected through the first temporary account, the service providing device 300 checks the first temporary account to continuously check whether the actual payment amount of 27000 won is collected.

Further, when all the actual payment amount (or the total payment amount) is not collected within a predetermined time (for example, 10 minutes) after creating the temporary account (or after transmitting information on the allotment for every participant and the temporary account to the plurality of user equipment 100 in the service providing device 300), the service providing device 300 cancels the partial payment and transmits information indicating that the partial payment is cancelled to the plurality of user equipment 100 which participates the partial payment. Further, when the partial payment is cancelled, the service providing device 300 refunds the previously collected allotment to the user equipment 100 which provides the collected allotment.

As another example, when the total payment amount of 50000 won is not collected through the second temporary account within a predetermined time of 10 minutes, the service providing device 300 transmits information indicating that the partial payment is cancelled to the eleventh to fifteenth user equipment 100 and refunds the previously transmitted allotment (for example, 10000 won) to the eleventh to thirteenth user equipment which transmits the allotment (S480).

Further, when all of the actual payment amount (or total payment amount) is collected as a checking result, the service providing device 300 transmits one or more product information to be paid, an expected payment amount (for example, including an actual payment amount and a total payment amount), discount benefit information, and the recommended card list to the previously registered payment representing user equipment 100.

That is, when all the actual payment amount (or the total payment amount) is collected, the service providing device 300 checks one or more benefit information which can be provided to the user equipment 100 in the store equipped with the POS terminal 400, among the plurality of advertisement information and the plurality of benefit information stored in advance, based on the identification information of the previously registered payment representing user equipment 100.

Further, the service providing device 300 creates a recommended card list including one or more recommended cards to which the benefit information may be applied (or reflected) among a plurality of cards issued to the payment representing user equipment 100, based on one or more checked benefit information. Here, the benefit information includes coupon information, membership benefit information, discount benefit information, and accumulation benefit information.

The service providing device 300 transmits one or more benefit information which can be provided to the user equipment 100 which performs the checked partial payment function, a recommended card list including one or more recommended cards, one or more product information to be paid, and an expected payment amount to the user equipment 100 of the representative payer.

For example, when the actual payment amount of 27000 won is collected through the first temporary account, the service providing device 300 checks the first benefit information (for example, 10% discount and 2% additionally accumulated when 30000 won or more is paid by a payment card AA) and the second benefit information (for example, 15% discount when 100000 won or more is paid by a payment card BB) which can be provided to the third user equipment 100 in the store, based on the identification information of the third user equipment 100 which is a representative payer. Further, the service providing device 300 creates a recommended card list including the payment card AA and the payment card BB to which the first benefit information may be applied, among a plurality of cards which is issued to the third user equipment 100. For example, the service providing device 300 transmits the checked first and second benefit information (for example, 10% discount and 2% additionally accumulated when 30000 won or more is paid by a payment card AA and 15% discount when 100000 won or more is paid by a payment card BB), the recommended card list including the payment card AA and the payment card BB, product information on eleventh to thirteenth products, and an expected payment amount (for example, 27000 won when the total payment amount of 30000 won is paid by the payment card AA) to the third user equipment 100 (S490).

The payment representing user equipment 100 displays the received one or more product information to be paid, expected payment amount, one or more benefit information, and recommended card list including one or more recommended cards, transmitted from the service providing device 300.

The payment representing user equipment 100 displays the received one or more product information to be paid, expected payment amount, one or more benefit information, and recommended card list including one or more recommended cards.

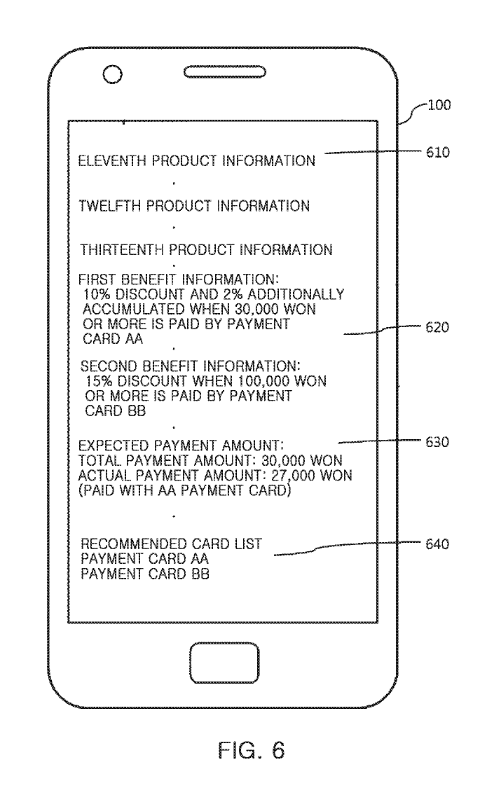

For example, as illustrated in FIG. 6, the third user equipment 100 which is payment representing user equipment displays the product information 610 on eleventh to thirteenth products, the first and second benefit information (for example, 10% discount and 2% additionally accumulated when 30000 won or more is paid by a payment card AA and 15% discount when 100000 won or more is paid by a payment card BB) 620, an expected payment amount (for example, 27000 won when the total payment amount of 30000 won is paid by the payment card AA) 630, and the recommended card list 640 including the payment card AA and the payment card BB, transmitted from the service providing device 300 (S500).

Next, the payment representing user equipment 100 receives a payment card type (or unique identification information of the payment card) in accordance with the user input (or user selection) and a PIN number through a specific app which is installed in advance in the payment representing user equipment 100.

That is, the payment representing user equipment 100 checks the payment card type which is selected in accordance with the user input (or user selection) among a plurality of cards which is registered in advance in the payment representing user equipment 100. In this case, the payment representing user equipment 100 may check a payment card type (or unique identification information of the payment card) of a payment card selected from the recommended card list transmitted from the service providing device 300.

Further, the payment representing user equipment 100 receives a PIN number in accordance with the user input (or user selection) through the specific app which is installed in advance in the payment representing user equipment 100. Here, the PIN number may be a PIN number corresponding to the checked payment card type.

Further, the payment representing user equipment 100 transmits the checked payment card type (or unique identification information of the payment card), the PIN number, and the identification information of the payment representing user equipment 100 to the service providing device 300.

For example, the third user equipment 100 which is payment representing user equipment checks the payment card BB selected from a plurality of payment cards which is registered (or issued) to an electronic wallet app which is installed in advance in the third user equipment 100. Further, the third user equipment 100 receives a first PIN number (for example, 987654) in accordance with user input through the electronic wallet app. Further, the third user equipment 100 transmits the checked payment card BB (or a type of the payment card BB), the received first PIN number, and the identification information of the third user equipment 100 to the service providing device 300.

As another example, the third user equipment 100 which is payment representing user equipment checks the payment card AA selected from the recommended card list displayed on the third user equipment 100. Further, the third user equipment 100 receives a second PIN number (for example, 123456) corresponding to the payment card AA in accordance with user input through the electronic wallet app. Further, the third user equipment 100 transmits the checked payment card AA, the received second PIN number, and the identification information of the third user equipment 100 to the service providing device 300 (S510).

Next, the service providing device 300 receives the payment card type (or unique identification information of the payment card), the PIN number, and identification information of the payment representing user equipment 100 which is transmitted from the payment representing user equipment 100 in response to the one or more benefit information and the recommended card list including one or more recommended cards which are previously transmitted to the payment representing user equipment 100.

Further, the service providing device 300 transmits one or more product information to be paid, an actual payment amount (or the total payment amount), card information corresponding to a PIN number, user information, and benefit information to the payment server 500. Here, the card information includes a card number, expiration date, a card verification code (CVC) number, and a user name. The user information includes a user name, birth date, an address, and an image. Further, the benefit information includes coupon information, membership benefit information, discount benefit information, and accumulation benefit information.

That is, the service providing device 300 receives the payment card type (or unique identification information of the payment card), the PIN number, and identification information of the payment representing user equipment 100 which is transmitted from the payment representing user equipment 100 in response to the one or more benefit information and the recommended card list including one or more recommended cards which are previously transmitted to the payment representing user equipment 100. Further, the service providing device 300 checks card information, user information, and benefit information which are stored in the service providing device 300 in advance, related with the PIN number (or the identification information of the payment representing user equipment 100) and transmits the checked card information, user information, benefit information, one or more product information to be paid, and the actual payment amount (or the total payment amount) to the payment service 500.

For example, the service providing device 300 checks 51st card information, 51st user information, and 51st benefit information corresponding to the identification information of the third user equipment 100 transmitted from the third user equipment 100 and transmits the checked 51st card information, 51st user information, 51st benefit information, product information on eleventh to thirteenth products, and the actual payment amount (for example, 27000 won) to the payment server 500 (S520).

Next, the payment server 500 receives one or more product information to be paid, an actual payment amount (or the total payment amount), card information corresponding to a PIN number, user information, and benefit information transmitted from the service providing device 300.

The payment server 500 performs a payment function on the actual payment amount (or the total payment amount) corresponding to one or more product information to be paid based on the received card information, user information, and benefit information. In this case, the payment server 500 may perform a payment function on the actual payment amount (or the total payment amount) obtained by applying a benefit amount corresponding to the benefit information transmitted from the service providing device 300 (or benefit information which may be applied to the user of the user equipment 100) to price information on one or more products to be paid.

For example, the payment server 500 receives the 51st card information, 51st user information, 51st benefit information, product information on eleventh to thirteenth products, and the actual payment amount (for example, 27000 won) transmitted from the service providing device 300 and performs the payment function on an actual payment amount (for example, 27000 won) obtained by applying a benefit amount (for example, the first benefit information of 10% discount and 2% additionally accumulated when 30000 won or more is paid by a payment card AA) corresponding to the 51st benefit information to the eleventh to thirteenth products to be paid. Further, the payment server 500 generates accumulated points (for example, 540 won) according to the 51st benefit information (for example, the first benefit information of 10% discount and 2% additionally accumulated when 30000 won or more is paid by the payment card AA) (S530).

Next, the payment server 500 transmits the payment function performed result (or payment information) to the POS terminal 400 and the service providing device 300. Here, the payment function performed result (or the payment information) includes a product name (or a service name), a unique product code (a unique service code), a unit price, an amount, a discounted price, whether to apply a coupon, a price, an actual payment amount (a total payment price), payment date and time information, and a payment card type.

In this case, when an accumulated point which is accumulated in accordance with the performing of the payment function is generated, the payment server 500 may transmit the payment function performed result and accumulated point information in accordance with the performing of the payment function to the POS terminal 400 and the service providing device 300.

For example, the payment server transmits the payment function result performed result on the eleventh to thirteenth products to the POS terminal 400 and the service providing device 300.

As another example, the payment server 500 transmits a payment function performed result on the eleventh to thirteenth products and accumulated point information (for example, including the accumulated points of 540 won corresponding to 2% accumulation of the actual payment amount/total payment amount) to the POS terminal 400 and the service providing device 300 (S540).

Next, the service providing device 300 receives the payment function performed result (or payment information) and accumulated point information in accordance with the performing of the payment function transmitted from the payment server 500 in response to the previously transmitted card information.

Further, the service providing device 300 transmits the payment function performed result (or the payment information) to the plurality of user equipment 100 which participates the partial payment.

The plurality of user equipment 100 receives the payment function performed result transmitted from the service providing device 300 and displays the received payment function performed result.

For example, the service providing device 300 receives the payment function performed result on the eleventh to thirteenth products and the accumulated point information (for example, including the accumulated points of 540 won corresponding to 2% accumulation of the actual payment amount/total payment amount) transmitted from the payment server 500 and transmits the received payment function performed result on the eleventh to thirteenth products to the first to fourth user equipment 100 which participates the partial payment (S550).

Next, the service providing device 300 provides (or transmits) the previously collected actual payment amount (or the total payment amount) to the payment representing user equipment 100 (or a predetermined account of the payment representing user equipment 100).

Further, the payment representing user equipment 100 receives (or checks) the actual payment amount (or the total payment amount) provided from the service providing device 300.

For example, the service providing device 300 provides the previously collected actual payment amount (for example, 27000 won) to an account which is registered in advance by the third user equipment 100 which is payment representing user equipment. Further, the third user equipment 100 checks deposit of the actual payment amount provided from the service providing device 300 (S560).

Further, when there are accumulated points in accordance with the performing of the payment function (or partial payment) (or points in accordance with the payment are generated after performing the payment function), the service providing device 300 distributes the accumulated points in accordance with the allotment for every participant.

Further, the plurality of user equipment 100 displays (or checks) information on the accumulated points which are distributed by the service providing device 300.

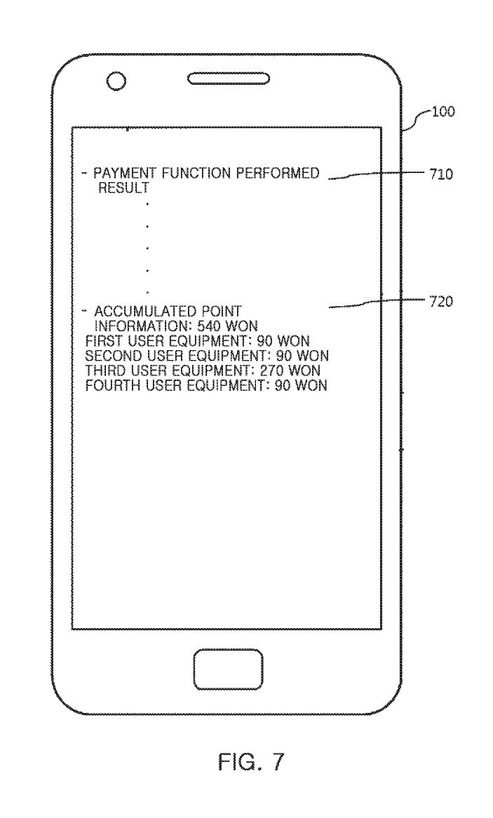

For example, when accumulated point information in accordance with the performing of the payment function (for example, including the accumulated points of 540 won corresponding to 2% accumulation of the actual payment amount/total payment amount) is received, the service providing device 300 distributes the accumulated points (540 won) to 90 won for the first user equipment, 90 won for the second user equipment, 270 won for the third user equipment, and 90 won for the fourth user equipment in accordance with the allotments of participants (for example, 4500 won for the first user equipment, 4500 won for the second user equipment, 13500 won for the third user equipment, and 4500 won for the fourth user equipment) and provides the distributed accumulated points to the first to fourth user equipment 100. Further, as illustrated in FIG. 7, the third user equipment 100 displays the received payment function performed result 710 and the information on the accumulated points 720 transmitted from the service providing device 300 (S570).

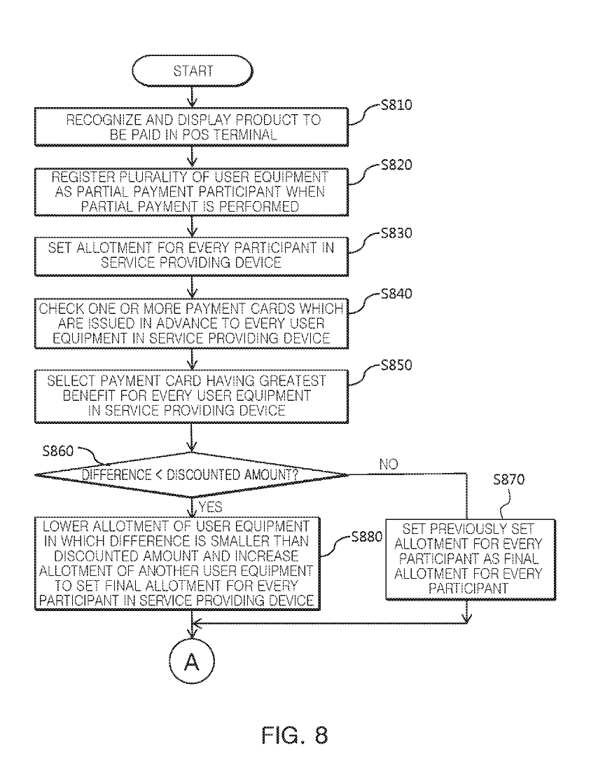

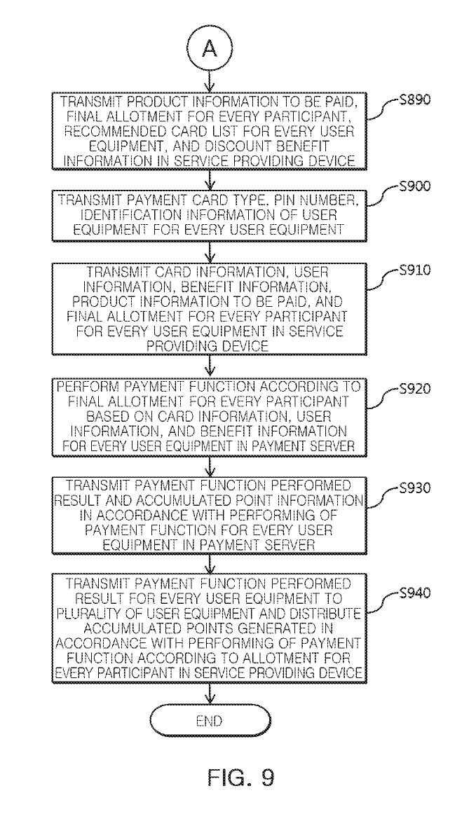

FIGS. 8 and 9 are flow charts illustrating a control method of a payment system according to a second exemplary embodiment of the present invention.

First, the POS terminal 400 scans (or recognizes a barcode attached on a product to be paid) one or more products (or payment products) to be paid which are selected by the users of the plurality of user equipment 100.

The POS terminal 400 displays product information on one or more scanned (or recognized) products to be paid. Here, the product information includes a product name, a unique product code, a unit price, an amount, a price, a total price, and the like.

Further, the POS terminal 400 checks service information for a service to be paid, which is selected (or used) by the users of the plurality of user equipment 100, and displays the checked service information. Here, the service information includes a service name, a unique service code, a unit price, an amount, a price, a total price, and the like.

For example, the POS terminal 400 recognizes barcodes attached on eleventh to thirteenth products which are selected by users of the plurality of user equipment 100 and displays product information on the recognized eleventh to thirteenth products.

As another example, the POS terminal 400 displays service information on eleventh to fourteenth services which are used by users of the plurality of another user equipment 100 (S810).

Thereafter, when the users of the plurality of user equipment 100 want to perform the partial payment function on the selected product or service (or used/to be purchased), the service providing device 300 communicates with the plurality of user equipment 100.

That is, when the users of the plurality of user equipment 100 which wants to perform the partial payment on one or more products or services in the store equipped with the POS terminal 400 or an online shopping mall expresses an intention of partial payment in the store or online shopping mall, the POS terminal (or an online shopping mall server (not illustrated) communicates with the service providing device 300 and transmits information indicating the partial payment and identification information of the POS terminal 400 to the service providing device 300. Thereafter, the service providing device 300 creates a partial payment registration room (for example, store A—partial payment registration #123) for partial payment based on the information indicating the partial payment and identification information of the POS terminal 400 transmitted from the POS terminal 400. Next, the plurality of user equipment 100 which accesses the service providing device 300 accesses the created partial payment registration room to register as partial payment participants for the partial payment in the partial payment registration room.

For example, when the partial payment function on eleventh to thirteenth products selected by users of first to third user equipment 100 is performed, the first to third user equipment accesses the service providing device 300 to register as partial payment participants for the partial payment.

As another example, when the partial payment function on eleventh to fourteenth services selected by users of eleventh to fifteenth user equipment 100 is performed, the eleventh to fifteenth user equipment 100 accesses the service providing device 300 to register as partial payment participants for the partial payment (S820).

Next, the service providing device 300 checks a total payment amount for the products or services selected by the users of the plurality of user equipment 100 and one or more product information to be paid by interlocking with the POS terminal 400.

Further, the service providing device 300 sets an allotment for every participant based on a total payment amount and the number of the plurality of user equipment 100 which participates the partial payment. In this case, an allotment setting method may include a method of setting by 1/n (or equal split) based on the number of the plurality of user equipment 100, a method of setting an amount allotted to each user of an actual payment amount (or a total payment amount) for every user equipment in advance at the time of previously registering as the partial payment participants, and a method of transmitting an actual payment amount (or a total payment amount) to the plurality of user equipment 100 after checking the actual payment amount (or the total payment amount) in the service providing device 300 and receiving an allotted amount for every user equipment which is transmitted to each user equipment as a response thereof. Here, the actual payment amount is an amount obtained by applying benefit information to the payment amount. When the benefit information is not applied, the actual payment amount may be equal to the total payment amount.

For example, the service providing device 300 receives a total payment amount (for example, 350,000 won) on the eleventh to thirteenth products and product information on the eleventh to thirteenth products transmitted from the POS terminal 400. Further, the service providing device 300 sets an allotment of 95,000 won to the first user equipment, an allotment of 130,000 won to the second user equipment, and an allotment of 125,000 won to the third user equipment, in accordance with an allotted amount for every user equipment which is set in advance to the first to third user equipment which participates the partial payment for the total payment amount (for example, 350,000 won) on the eleventh to thirteenth products.

As another example, the service providing device 300 receives a total payment amount (for example, 500,000 won) on the eleventh to fourteenth services and service information on the eleventh to fourteenth services transmitted from the POS terminal 400. Further, the service providing device 300 sets an allotment of 100,000 won for every participant which is the same amount for every user equipment according to a predetermined equal split based on the total amount (for example, 500,000 won) for the eleventh to fourteenth services and the number of eleventh to fifteenth user equipment which participates the partial payment (S830).

Next, the service providing device 300 checks one or more payment card information (or a payment card) for every user equipment which is issued (or registered) in advance for every user equipment to the plurality of user equipment 100.

In this case, the service providing device 300 may collect one or more payment card information which is issued in advance to each of the plurality of user equipment 100.

For example, the service providing device 300 checks a payment card AA, a payment card BB, and a payment card CC which are issued to the first user equipment which participates the partial payment, the payment card AA, the payment card CC, and a payment card DD which are issued to the second user equipment, and the payment card BB and the payment card DD which are issued to the third user equipment (S840).

Next, the service providing device 300 selects one (or plural) payment card (or payment card for every user equipment) having the greatest discount benefit for every user equipment when the payment is performed.

For example, the service providing device 300 selects the payment card AA having the greatest discount benefit (for example, 10% discount when 100,000 won or more is paid) among the plurality of payment cards (the payment card AA, the payment card BB, and the payment card CC) issued to the first user equipment, selects the payment card AA having the greatest discount benefit (for example, 10% discount when 100,000 won or more is paid) among the plurality of payment cards (the payment card AA, the payment card CC, and the payment card DD) issued to the second user equipment, and selects the payment card BB having the greatest discount benefit (for example, 10% discount and 4% additional accumulated when 110,000 won or more is paid) among the plurality of payment cards (the payment card BB and the payment card DD) issued to the third user equipment (S850).

Next, the service providing device 300 calculates a difference between a reference amount of a payment card corresponding to the user equipment to get the discount benefit of the selected payment card for every user equipment and an allotment corresponding to the corresponding user equipment among the allotments for participants.

When the calculated difference is larger than zero (the reference amount of the payment card to get the discount benefit is larger to the allotment corresponding to the user equipment), the service providing device 300 checks (or determines/compares) whether the calculated difference is smaller than the discount amount (or a compensation amount) to which a discount benefit of the payment card is applied to the allotment corresponding to the user equipment.

For example, the service providing device 300 checks whether a first difference (for example, 100,000 won −95,000 won=5000 won) between a first reference amount (for example, 100,000 won) to get the discount benefit of the payment card AA selected for the first user equipment and a first allotment (for example, 95,000 won) set for the first user equipment is smaller than a first discount amount (for example, 95,000 won×10%=9,500 won) to which the discount benefit (10% discount when 100,000 won or more is paid) of the payment card AA is applied to the first allotment (for example, 95,000 won) set for the first user equipment.

Further, the service providing device 300 calculates a second difference (for example, 100,000 won−130,000 won=−30,000 won) between a second reference amount (for example, 100,000 won) to get the discount benefit of the payment card AA selected for the second user equipment and a second allotment (for example, 130,000 won) set for the second user equipment.

Further, the service providing device 300 calculates a third difference (for example, 120,000 won−125,000 won=−5,000 won) between a third reference amount (for example, 120,000 won) to get the discount benefit of the payment card BB selected for the third user equipment and a third allotment (for example, 125,000 won) set for the third user equipment (S860).

When the difference between the reference amount of the payment amount to apply the discount benefit of the payment card for every user equipment and the allotment corresponding to the user equipment among the allotments of the participants is equal to or larger than the discounted amount (or a compensation amount) obtained by applying the discount benefit of the payment card to the allotment corresponding to the user equipment as a checking result (or determination/comparison result) (or when the reference amount of the payment card corresponding to the user equipment to apply the discount benefit of the payment card for every user equipment is equal to or smaller than the allotment corresponding to the user equipment or the difference is negative), the service providing device 300 sets the previously set allotment for every participant as a final allotment for every participant.

For example, when the first reference amount for the first user equipment which participates the partial payment is equal to or smaller than the first allotment, the second reference amount for the second user equipment is equal to or smaller than the second allotment, and the third reference amount for the third user equipment is equal to or smaller than the third allotment (or the differences for all user equipment which participates the partial payment is negative), the service providing device 300 sets 95,000 won which is the previously set allotment for every participant for the first user equipment, 130,000 won for the second user equipment, and 125,000 won for third user equipment as final allotments for every participant (S870).

When the difference between the reference amount of the payment card to apply the discount benefit of the selected payment card for every user equipment and the allotment corresponding to the user equipment among the allotments of the participants is smaller than the discounted amount (or a compensation amount) obtained by applying the discount benefit of the payment card to the allotment corresponding to the user equipment as a checking result (or determination/comparison result) (or when the reference amount of the payment card corresponding to the user equipment which participates the partial payment is larger than the allotment and/or the difference is smaller than the discounted amount), the service providing device 300 raises the allotment of specific user equipment to the reference amount of the payment card related with the specific user equipment to receive the discount benefit so that at least one user equipment in which the difference is smaller than the discounted amount receives the discount benefit and lowers the allotment of one or more user equipment among the remaining user equipment excluding the specific user equipment to adjust the previously set allotment for every participant and then sets the adjusted allotment for every participant as a final allotment for every participant.

For example, when the second difference (for example, −30,000 won) for the second user equipment which participates the partial payment is negative, the third difference (for example, −5,000 won) for the third user equipment is negative, and the first difference (for example, 5,000 won) for the first user equipment is smaller than the first discounted amount (for example, 9,500 won) (or at the time of comparing the difference for every user equipment which participates the partial payment and the discounted amount, when the reference amount of the payment card corresponding to the user equipment is larger than the allotment and the difference is smaller than the discounted amount), the service providing device 300 adjusts (or changes/modifies/resets) the allotment for the first user equipment from the former allotment (or the first allotment, for example, 95,000 won) to a first reference amount (for example, 100,000 won) to receive the benefit of the payment card AA selected for the first user equipment) so as to be provided with the discount benefit for the payment card AA in the first user equipment, lowers the former allotment (or the second allotment, for example, 130,000 won) for the second user equipment by an allotment difference (for example, 100,000 won−95,000 won=5,000 won) adjusted in the first user equipment to adjust the allotment (or adjusted second allotment, for example, 130,000 won−5,000 won=125,000 won), and maintains the former allotment (or the third allotment, for example, 125,000 won) for the third user equipment to set final allotments for the participants (for example, an adjusted allotment of 100,000 won for the first user equipment, an adjusted allotment of 125,000 won for the second user equipment, and an adjusted allotment of 125,000 for the third user equipment) (S880).

Next, the service providing device 300 transmits the set final allotment for every participant, a recommended card list for every user equipment, discount benefit information corresponding to the recommended card (or a recommended payment card) and one or more product information to be paid to the plurality of user equipment 100. In this case, the service providing device 300 may transmit the allotment (or an allotment corresponding to the corresponding user equipment among the final allotments for every participant), the recommended card list (or a recommended card list corresponding to the user equipment among recommended card lists for every participant), discount benefit information corresponding to the recommended card, and one or more product information to be paid for every user equipment.

For example, when the allotment is adjusted (when the reference amount of the payment card corresponding to the user equipment which participates the partial payment is larger than the allotment and/or the difference is smaller than the discounted amount), the service providing device 300 transmits product information on the eleventh to thirteenth products, the final allotment for every participant (for example, including 100,000 for the first user equipment, 125,000 for the second user equipment, and 125,000 for the third user equipment), the recommended card list for every user equipment (for example, including the payment card AA for the first user equipment, the payment card BB for the second user equipment, and the payment card BB for the third user equipment), discount benefit information corresponding to the recommended card (for example, 10% discount when the payment is made by the payment card AA and 10% discount and 4% additional accumulation when the payment is made by the payment card BB) to the first to third user equipment.

As another example, when the allotment is not adjusted (when the differences for all user equipment which participates the partial payment is negative, as the previous checking result), the service providing device 300 transmits product information on the eleventh to thirteenth products, the final allotment for every participant (for example, including 95,000 for the first user equipment, 125,000 for the second user equipment, and 125,000 for the third user equipment), the recommended card list for every user equipment (for example, including the payment card AA for the first user equipment, the payment card BB for the second user equipment, and the payment card BB for the third user equipment), discount benefit information corresponding to the recommended card (for example, 10% discount when the payment is made by the payment card AA and 10% discount and 4% additional accumulation when the payment is made by the payment card BB) to the first to third user equipment (S890).

Next, each of the plurality of user equipment 100 receives one or more product information to be paid, a final allotment for every participant, a recommended card list for every user equipment, discount benefit information corresponding to a recommended card, and one or more product information to be paid, transmitted from the service providing device 300.

Further, each of the plurality of user equipment 100 displays the received one or more product information to be paid, a final allotment for every participant, recommended card list for every user equipment, discount benefit information corresponding to a recommended card, and one or more product information to be paid.

Further, the plurality of user equipment 100 receives a payment card type (or unique identification information of the payment card) in accordance with the user input (or user selection) and a PIN number through a specific app which is installed in advance in the user equipment 100.

That is, the plurality of user equipment 100 checks the payment card type which is selected in accordance with the user input (or user selection) among a plurality of cards which is registered in advance in the user equipment 100. In this case, the plurality of user equipment 100 may check a payment card type (or unique identification information of the payment card) of a payment card selected from the recommended card list transmitted from the service providing device 300.

Further, the plurality of user equipment 100 receives a PIN number in accordance with the user input (or user selection) through the specific app which is installed in advance in the user equipment 100. Here, the PIN number may be a PIN number corresponding to the checked payment card type.

Further, each of the plurality of user equipment 100 transmits the checked payment card type (or unique identification information of the payment card), the PIN number, and the identification information of the user equipment 100 to the service providing device 300.

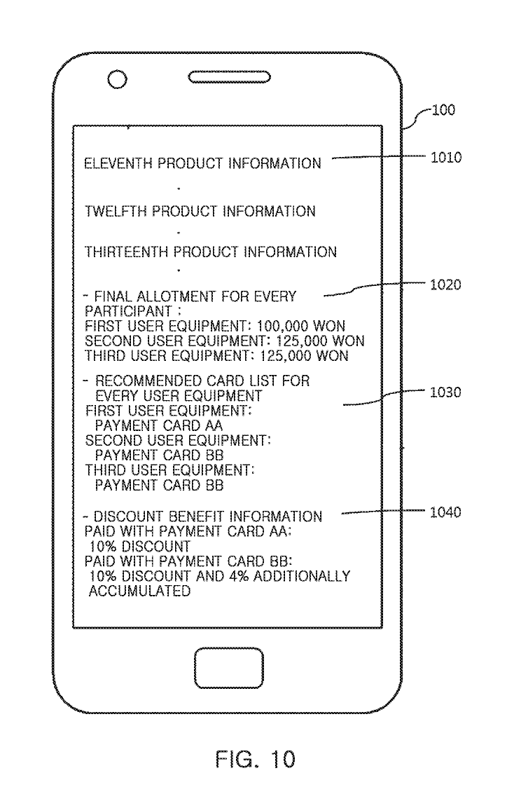

For example, as illustrated in FIG. 10, the first user equipment 100 displays product information 1010 on the eleventh to thirteenth products, the final allotment for every participant (for example, including 100,000 for the first user equipment, 125,000 for the second user equipment, and 125,000 for the third user equipment) 1020, the recommended card list for every user equipment (for example, including the payment card AA for the first user equipment, the payment card BB for the second user equipment, and the payment card BB for the third user equipment) 1030, discount benefit information corresponding to the recommended card (for example, 10% discount when the payment is made by the payment card AA and 10% discount and 4% additional accumulation when the payment is made by the payment card BB) 1040.

Further, the first user equipment checks the payment card AA selected from the plurality of payment cards (or the recommended card list provided from the service providing device 300) which is registered (or issued) in an electronic wallet app which is installed in advance in the first user equipment. Further, the first user equipment receives a first PIN number (for example, 123456) in accordance with user input through the electronic wallet app. Further, the first user equipment 100 transmits the checked payment card AA (or a type of the payment card AA), the received first PIN number, and the identification information of the first user equipment 100 to the service providing device 300.

Further, the second user equipment checks the payment card AA selected from the plurality of payment cards (or the recommended card list provided from the service providing device 300) which is registered (or issued) in an electronic wallet app which is installed in advance in the second user equipment. Further, the second user equipment receives a second PIN number (for example, 456789) in accordance with user input through the electronic wallet app. Further, the second user equipment 100 transmits the checked payment card AA (or a type of the payment card AA), the received second PIN number, and the identification information of the second user equipment 100 to the service providing device 300.

Further, the third user equipment checks the payment card BB selected from the plurality of payment cards (or the recommended card list provided from the service providing device 300) which is registered (or issued) in an electronic wallet app which is installed in advance in the third user equipment. Further, the third user equipment receives a third PIN number (for example, 789123) in accordance with user input through the electronic wallet app. Further, the third user equipment 100 transmits the checked payment card BB (or a type of the payment card BB), the received third PIN number, and the identification information of the third user equipment 100 to the service providing device 300 (S900).

Next, the service providing device 300 receives the payment card type, the PIN number, and the identification information of the user equipment 100 which are transmitted for every user equipment, in response to the previously transmitted final allotment for every participant and the recommended card list for every user equipment.

Further, when the service providing device 300 receives all the payment card type, the PIN number, and the identification information of the user equipment 100 from the plurality of user equipment 100 which participates the partial payment, the service providing device 300 transmits one or more product information to be paid, the payment card type, the PIN number, and the identification information of the user equipment 100, the final allotment for every participant, card information corresponding to the PIN number for every user equipment, the user information, and the benefit information to the payment server 500. Here, the card information includes a card number, expiration date, a card verification code (CVC) number, and a user name. The user information includes a user name, birth date, an address, and an image. Further, the benefit information includes coupon information, membership benefit information, discount benefit information, and accumulation benefit information.

That is, the service providing device 300 receives the payment card type, the PIN number, and the identification information of the user equipment 100 which are transmitted for every user equipment, in response to the previously transmitted final allotment for every participant and the recommended card list for every user equipment. Further, the service providing device 300 checks the card information for every user equipment, the user information for every user equipment, and the benefit information for every user equipment which are stored in advance in the service providing device 300, in regard to the PIN number for every user equipment (or identification information for every user equipment) and transmits the checked card information for every user equipment, user information for every user equipment, benefit information for every user equipment, one or more product information to be paid, and final allotment for every participant to the payment server 500.

For example, the service providing device 1 checks eleventh card information, eleventh user information, and eleventh benefit information corresponding to the first PIN number (for example, 123456) transmitted from the first user equipment, twelfth card information, twelfth user information, and twelfth benefit information corresponding to the second PIN number (for example, 456789) transmitted from the second user equipment, and thirteenth card information, thirteenth user information, and thirteenth benefit information corresponding to the third PIN number (for example, 789123) transmitted from the third user equipment.

Further, the service providing device 300 transmits the checked eleventh card information, eleventh user information, and eleventh benefit information corresponding to the first PIN number of the first user equipment, twelfth card information, twelfth user information, and twelfth benefit information corresponding to the second PIN number of the second user equipment, and thirteenth card information, thirteenth user information, and thirteenth benefit information corresponding to the third PIN number of the third user equipment, product information on the eleventh to thirteenth products, and the final allotments for every participant (for example, 100,000 won for the first user equipment, 125,000 won for the second user equipment, and 125,000 for the third user equipment) to the payment server 500.

Further, when all the payment card type, the PIN number, and the identification information of the user equipment 100 are not received from the plurality of user equipment 100 within a predetermined time (for example, 10 minutes) after transmitting the information on the final allotment for every participant from the service providing device 300 to the plurality of user equipment 100, the service providing device 300 cancels the partial payment and transmits information indicating that the partial payment is cancelled to the plurality of user equipment 100 which participates the partial payment.

As another example, when only the first user equipment and the third user equipment among the first to third user equipment transmit the payment card type AA, the first PIN number, the identification information of the first user equipment, the payment card type BB, the third PIN number, and the identification information of the third user equipment within a predetermined time (for example, 10 minutes) to the service providing device 300, but the second user equipment does not transmit the payment card type, the second PIN number, the identification information of the second user equipment, the service providing device 300 transmits the information indicating that the partial payment is cancelled to the first to third user equipment (S910).

Next, the payment server 500 receives on one or more product information to be paid, an allotment for every participant, card information corresponding to a PIN number for every user equipment, user information, and benefit information, transmitted from the service providing device 300.

Further, the payment server 500 performs a partial payment function for an allotment for every participant for every user equipment, based on the card information, the user information, and the benefit information corresponding to the received allotment for every participant and the PIN number for every user equipment. In this case, the payment server 500 may perform the payment function on a payment amount (or an actual payment amount) obtained by applying a benefit amount corresponding to the benefit information transmitted from the service providing device 300 (or benefit information which may be applied to the user of the user equipment 100) to the final allotment for every participant.

For example, the payment server 500 receives the eleventh card information, the eleventh user information, and the eleventh benefit information related with the first user equipment, the twelfth card information, the twelfth user information, and the twelfth benefit information related with the second user equipment, and the thirteenth card information, the thirteenth user information, and the thirteenth benefit information related with the third user equipment, product information on the eleventh to thirteenth products, and the final allotments for every participant (for example, 100,000 won for the first user equipment, 125,000 won for the second user equipment, and 125,000 for the third user equipment), transmitted from the service providing device 300.

For example, the payment server 500 performs the payment function on a first actual payment amount (for example, 90,000 won) obtained by applying a first benefit amount (for example, 10% discount when 100,000 won or more is paid by the payment card AA) corresponding to the eleventh benefit information to the final participant allotment (for example, 100,000 won) for the first user equipment, performs the payment function on a second actual payment amount (for example, 112,500 won) obtained by applying a second benefit amount (for example, 10% discount when 100,000 won or more is paid by the payment card AA) corresponding to the twelfth benefit information to the final participant allotment (for example, 125,000 won) for the second user equipment, and performs the payment function on a third actual payment amount (for example, 112,500 won) obtained by applying a third benefit amount (for example, 10% discount and 4% additional accumulation when 120,000 won or more is paid by the payment card BB) corresponding to the thirteenth benefit information to the final participant allotment (for example, 125,000 won) for the third user equipment. Further, the payment server 500 accumulates (or provides) the third accumulated points (for example, 4,500 won) according to the thirteenth benefit information (for example, 10% discount and 4% additional accumulation when 120,000 won or more is paid by the payment card BB) to the third user equipment (S920).

Next, the payment server 500 transmits the payment function performed result (or payment information for every user equipment) for every user equipment to the POS terminal 400 and the service providing device 300. Here, the payment function performed result (or the payment information for every user equipment) for every user equipment includes a product name (or a service name), a unique product code (a unique service code), a unit price, an amount, a discounted price, whether to apply a coupon, a price, an actual payment amount (a total payment price), payment date and time information, and a payment card type.

In this case, when an accumulated point which is accumulated in accordance with the performing of the payment function is generated, the payment server 500 may transmit the payment function performed result for every user equipment and accumulated point information for every user equipment in accordance with the performing of the payment function for every user equipment to the POS terminal 400 and the service providing device 300.

For example, the payment server 500 transmits a first payment function performed result related to the first user equipment, a second payment function performed result related to the second user equipment, a third payment function performed result related to the third user equipment and third accumulated point information (for example, including accumulated points of 4,500 corresponding to 4% accumulation of the actual payment amount/total payment amount) related with the third user equipment to the POS terminal 400 and the service providing device 300 (S930).

Next, after normally performing the payment function on the plurality of user equipment 100, the service providing device 300 receives a payment function performed result (or payment information for every user equipment) for every user equipment and accumulated point information in accordance with the performing of payment function for every user equipment, transmitted from the payment server 500.

Further, the service providing device 300 transmits the payment function performed result and the accumulated point information in accordance with the performing of payment function to the plurality of user equipment 100 which participates the partial payment.

Each of the plurality of user equipment 100 receives the payment function performed result and the accumulated point information in accordance with the performing of payment function transmitted from the service providing device 300 and displays the received payment function performed result and accumulated point information in accordance with the performing of payment function.

For example, the service providing device 300 receives the first payment function performed result related to the first user equipment, the second payment function performed result related to the second user equipment, the third payment function performed result related to the third user equipment and the third accumulated point information (for example, including accumulated points of 4,500 corresponding to 4% accumulation of the actual payment amount/total payment amount) related with the third user equipment which are transmitted from payment server 500 and are partial payment performed results on the eleventh to thirteenth products. Further, the service providing device 300 transmits the first payment function performed result to the first user equipment, transmits the second payment function performed result to the second user equipment, and transmits the third payment function performed result and the third accumulated point information to the third user equipment (S940).

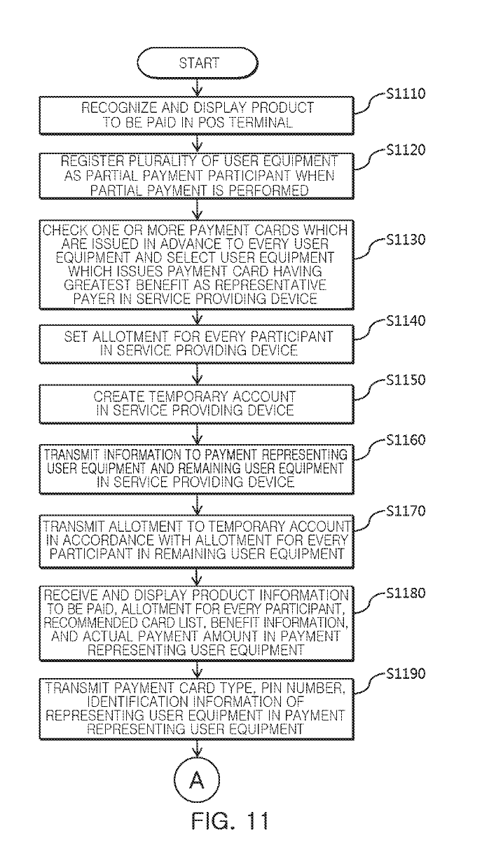

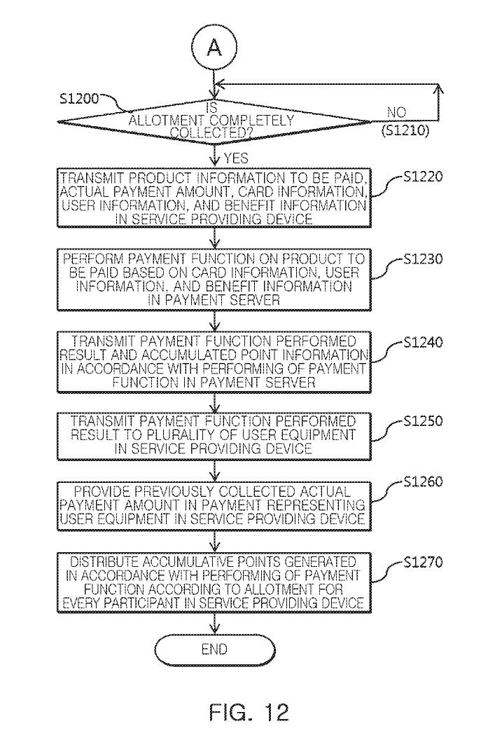

FIGS. 11 and 12 are flow charts illustrating a control method of a payment system according to a third exemplary embodiment of the present invention.

First, the POS terminal 400 scans (or recognizes a barcode attached on a product to be paid) one or more products (or payment products) to be paid which are selected by the users of the plurality of user equipment 100.

The POS terminal 400 displays product information on one or more scanned (or recognized) products to be paid. Here, the product information includes a product name, a unique product code, a unit price, an amount, a price, a total price, and the like.

Further, the POS terminal 400 checks service information for a service to be paid, which is selected (or used) by the users of the plurality of user equipment 100, and displays the checked service information. Here, the service information includes a service name, a unique service code, a unit price, an amount, a price, a total price, and the like.

For example, the POS terminal 400 recognizes barcodes attached on 21st to 24th products which are selected by users of the plurality of user equipment 100 and displays product information on the recognized 21st to 24th products.

As another example, the POS terminal 400 displays service information on 21st to 23rd services which are used by users of the plurality of another user equipment 100 (S1110).

Thereafter, when the users of the plurality of user equipment 100 want to perform the partial payment function on the selected product or service (or used/to be purchased), the service providing device 300 communicates with the plurality of user equipment 100.

That is, when the users of the plurality of user equipment 100 which wants to perform the partial payment on one or more products or services in the store equipped with the POS terminal 400 or an online shopping mall expresses an intention of partial payment in the store or online shopping mall, the POS terminal (or an online shopping mall server (not illustrated) communicates with the service providing device 300 and transmits information indicating the partial payment and identification information of the POS terminal 400 to the service providing device 300. Thereafter, the service providing device 300 creates a partial payment registration room (for example, store A—partial payment registration #123) for partial payment based on the information indicating the partial payment and identification information of the POS terminal 400 transmitted from the POS terminal 400. Next, the plurality of user equipment 100 which accesses the service providing device 300 accesses the created partial payment registration room to register as partial payment participants for the partial payment in the partial payment registration room.

For example, when the partial payment function on 21st to 24th products selected by users of 21st to 23rd user equipment 100 is performed, the 21st to 23rd user equipment accesses the service providing device 300 to register as partial payment participants for the partial payment.

For example, when the partial payment function on 21st to 23rd services selected by users of 31st to 35th user equipment 100 is performed, the 31st to 35th user equipment accesses the service providing device 300 to register as partial payment participants for the partial payment (S1120).

Next, the service providing device 300 checks a total payment amount for the products or services selected by the users of the plurality of user equipment 100 and one or more product information to be paid by interlocking with the POS terminal 400.

Further, the service providing device 300 checks one (or plural) payment card having the greatest benefit (for example, including a discount benefit and an accumulation benefit) among a plurality (all) of payment cards which is issued to the plurality of user equipment 100 which participates the partial payment.

In this case, the service providing device 300 collects information on a plurality of payment cares which is issued in advance to the plurality of user equipment 100 and checks one (or plural) payment card having the greatest benefit among the plurality of collected payment cards.

Further, the service providing device 300 selects one (or plural) user equipment 100 to which the payment card having the greatest benefit is issued, among the plurality of user equipment 100 which participates the partial payment, as a represent payer (or a payment representing user equipment) who performs an actual payment function.

For example, the service providing device 300 receives a total payment amount (for example, 150,000 won) on the 21st to 24th products and products information on the 21st to 24th products transmitted from the POS terminal 400. Further, the service providing device 300 checks a payment card AA, a payment card BB, a payment card CC, a payment card DD, and a payment card EE which are issued to the 21st to 23rd user equipment which participates the partial payment. Further, the service providing device checks the payment card CC having the greatest benefit in the store equipped with the POS terminal, among the checked payment card AA, payment card BB, payment card CC, payment card DD, and payment card EE. Further, the service providing device 300 selects the 22nd user equipment which issues the payment card CC having the greatest benefit (for example, 20% discount and 2% accumulation when 100,000 won or more is paid by the payment card CC) as payment representing user equipment (31130).

Next, the service providing device 300 sets an allotment for every participant based on a total payment amount and the number of the plurality of user equipment 100 which participates the partial payment, with respect to an actual payment amount obtained by applying the benefit to the checked total payment amount. In this case, an allotment setting method may include a method of setting by 1/n (or equal split) based on the number of the plurality of user equipment 100, a method of setting an amount allotted to each user of an actual payment amount (or a total payment amount) for every user equipment in advance at the time of previously registering as the partial payment participants, and a method of transmitting an actual payment amount (or a total payment amount) to the plurality of user equipment 100 after checking the actual payment amount (or the total payment amount) in the service providing device 300 and receiving an allotted amount for every user equipment which is transmitted to each user equipment as a response thereof. Further, the payment representing user equipment 100 may be one of the plurality of user equipment 100 which participates the partial payment. Here, the actual payment amount is an amount obtained by applying benefit information to the payment amount. When the benefit information is not applied, the actual payment amount may be equal to the total payment amount.

For example, the service providing device 300 sets the same allotment for every participant of 40,000 by equally splitting an actual amount (for example, 150,000 won−30,000 won=120,000 won) obtained by applying 20% discount benefit (for example, 150,000 won×20%=30,000 won) when the payment card CC issued to the 22nd user equipment among the plurality of user equipment which participates the partial payment is used to make a payment to the total payment amount (for example, 150,000 won) for the 21st to 24th products, based on the number of 21st to 23rd user equipment which participates the partial payment (S1140).

Next, the service providing device 300 creates a temporary account for partial payment. In this case, the temporary account may be an account through which predetermined points commonly used in a plurality of predetermined sites are received, an account through which cash is transferred, and an account through which points and/or cash are received.

For example, the service providing device 300 creates a first temporary account (for example, 123-456-789) for receiving the points that can be generally used in a plurality of predetermined sites for a partial payment (S1150).

Further, the service providing device 300 transmits the received one or more product information to be paid, allotment for every participant, recommended card list including a recommended card having the greatest benefit, benefit information, and actual payment amount to which the benefit information is applied, to the user equipment (or the payment representing user equipment) 100 of the representative payer.

Further, the service providing device 300 transmits the allotment for every participant, information on the temporary account, one or more product information to be paid, and representative payer information to the remaining user equipment 100 excluding the payment representing user equipment 100 from the plurality of user equipment 100.

For example, the service providing device 300 transmits product information on the 21st to 24th products, an allotment for every participant (for example, including an allotment for the 21st user equipment of 40,000 won, an allotment for the 22nd user equipment of 40,000 won, and an allotment for the 23rd user equipment of 40,000 won which are set by equally splitting the actual amount obtained by applying the discount benefit to the total payment amount), a recommended card list including a payment card CC having the greatest benefit, benefit information, benefit information (for example, 20% discount and 2% accumulation when 100,000 won or more is paid by the payment card CC), and actual payment amount (for example, 120,000 won) to which the benefit information is applied, to the 22nd user equipment which is the representative payer.

Further, the service providing device 300 transmits an allotment for every participant (for example, including an allotment for the 21st user equipment of 40,000 won, an allotment for the 22nd user equipment of 40,000 won, and an allotment for the 23rd user equipment of 40,000 won which are set by equally splitting the actual amount obtained by applying the discount benefit to the total payment amount), first information including the first temporary account (for example, 123-456-789), product information on the 21st to 24th products, and representative payer information (for example, the 22nd user equipment) to the 21st and 23rd user equipment excluding the 22nd user equipment which is the representative payer from the 21st to 23rd user equipment which participates the partial payment (S1160).

Further, the remaining user equipment 100 excluding the payment representing user equipment among the plurality of user equipment which participates the partial payment receives the allotment for every participant, information on the temporary account, one or more product information to be paid, and representative payer information transmitted from the service providing device 300.

Further, the remaining user equipment 100 displays the received allotment for every participant, information on a temporary account, one or more product information to be paid, and representative payer information.

In this case, the remaining user equipment 100 may display the previously received allotment for every participant, information on a temporary account, one or more product information to be paid, and representative payer information through an app which is installed in advance in the user equipment 100.

Further, the remaining user equipment transmits (or transfers) an allotment corresponding to the user equipment among allotments for every participant to the temporary account in accordance with the selection (or input/control) of the user of the user equipment 100. In this case, the allotment includes cyber money (for example, including points or accumulated money available in a specific site) and cash.

For example, the 21st and 23rd user equipment excluding the 22nd user equipment which is the representative payer from the 21st to 23rd user equipment which participates the partial payment receives an allotment for every participant (for example, including an allotment for the 21st user equipment of 40,000 won, an allotment for the 22nd user equipment of 40,000 won, and an allotment for the 23rd user equipment of 40,000 won which are set by equally splitting the actual amount obtained by applying the discount benefit to the total payment amount), first information including the first temporary account (for example, 123-456-789), product information on the 21st to 24th products, and representative payer information (for example, the 22nd user equipment) to the 21st and 23rd user equipment excluding the 22nd user equipment which is the representative payer from the 21st to 23rd user equipment which participates the partial payment transmitted from the service providing device 300 and displays the received information.

Further, the 21st and 23rd user equipment transmits an amount corresponding to the allotment (for example, points corresponding to 40,000 won) for every participant to the first temporary account (S1170).

Further, the payment representing user equipment 100 receives one or more product information to be paid, allotment for every participant, recommended card list including a recommended card having the greatest benefit, benefit information, and actual payment amount to which the benefit information is applied, transmitted from the service providing device 300.

Further, the payment representing user equipment 100 displays the received one or more product information to be paid, allotment for every participant, recommended card list including a recommended card having the greatest benefit, benefit information, and actual payment amount to which the benefit information is applied.

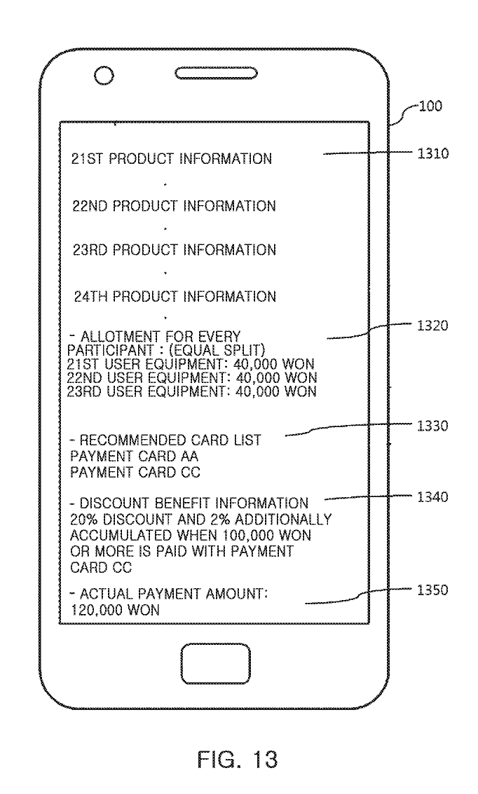

For example, as illustrated in FIG. 13, the 22nd user equipment which is the payment representing user equipment displays product information 1310 on the 21st to 24th products, an allotment for every participant (for example, 40,000 won for all the 21st to the 23rd user equipment) 1320, a recommended card list 1330 including the payment card CC having the greatest benefit, benefit information, benefit information 1340 (for example, 20% discount and 2% accumulation when 100,000 won or more is paid by the payment card CC), and an actual payment amount 1350 (for example, 120,000 won) to which the benefit information is applied, transmitted from the service providing device 300 (S1180).

Further, the payment representing user equipment 100 receives a payment card type (or unique identification information of the payment card) in accordance with the user input (or user selection) and a PIN number through a specific app which is installed in advance in the payment representing user equipment 100.

That is, the payment representing user equipment 100 checks the payment card type which is selected in accordance with the user input (or user selection) among a plurality of cards which is registered in advance in the payment representing user equipment 100. In this case, the payment representing user equipment 100 may check a payment card type (or unique identification information of the payment card) of a payment card selected from the recommended card list transmitted from the service providing device 300.

Further, the payment representing user equipment 100 receives a PIN number in accordance with the user input (or user selection) through the specific app which is installed in advance in the payment representing user equipment 100. Here, the PIN number may be a PIN number corresponding to the checked payment card type.

Further, the payment representing user equipment 100 transmits the checked payment card type (or unique identification information of the payment card), the PIN number, and the identification information of the payment representing user equipment 100 to the service providing device 300.

For example, the 22nd user equipment which is the payment representing user equipment checks the payment card CC selected from the recommended card list illustrated in FIG. 13. Further, the 22nd user equipment receives a first PIN number (for example, 987654) in accordance with user input through the electronic wallet app. Further, the 22nd user equipment transmits the checked payment card CC (or a type of the payment card CC), the received first PIN number, and the identification information of the 22nd user equipment to the service providing device 300 (S1190).

Next, the service providing device 300 receives the payment card type (or unique identification information of the payment card), the PIN number, and identification information of the payment representing user equipment 100 which is transmitted from the payment representing user equipment 100 in response to the one or more benefit information and the recommended card list including one or more recommended cards which are previously transmitted to the payment representing user equipment 100.

Further, the service providing device 300 checks the temporary account to whether all of the actual payment amount (or total payment amount) is collected. In this case, the service providing device 300 may check whether all amounts excluding the allotment corresponding to the user equipment 100 of the representative payer are collected.

For example, the service providing device 300 receives the payment card CC (or a type of the payment card CC), the received first PIN number, and the identification information of the 22nd user equipment transmitted from the 22nd user equipment which is the payment representing user equipment.

Further the service providing device 300 checks whether all the allotment (for example, 40,000 won) for every participant is transmitted to the first temporary account from the 21st and the 23rd user equipment (S1200).

When all the actual payment amounts are not collected (or when all payment amounts excluding the allotment of the payment representing user equipment among the actual payment amounts are not collected) as a checking result, the service providing device 300 returns to a step (or step S900) of checking the temporary account to check whether all the actual payment amounts are collected.

For example, when all the allotment of 40,000 won of the 21st user equipment and the allotment of 40,000 won of the 23rd user equipment excluding the allotment of 40,000 won of the 22nd user equipment which is the payment representing user equipment from the actual payment amount of 120,000 won are not collected through first temporary account, the service providing device 300 checks the first temporary account to continuously check whether the allotments are transmitted from 21st and 23rd user equipment.

Further, when all the actual payment amount (or the total payment amount) is not collected within a predetermined time (for example, 10 minutes) after creating the temporary account (or after transmitting information on the allotment for every participant and the temporary account to the plurality of user equipment 100 in the service providing device 300), the service providing device 300 cancels the partial payment and transmits information that the partial payment is cancelled to the plurality of user equipment 100 which participates the partial payment. Further, when the partial payment is cancelled, the service providing device 300 refunds the previously collected allotment to the user equipment 100 which provides the collected allotment.

As another example, when all the allotment of 40,000 won of the 21st user equipment and the allotment of 40,000 won of the 23rd user equipment excluding the allotment of 40,000 won of the 22nd user equipment which is the payment representing user equipment from the actual payment amount of 120,000 won are not collected through first temporary account within 10 minutes, the service providing device 300 transmits information indicating that the partial payment is cancelled to the plurality of user equipment 100 which participates the partial payment and refunds the allotment (for example, 40,000 won) which is transmitted in advance to the 23rd user equipment which transmits the allotment (S1210).

Further, when all the actual payment amounts are collected (or when all payment amounts excluding the allotment of the payment representing user equipment among the actual payment amounts are collected) as a checking result, the service providing device 300 transmits one or more product information to be paid, the actual payment amount (or the total payment amount), the card information, the user information, and the benefit information corresponding to the PIN number (or the identification information of the user equipment 100 of the representative payer) related with the user equipment 100 of the representative payer which is received in advance to the payment server 500. Here, the card information includes a card number, expiration date, a card verification code (CVC) number, and a user name. The user information includes a user name, birth date, an address, and an image. Further, the benefit information includes coupon information, membership benefit information, discount benefit information, and accumulation benefit information.

For example, the service providing device 300 checks 31st card information, 31st user information, and 31st benefit information corresponding to the first PIN number (or the identification information of the 22nd user equipment) transmitted from the 22nd user equipment and transmits the checked 31st card information, 31st user information, 31st benefit information, product information on 21st to 24th products, and the actual payment amount (for example, 120,000 won) to the payment server 500 (S1220).

Next, the payment server 500 receives one or more product information to be paid, an actual payment amount (or the total payment amount), card information corresponding to a PIN number (or the identification information of the user equipment of the representative payer), user information, and benefit information transmitted from the service providing device 300.

The payment server 500 performs a payment function on the actual payment amount (or the total payment amount) corresponding to one or more product information to be paid based on the received card information, user information, and benefit information. In this case, the payment server 500 may perform a payment function on the actual payment amount (or the total payment amount) obtained by applying a benefit amount corresponding to the benefit information transmitted from the service providing device 300 (or benefit information which may be applied to the user of the user equipment 100) to price information on one or more products to be paid.

For example, the payment server 500 receives the 31st card information, 31st user information, 31st benefit information, product information on 21st to 24th products, and the actual payment amount (for example, 120,000 won) transmitted from the service providing device 300 and performs the payment function on an actual payment amount (for example, 120,000 won) obtained by applying a benefit amount (for example, 20% discount and 2% accumulated when 100,000 won or more is paid by a payment card CC) corresponding to the 31st benefit information to the 21st to 24th products to be paid (S1230).

Next, the payment server 500 transmits the payment function performed result (or payment information) to the POS terminal 400 and the service providing device 300. Here, the payment function performed result (or the payment information) includes a product name (or a service name), a unique product code (a unique service code), a unit price, an amount, a discounted price, whether to apply a coupon, a price, an actual payment amount (a total payment price), payment date and time information, and a payment card type.

In this case, when an accumulated point which is accumulated in accordance with the performing of the payment function is generated, the payment server 500 may transmit the payment function performed result and accumulated point information in accordance with the performing of the payment function to the POS terminal 400 and the service providing device 300.

For example, the payment server transmits the payment function result performed result on the 21st to 24th products to the POS terminal 400 and the service providing device 300.

As another example, the payment server 500 transmits a payment function performed result on the 21st to 24th products and accumulated point information (for example, including the accumulated points of 2,400 won corresponding to 2% accumulation of the actual payment amount/total payment amount) to the POS terminal 400 and the service providing device 300 (S1240).

Next, the service providing device 300 receives the payment function performed result (or payment information) and accumulated point information in accordance with the performing of the payment function transmitted from the payment server 500 in response to the previously transmitted card information.

Further, the service providing device 300 transmits the payment function performed result (or the payment information) to the plurality of user equipment 100 which participates the partial payment.

The plurality of user equipment 100 receives the payment function performed result transmitted from the service providing device 300 and displays the received payment function performed result.

For example, the service providing device 300 receives the payment function performed result on the 21st to 24th products and the accumulated point information (for example, including the accumulated points of 2,400 won corresponding to 2% accumulation of the actual payment amount/total payment amount) transmitted from the payment server 500 and transmits the received payment function performed result on the 21st to 24th products to the 21st to 23rd user equipment which participates the partial payment (S1250).

Next, the service providing device 300 provides (or transmits) the previously collected actual payment amount (or the total payment amount or a payment amount excluding the allotment of the payment representing user equipment among the actual payment amounts) to the payment representing user equipment 100 (or a predetermined account of the payment representing user equipment 100). In this case, when a plurality of representative payers is selected, the service providing device 300 divides the previous collected actual payment amount in accordance with a ratio paid by the plurality of representative payers and provides the divided payment amount to the plurality of payment representing user equipment 100 corresponding to the plurality of representative payers.

Further, the payment representing user equipment 100 receives (or checks) the actual payment amount (or the total payment amount) provided from the service providing device 300.

For example, the service providing device 300 provides the previously collected allotments (for example, 80,000 won including the allotment of the 21st user equipment and the 23rd user equipment excluding the allotment of the 22nd user equipment which is the representative payer) to an account which is registered in advance by the 22nd user equipment which is the representative payer. Further, the 22nd user equipment checks a deposit of the collected allotments provided from the service providing device 300 (S1260).

Further, when there are accumulated points in accordance with the performing of the payment function (or points in accordance with the payment are generated after performing the payment function), the service providing device 300 distributes the accumulated points in accordance with the allotment for every participant.

Further, the plurality of user equipment 100 displays (or checks) information on the accumulated points which are distributed by the service providing device 300.

For example, when accumulated point information in accordance with the performing of the payment function (for example, including the accumulated points of 2,400 won corresponding to 2% accumulation of the actual payment amount/total payment amount) is received, the service providing device 300 distributes the accumulated points (2,400 won) to 800 won for the 21st user equipment, 800 won for the 22nd user equipment, and 800 won for the 23rd user equipment in accordance with the allotments of participants (for example, 40,000 won for the 21st user equipment, 40,000 won for the 22nd user equipment, and 40,000 won for the 23rd user equipment) and provides the distributed accumulated points to the 21st to 23rd user equipment. Further, the 21st to 23rd user equipment displays the payment function performed result and the information on the accumulated points transmitted from the service providing device 300 (S1270).

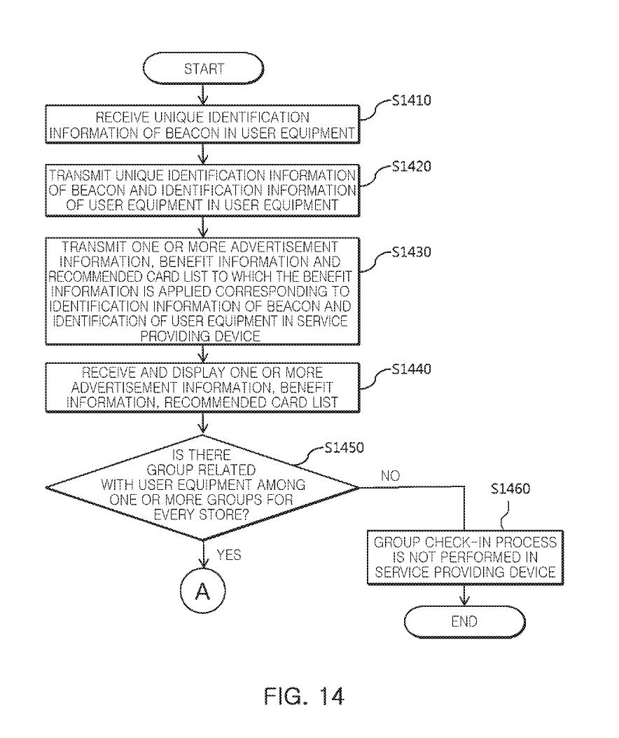

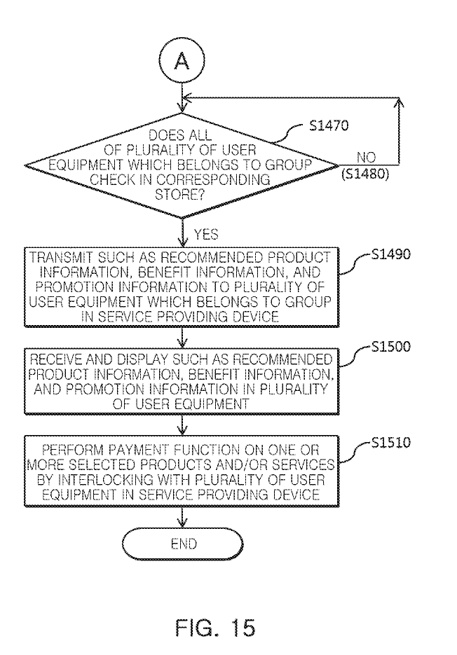

FIGS. 14 and 15 are flow charts illustrating a control method of a payment system according to a fourth exemplary embodiment of the present invention.

Further, when a user who carries the user equipment 100 enters a store, the user equipment 100 receives the identification information (or unique identification information of a store provided with the beacon 200) of the beacon 200 transmitted from the beacon 200.

For example, when a user who carries the first user equipment 100 enters a food store, the first user equipment receives identification information of the beacon broadcasted (or transmitted) from the beacon 200 equipped in the food store (S1410).

Next, the user equipment 100 transmits the received unique identification information of the beacon 200 (or the unique identification information of a store equipped with the beacon 200) and the identification information of the user equipment 100 to the service providing device 300. Here, the identification information of the user equipment 100 includes a mobile directory number (MDN), a mobile IP, a mobile MAC, a subscriber identify module (Sim) card unique information, and a serial number.

Further, in order to notify (or inform) the service providing device 300 that the first user equipment enters the food store, the first user equipment transmits the previously received unique identification information of the beacon 200 and the identification information of the first user equipment to the service providing device 300 (S1420).

Next, the service providing device 300 receives the unique identification information of the beacon 200 and the identification information of the user equipment 100 transmitted from the user equipment 100.

Further, the service providing device 300 checks (or registers/sets/maintains) a check-in status for a store where the user equipment 100 visits with respect to the user equipment 100.

Further, the service providing device 300 checks one or more advertisement information and one or more benefit information which can be provided to the user equipment 100 in the store equipped with the beacon 200, among a plurality of advertisement information and a plurality of benefit information stored in advance, based on the received unique identification information of the beacon 200 and identification information of the user equipment 100.

That is, the service providing device 300 checks store information corresponding to the unique identification information of the beacon 200 among store information for every unique identification information of a plurality of beacons which is stored in advance. Further, the service providing device 300 checks one or more advertisement information and benefit information which may be provided to the user equipment 100 in the store based on the checked store information and the received identification information of the user equipment 100.

Further, the service providing device 300 creates a recommended card list including one or more recommended cards to which the benefit information may be applied (or reflected) among a plurality of cards issued to the user equipment 100, based on one or more checked benefit information. Here, the benefit information includes coupon information, membership benefit information, and discount benefit information.

Further, the service providing device 300 transmits one or more advertisement information, one or more benefit information, and a recommended card list including one or more recommended cards which may be provided to the user equipment 100 in the store equipped with the checked beacon 200 to the user equipment 100.

For example, the service providing device 300 checks food store information corresponding to the unique identification information of the beacon 200 among store information for every unique identification information of a plurality of beacons which is stored in advance. Further, the service providing device 300 checks first to third advertisement information and first and second benefit information (for example, including discount coupon information and membership benefit information) which may be provided to the first user equipment in the food store based on the checked food store information and the identification information of the first user equipment. Further, the service providing device 300 creates a recommended card list including a payment card AA, a payment card BB, and a payment card CC to which the first and second benefit information may be applied, among a plurality of cards which is issued to the first user equipment. Further, the service providing device 300 transmits the checked first to third advertisement information and first and second benefit information (for example, including discount coupon information and membership benefit information) and the recommended card list including the payment card AA, the payment card BB, and the payment card CC to the first user equipment (S1430).

Thereafter, the user equipment 100 receives one or more advertisement information, one or more benefit information, and a recommended card list in response to the unique identification information of the beacon 200 which is previously transmitted and the identification information of the user equipment 100.

Further, the user equipment 100 displays the received one or more advertisement information, one or more benefit information, and recommended card list.

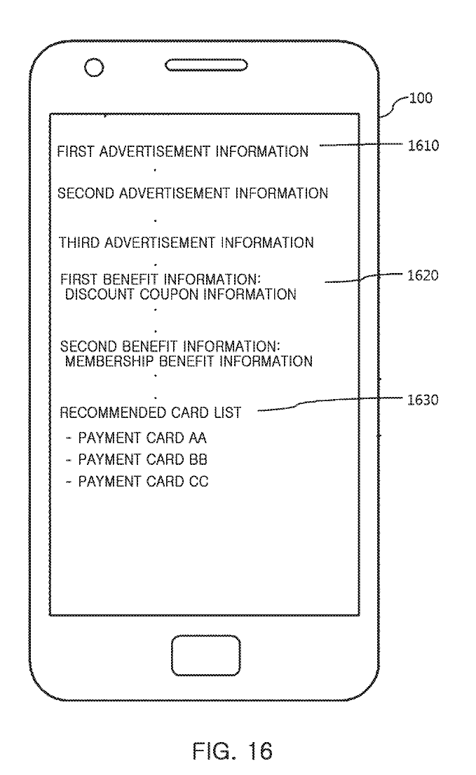

For example, as illustrated in FIG. 16, the first user equipment 100 displays the first to third advertisement information 1610 transmitted from the service providing device 300, the first and second benefit information 1620 (for example, including discount coupon information and membership benefit information) which may be provided in the food store, and the recommended card list (for example, including the payment card AA, the payment card BB, and the payment card CC) 1630 (S1440).

As described above, the service providing device 300 performs a check-in function for individual users of the user equipment 100 and provides promotion information for the personal.

Thereafter, the service providing device 300 checks whether there is a group related with the user equipment 100 in the store where the user equipment 100 visits.

That is, the service providing device 300 checks whether there is a group related with the user equipment 100 in the store where the user equipment 100 visits among one or more groups for every store which is registered (or stored) in advance.

For example, the service providing device 300 checks whether there is a group including the identification information of the first user equipment among the identification information of one or more user equipment included in a plurality of groups (for example, including a group A, a group B, a group C, a group D, and a group E) related with the food store where the first user equipment (or the user of the first user equipment) visits (S1450).

When there is no group related with the user equipment 100 in the store where the user equipment 100 visits as a checking result, the service providing device 300 does not perform a group check-in process.

For example, when there is no group including the identification information of the first user equipment among the identification information of one or more user equipment included in the plurality of groups (for example, including the group A, the group B, the group C, the group D, and the group E) related with the food store, the service providing device 300 ends the entire process without performing a group check-in process in regard to the first user equipment (S1460).

Further, when there is a group related with the user equipment 100 in the store where the user equipment 100 visits as a checking result, the service providing device 300 determines whether all of the plurality of user equipment 100 which belongs to the group is in the check-in status in the store.

Further, when there is a group including the identification information of the first user equipment among the identification information of one or more user equipment included in the plurality of groups (for example, including the group A, the group B, the group C, the group D, and the group E) related with the food store (for example, when the identification information of the first user equipment is included in the group C), the service providing device 300 determines whether all the first to fourth user equipment which belong to the group C are in a check-status in the food store (S1470).

When not all of the plurality of user equipment 100 which belongs to the group is in the check-in status in the store as a determination result, the service providing device 300 returns to a previous step of determining whether all of the plurality of user equipment 100 which belongs to the group is in the check-in status in the store.

Further, when all of the first to fourth user equipment which belongs to the group C is not in the check-in status in the store (or only the first and fourth user equipment among the first to fourth user equipment which belongs to the group C are in a check-in status in the food store), the service providing device 300 returns to a step (or a step of S1470) of determining whether all of the first to fourth user equipment which belongs to the group C are in the check-in status in the store (S1480).

Further, when all of the plurality of user equipment 100 which belongs to the group is in the check-in status in the store as a determination result, the service providing device 300 checks one or more recommended product information, one or more coupon information (for example, including a discount/free coupon), one or more promotion information, which can be provided to the group among a plurality of benefit information for every store which is stored in advance, based on previous purchase records of the group and transmits the checked one or more recommended product information, coupon information (for example, including a discount/free coupon), promotion information, which can be provided to the group, to the plurality of user equipment 100 which belongs to the group. In this case, the service providing device 300 may one or more recommended product information, one or more coupon information (for example, including a discount/free coupon), one or more promotion information only to payment representing user equipment 100 which is set in advance for the group. Here, the service providing device 300 may transmit the information indicating that the group check-in is performed in the plurality of user equipment 100 which belongs to the group, simultaneously (or before transmitting one or more recommended product information).

For example, when all of the first to fourth user equipment which belongs to the group C is in the check-in status in the food store, the service providing device 300 checks 21st recommended product information and 21st discount coupon information which can be provided to the group C, among the plurality of benefit information of the food store which is stored in advance based on the previous purchasing record of the group C and transmits the checked 21st recommended product information and 21st discount coupon information to the first to fourth user equipment (S1490).

As described above, the service providing device 300 performs a group check-in function on the plurality of user equipment 100 which belongs to a specific group and provides the promotion information on the plurality of user equipment 100 which belongs to the group.

Thereafter, the plurality of user equipment 100 which belongs to the group receives one or more recommended product information, one or more coupon information (for example, including a discount/free coupon), and one or more promotion information, transmitted from the service providing device 300.

Thereafter, the plurality of user equipment 100 which belongs to the group displays one or more recommended product information, one or more coupon information (for example, including a discount/free coupon), and one or more promotion information.

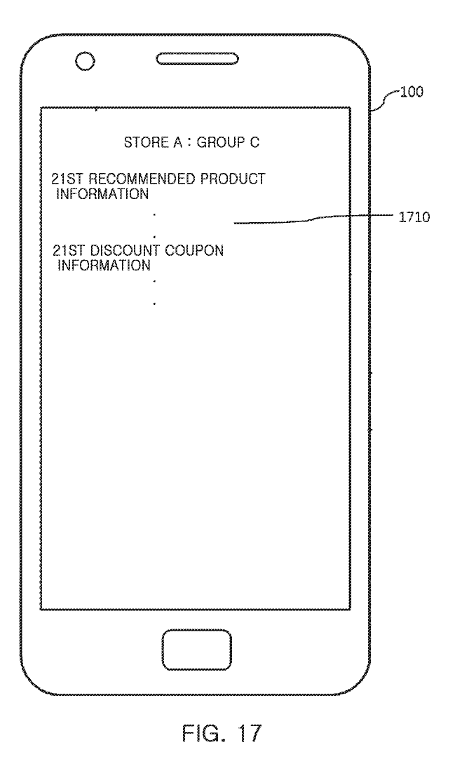

For example, as illustrated in FIG. 17, the first user equipment displays 1710 21st recommended product information and 21st discount coupon information transmitted from the service providing device 300 (S1500).

Next, the service providing device 300 performs a payment function (or a partial payment function) on one or more products and/or service selected (or commonly selected) by the plurality of user equipment 100 which belongs to the group (or at least one user equipment 100 among the plurality of user equipment 100 which belongs to the group) by interlocking with the plurality of user equipment 100 which belongs to the group. In this case, the service providing device 300 may immediately perform the partial payment function based on the information which is set in advance for the group (for example, including an allotment for every participant and a payment method (including equal payment and representative payment)). Here, the service providing device 300 may apply a simple payment function to perform the payment function in accordance with the above-described simple payment function by interlocking with the plurality of user equipment 100 which belongs to the group.

Further, the service providing device 300 provides the payment function performed result to the plurality of user equipment 100 which belongs to the group. In this case, the payment function performed result (or the payment information) includes a product name (or a service name), a unique product code (a unique service code), a unit price, an amount, a discounted price, whether to apply a coupon, a price, an actual payment amount (a total payment price), payment date and time information, and a payment card type.

The plurality of user equipment 100 receives the payment function performed result transmitted from the service providing device 300 in accordance with the group check-in and displays the received payment function performed result.

Further, the service providing device 300 manages (or stores) purchasing information of one or more products and/or services paid by the group as a purchasing record of the group together with a purchasing record for each user equipment 100.

For example, the service providing device 300 performs the partial payment function on 31st to 35th products selected by the first to fourth user equipment which belongs to the group C, according to a predetermined allotment (or an allotting rate, for example, equally split) for every participant for a payment amount (for example, 100,000 won−20,000 won=80,000 won) obtained by applying the benefit amount (for example, 20,000 won obtained by applying 20% discount) corresponding to the 21st discount coupon to price information (for example, 100,000 won) for the selected 31st to 35th products, by interlocking the first to fourth user equipment and the payment server 500. Further, the service providing device 300 provides the partial payment function performed result to the first to fourth user equipment. Further, the first to fourth user equipment receives the partial payment function performed result through the group C transmitted from the service providing device 300 and displays the received partial payment function performed result (S1510).

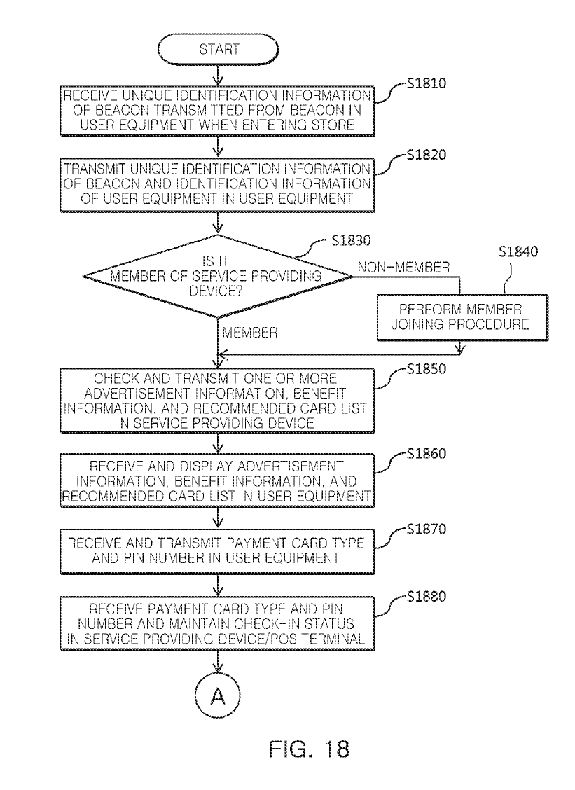

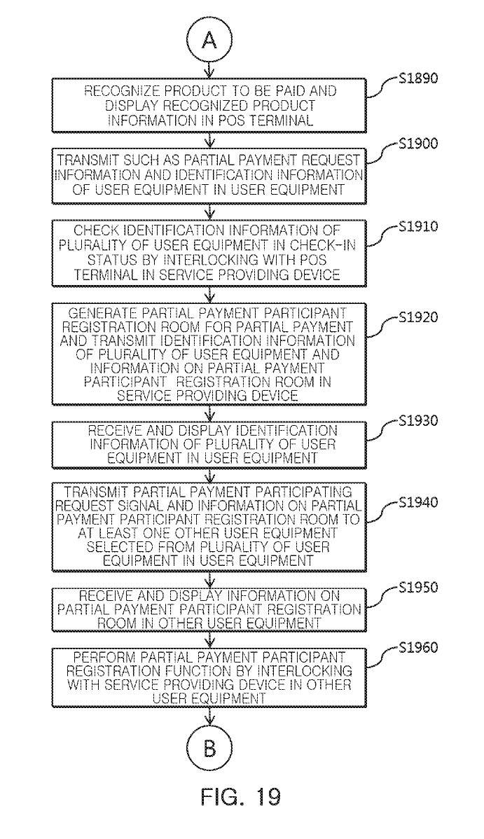

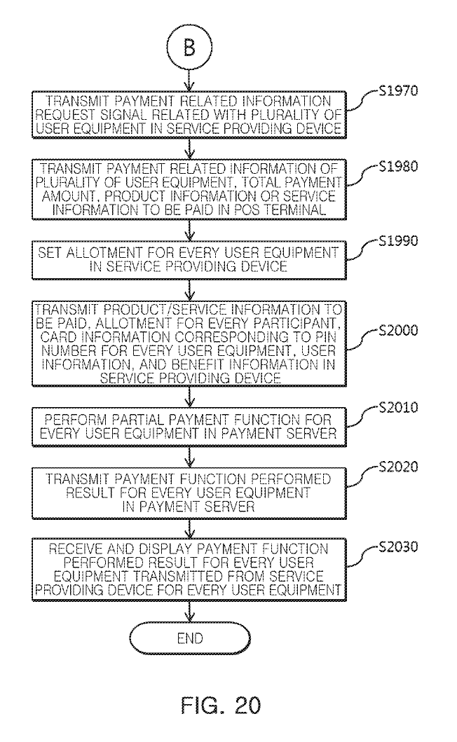

FIGS. 18 and 20 are flow charts illustrating a control method of a payment system according to a fifth exemplary embodiment of the present invention. Further, when a user who carries the user equipment 100 enters a store, the user equipment 100 receives the identification information (or unique identification information of a store provided with the beacon 200) of the beacon 200 transmitted from the beacon 200.

For example, when a user who carries the first user equipment 100 enters a store A, the first user equipment receives identification information of the beacon broadcasted (or transmitted) from the beacon 200 equipped in the store A (S1810).

Next, the user equipment 100 transmits the received unique identification information of the beacon 200 (or the unique identification information of a store equipped with the beacon 200) and the identification information of the user equipment 100 to the service providing device 300. Here, the identification information of the user equipment 100 includes a mobile directory number (MDN), a mobile IP, a mobile MAC, a subscriber identify module (Sim) card unique information, and a serial number.

Further, in order to notify (or inform) the service providing device 300 that the first user equipment enters the store, the first user equipment transmits the previously received unique identification information of the beacon 200 and the identification information of the first user equipment to the service providing device 300 (S1820).

Next, the service providing device 300 receives the unique identification information of the beacon 200 and the identification information of the user equipment 100 transmitted from the user equipment 100.

Further, the service providing device 300 determines (or checks) whether the user corresponding to the user equipment 100 is a member who is registered (joined) in advance in the service providing device 300 based on the received identification information of the user equipment 100.

For example the service providing device 300 determines whether the user joins as a member based on the identification information of the first user equipment (S1830).

When the user corresponding to the user equipment 100 is not a member who is registered in advance in the service providing device 300 as a determination result (or a checking result), the service providing device 300 transmits guide information related with the member joining procedure to the user equipment 100.

Further, the service providing device 300 interlocks with the user equipment 100 to perform a member joining procedure for the user equipment 100 (or the user of the user equipment 100).

Further, a member joining procedure on the user equipment 100 is normally completed and the following subsequent processes may be normally performed.

When the first user equipment is not a member who is registered in advance in the service providing device 300, the service providing device 300 interlocks with the first user equipment to perform a member joining procedure on the first user equipment based on guide information related with the member joining (S1840).

Further, when the user corresponding to the user equipment 100 is a member who is registered in advance in the service providing device 300 as a determination result (or a checking result), the service providing device 300 checks one or more advertisement information and one or more benefit information which may be provided to the user equipment 100 in the store provided with the beacon 200, among a plurality of advertisement information and a plurality of benefit information which are stored in advance based on the unique identification information of the beacon 200 which is previously received and the identification information of the user equipment 100.

Further, the service providing device 300 creates a recommended card list including one or more recommended cards to which the benefit information may be applied (or reflected) among a plurality of cards issued to the user equipment 100, based on one or more checked benefit information. Here, the benefit information includes coupon information, membership benefit information, and discount benefit information.

The service providing device 300 transmits one or more advertisement information, one or more benefit information, and a recommended card list including one or more recommended cards which may be provided to the user equipment 100 in the store equipped with the checked beacon 200 to the user equipment 100.

That is, when the user corresponding to the user equipment 100 is a member who is registered in advance in the service providing device 300, the service providing device 300 checks store information corresponding to the unique identification information of the beacon 200 among store information for every unique identification information of the plurality of beacons which is stored in advance. Further, the service providing device 300 checks one or more advertisement information and benefit information which may be provided to the user equipment 100 in the store based on the checked store information and the received identification information of the user equipment 100. Further, the service providing device 300 creates the recommended card list including at least one card to which the benefit information is applied, among a plurality of cards (or one or more cards) which is previously issued to the user equipment 100. Further, the service providing device 300 transmits one or more checked advertisement information, one or more checked benefit information, and the created recommended card list to the user equipment 100.

For example, when the first user equipment is a member who is registered in advance in the service providing device 300, the service providing device 300 checks store A information corresponding to the unique identification information of the beacon 200 among store information for every unique identification information of the plurality of beacons which is stored in advance. Further, the service providing device 300 checks first to third advertisement information and first and second benefit information (for example, including discount coupon information and membership benefit information) which may be provided to the user equipment 100 in the store A based on the checked store A information and the identification information of the user equipment 1. Further, the service providing device 300 creates a recommended card list including a card AA, a card BB, a card CC, and a card DD to which the first and second benefit information may be applied, among a plurality of cards which is issued to the first user equipment. Further, the service providing device 300 transmits the checked first to third advertisement information and first and second benefit information (for example, including discount coupon information and membership benefit information) and the recommended card list including a card AA, a card BB, a card CC, and a card DD to the first user equipment (S1850).

Thereafter, the user equipment 100 receives one or more advertisement information, one or more benefit information, and a recommended card list in response to the unique identification information of the beacon 200 which is previously transmitted and the identification information of the user equipment 100.

Further, the user equipment 100 displays the received one or more advertisement information, one or more benefit information, and recommended card list through a specific app which is installed in advance in the user equipment 100.

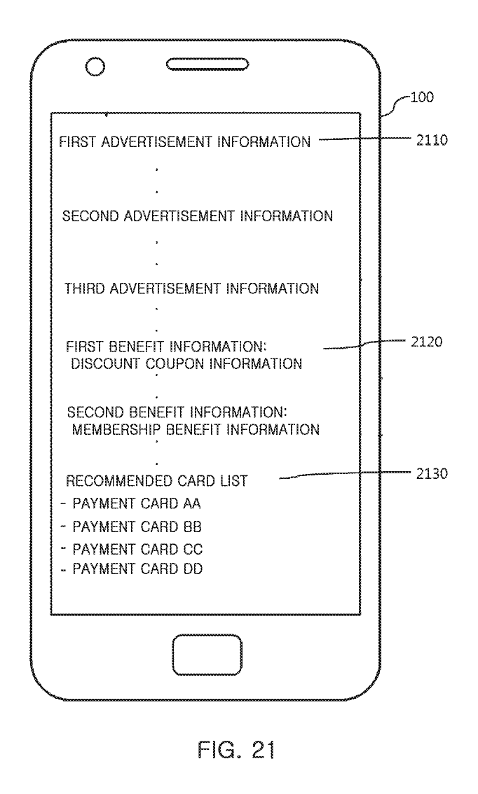

For example, as illustrated in FIG. 21, the first user equipment displays the first to third advertisement information 2110 transmitted from the service providing device 300, the first and second benefit information 2120 (for example, including discount coupon information and membership benefit information) which may be provided in the store A, and the recommended card list 2130 including the payment card AA, the payment card BB, the payment card CC, and the payment card DD 2130 (S1860).

That is, the user equipment 100 checks the payment card type which is selected in accordance with the user input (or user selection) among one or more recommended cards which is included in the recommended card list displayed on the user equipment 100.

Further, the user equipment 100 receives a PIN number in accordance with the user input (or user selection) through the specific app which is installed in advance in the user equipment 100. Here, the PIN number may be a PIN number corresponding to the previously checked payment card type.

Further, the user equipment 100 transmits the checked payment card type (or unique identification information of the payment card), the PIN number (or a PIN number corresponding to the checked payment card type), and the identification information of the user equipment 100 to the service providing device 300 (or the POS terminal 400).

For example, the first user equipment checks a card DD selected from the recommended card list 2130 including a card AA, a card BB, a card CC, and a card DD illustrated in FIG. 21. Further, the first user equipment receives a first PIN number (for example, 123456) in accordance with user input through the electronic wallet app which is installed in advance in the first user equipment. Further, the first user equipment transmits the checked card DD (or the type of card DD), the received PIN number, and the identification information of the first user equipment to the service providing device 300 or to the POS terminal 400 through BLE communication (S1870).

Next, the service providing device 300 (or the POS terminal 400) receives the payment card type, the PIN number, and the identification information of the user equipment 100 transmitted from the user equipment 100.

Further, after receiving the payment card type, the PIN number, and the identification information of the user equipment 100, the service providing device 300 (or the POS terminal 400) maintains a stand-by status (or a check-in status) for simple payment.

For example, the service providing device 300 (or the POS terminal 400) receives the card DD (or a type of the card DD) transmitted from the first user equipment, the received first PIN number, and the identification information of the first user equipment.

As described above, the service providing device 300 (or the POS terminal 400) receives and manages prior information (for example, including the payment card type, the PIN number, and the identification information of the user equipment 100) for simple payment of the user equipment 100 which enters the store equipped with the POS terminal 400.

Further, the service providing device 300 (or the POS terminal 400) maintains the check-in status with the second to tenth user equipment by interlocking (or communicating) with the plurality of second to tenth user equipment 100 which visits a store equipped with the POS terminal 400 (S1880).

Thereafter, the POS terminal 400 scans (or recognizes a code such as a barcode attached on a product to be paid) one or more products (or payment products) to be paid which are selected by the user of the user equipment 100.

The POS terminal 400 displays product information on one or more scanned (or recognized) products to be paid. Here, the product information includes a product name, a unique product code, a unit price, an amount, a price, a total price, and the like.

Further, the POS terminal 400 checks service information for a service to be paid, which is selected (or used) by the user of the user equipment 100, and displays the checked service information. Here, the service information includes a service name, a unique service code, a unit price, an amount, a price, a total price, and the like.

For example, the POS terminal 400 recognizes barcodes attached on eleventh to thirteenth products which are selected by a uses of the first user equipment and displays product information on the recognized eleventh to thirteenth products.

As another example, the POS terminal 400 displays service information on eleventh to fourteenth services which are used by the user of the first user equipment (S1890).

Thereafter, when an in-store friend finding menu (or item/button) which is set in advance through an app which is installed in advance in the user equipment 100 to perform the partial payment function on the product or service selected (or used/wanted to purchase) by the user of the user equipment 100, the user equipment 100 transmits partial payment request information and the identification information of the user equipment 100 to the service providing device 300.

For example, when a predetermined in-store friend finding menu which is displayed on an app is selected in accordance with the user manipulation (or control of the user) of first user equipment 100 through an app which is installed in advance in the first user equipment, the first user equipment generates partial payment request information to perform the partial payment function on the previously selected eleventh to thirteenth products and transmits the generated partial payment request information and the identification information of the first user equipment to the service providing device 300 (S1900).

Next, the service providing device 300 receives partial payment request information and the identification information of the user equipment 100 transmitted from the user equipment 100.

Further, the service providing device 300 checks the identification information (for example, including phone numbers of the plurality of user equipment 100) of the plurality of user equipment 100 which is in the check-in status in the store equipped with the POS terminal by interlocking with the POS terminal 400. In this case, the identification information of the plurality of user equipment 100 which is in the check-in status in the store equipped with the POS terminal includes identification information of the user equipment 100.

That is, the service providing device 300 requests the identification information of the user equipment 100 which is in the check-in status in the POS terminal 400 to the POS terminal 400 based on the previously received partial payment request information and receives the identification information of the plurality of user equipment 100 which is in the check-in status in the store equipped with the POS terminal 400 which is transmitted from the POS terminal 400 in response to the request.

In this case, the POS terminal 400 may provide only identification information of the plurality of user equipment 100 located within a communication range (or a BLE communication range) of the POS terminal 400, to the service providing device 300.

In this case, the POS terminal 400 may provide identification information of the plurality of user equipment 100 which is located within a communication range (or a BLE communication range) of the POS terminal 400 and maintains a check-in status in the store, to the service providing device 300.

For example, the service providing device 300 requests the identification information of the user equipment which is in the check-in state to the POS terminal 400 based on the previously received partial payment request information. Further, the POS terminal 400 checks identification information of the first to tenth user equipment which is in the check-in status in the store A equipped with the POS terminal 400 which is located in the communication range of the POS terminal 400 and transmits the checked identification information (for example, phone numbers of the first to tenth user equipment) of the first to tenth user equipment which is in the check-in status to the service providing device 300. Further, the service providing device 300 receives the identification information of the first to tenth user equipment which is in the check-in status in the store A, transmitted from the POS terminal 400 in response to the previous request (S1910).

Next, the service providing device 300 creates a partial payment participant registration room for partial payment based on the previously received partial payment request information. The created partial payment participant registration room is managed by being interlocked (matched) with the identification information of the user equipment 100. Here, the partial payment participant registration room includes information such as a registration room name, a registration room unique number, a maximum number of partial payment participants.

Further, the service providing device 300 transmits the checked identification information of the plurality of user equipment 100 which is in the check-in status in the store equipped with the POS terminal 400 and information on the created partial payment participant registration room to the user equipment 100.

For example, the service providing device 300 creates a first partial payment participant registration room based on the partial payment request information of the first user equipment. For example, the service providing device 300 transmits the previously checked (or received) identification information (for example, phone numbers of the first to tenth user equipment) of the first to tenth user equipment 100 and information on the first partial payment participant registration room (for example, a registration room name: store A-ABCD team, unique number of registration room: store A-#1001, a maximum number of partial payment participants: 5) to the first user equipment (S1920).

Thereafter, the user equipment 100 receives the identification information of the plurality of user equipment 100 which is in the check-in status in the store equipped with the POS terminal 400 and information on the partial payment participant registration room transmitted from the service providing device 300 in response to the previously transmitted partial payment request information.

Further, the user equipment 100 displays the received identification information of the plurality of user equipment 100. In this case, the user equipment 100 displays identification information of the remaining user equipment 100 excluding identification information of the user equipment 100 from identification information of the plurality of user equipment 100.

Here, the user equipment 100 checks (or determines) whether there is identification information of the user equipment stored (or registered) in the phone book (or an address book) of the corresponding user equipment 100 among the received identification of the plurality of user equipment 100.

Further, when there is identification information of one or more user equipment 100 stored in the phone book of the corresponding user equipment 100 among the received identification of the plurality of user equipment 100 as a checking result, the user equipment 100 checks a title (for example, including a name or a nickname) stored in a title item (or a name item) of the phone book for the identification information of the one or more user equipment 100 stored in the phone book of the corresponding user equipment 100.

Further, when the identification information of the plurality of user equipment 100 is displayed, the user equipment 100 may display the title corresponding to the identification information of the user equipment stored in the phone book with respect to the identification information of the user equipment stored in the phone book of the user equipment 100.

For example, the first user equipment receives the identification information (for example, phone numbers of the first to tenth user equipment) of the first to tenth user equipment 100 which is in the check-in status in the store A equipped with the POS terminal 400 and information on the created first partial payment participant registration room (for example, a registration room name: store A-ABCD team, unique number of registration room: store A-#1001, a maximum number of partial payment participants: 5) transmitted from the service providing device 300, in response to the previously transmitted partial payment request information.

Further, the first user equipment checks second user equipment, fourth user equipment, fifth user equipment, sixth user equipment, and ninth user equipment which are registered in the phone book of the first user equipment among the identification information of the second to tenth user equipment. Further, the first user equipment checks titles (for example, Gil-dong Hong corresponding to the second user equipment, Chul-su corresponding to the fourth user equipment, Younghee corresponding to the fifth user equipment, Deputy section chief Kim corresponding to the sixth user equipment, and Section chief Lee corresponding to the ninth user equipment) corresponding to the second user equipment, fourth user equipment, fifth user equipment, sixth user equipment, and ninth user equipment which are registered in the phone book.

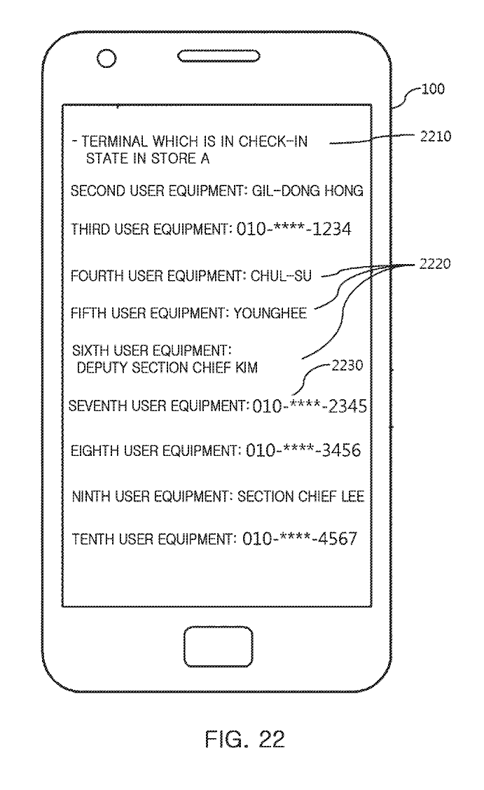

Further, as illustrated in FIG. 22, the first user equipment displays the received identification information of the second to tenth user equipment (for example, phone numbers of the second to tenth user equipment) 2210. In this case, the first user equipment displays 2220 the titles registered in the phone book instead of the phone number of the second user equipment, the fourth user equipment, the fifth user equipment, the sixth user equipment, and the ninth user equipment which are registered in the phone book of the first user equipment among the phone numbers of the second to tenth user equipment. Further, the first user equipment may display 2230 only a part (for example, telephone exchange number and last four digits) of phone numbers of third user equipment, seventh user equipment, eighth user equipment, and tenth user equipment (S1930).

Next, when at least one other user equipment 100 is selected by the selection (or control) the user of the user equipment 100 among the identification information (the remaining user equipment 100 excluding the identification information of the corresponding user equipment 100 among the plurality of the identification information of the plurality of user equipment 100) of the plurality of user equipment 100 displayed on the user equipment 100, the user equipment 100 transmits a partial payment participating request signal and information on the partial payment participant registration room to at least one other selected user equipment 100.

In this case, the user equipment 100 may directly transmit the partial payment participating request signal and information on the partial payment participant registration room to the at least one other user equipment 100 or transmit the partial payment participating request signal and information on the partial payment participant registration room to the at least one other user equipment 100 via the service providing device 300.

For example, when the second user equipment, the fourth user equipment, the fifth user equipment, the ninth user equipment are selected among the second to tenth user equipment illustrated in FIG. 22, the first user equipment generates a partial payment participating request signal and transmits the generated partial payment participating request signal and information on the first partial payment participant registration room (for example, a registration room name: store A-ABCD team, unique number of registration room: store A-#1001, a maximum number of partial payment participants: 5) to the second user equipment, the fourth user equipment, the fifth user equipment, the ninth user equipment (S1940).

Next, at least one other user equipment 100 receives the generated partial payment participating request signal and the information on the first partial payment participant registration room transmitted from the user equipment 100 (or the service providing device 300). In this case, the at least one other user equipment 100 may be user equipment which is in a check-in state in the same store as the store where the user equipment 100 is located.

Further, the at least one user equipment 100 displays the received partial payment participating request signal and the information on the first partial payment participant registration room.

For example, the fifth user equipment receives the generated partial payment participating request signal and the information on the first partial payment participant registration room (for example, a registration room name: store A-ABCD team, unique number of registration room: store A-#1001, a maximum number of partial payment participants: 5) transmitted from the first user equipment and displays the received partial payment participating request signal and information on the first partial payment participant registration room (for example, a registration room name: store A-ABCD team, unique number of registration room: store A-#1001, a maximum number of partial payment participants: 5).

Next, when at least one other user equipment 100 participates the partial payment, the other user equipment 100 accesses the service providing device 300 based on the previously received information on the partial payment participant registration room.

Further, the other user equipment 100 registers as a partial payment participant for the partial payment in the partial payment participant registration room included in (or corresponding to/according to) the information on the accessed partial payment participant registration room by interlocking with the service providing device 300.

For example, when the second user equipment, the fourth user equipment, the fifth user equipment, and the ninth user equipment participate the partial payment, the second user equipment, the fourth user equipment, the fifth user equipment, and the ninth user equipment access the registration room unique number: store A-#1001 provided by the service providing device 300 based on the information on the first partial payment participant registration room (for example, a registration room name: store A-ABCD team, unique number of registration room: store A-#1001, a maximum number of partial payment participants: 5) and register in the registration room as partial payment participants for partial payment. In this case, the first user equipment which establishes the registration room may be already registered as the partial payment participant (S1960).

Next, when a predetermined time for partial payment has elapsed (or when a plurality of user equipment corresponding to the maximum number of partial payment participants which is set in advance for the partial payment all registers as partial payment participant), the service providing device 300 transmits a payment related information request signal related with the plurality of user equipment 100 which participates the partial payment to the POS terminal 400. Here, the payment related information request signal includes identification information of the plurality of user equipment which participates the partial payment.

For example, when the first user equipment, the second user equipment, the fourth user equipment, the fifth user equipment, and the ninth user equipment corresponding to five participants which are set in advance for the partial payment set the partial payment participant registration, the service providing device 300 transmits payment related information request signal (for example, including the identification information of the first user equipment, the identification information of the second user equipment, the identification information of the fourth user equipment, the identification information of the fifth user equipment, and the identification information of the ninth user equipment) related with the first user equipment, the second user equipment, the fourth user equipment, the fifth user equipment, and the ninth user equipment to the POS terminal 400 (S1970).

Next, the POS terminal 400 receives the payment related information request signal related with the plurality of user equipment 100 which participates the partial payment, transmitted from the service providing device 300.

Further, the POS terminal 400 transmits a payment card type (or a payment card type for every user equipment/a payment card type for every user equipment which participates partial payment) related with the plurality of user equipment 100, the PIN number (or a PIN number for every user equipment), the identification information of the user equipment 100 (or identification information of user equipment for every user equipment), a total payment amount for a product or a service selected by the user of the user equipment 100, or information on one or more products or services to be paid, to the service providing device 300, in response to the payment related information request signal related with the plurality of user equipment 100 which participates the partial payment.

For example, the POS terminal 400 transmits a total payment amount (for example, 250,000 won) for eleventh to thirteenth products and product information on the eleventh to thirteenth products, the payment card type for every user equipment (for example, including a payment card DD for the first user equipment, a payment card AA for the second user equipment, a payment card AA for the fourth user equipment, a payment card BB for the fifth user equipment, and a payment card CC for the ninth user equipment), PIN numbers for every user equipment (for example, including a first PIN number for the first user equipment, a second PIN number for the second user equipment, a fourth PIN number for the fourth user equipment, a fifth PIN number for the fifth user equipment, and a ninth PIN number for the ninth user equipment), and identification information of the user equipment for every user equipment to the service providing device 300 in response to the payment related information request signal transmitted from the service providing device 300 (S1980).

Next, the service providing device 300 receives a payment card type (or a payment card type for every user equipment/a payment card type for every user equipment which participates partial payment) related with the plurality of user equipment 100 which participates the partial payment, the PIN number (or a PIN number for every user equipment), the identification information of the user equipment 100 (or identification information of user equipment for every user equipment), a total payment amount for a product or a service selected by the user of the user equipment 100, or information on one or more products or services to be paid, transmitted from the POS terminal 400 in response to the previously transmitted payment related information request signal related with the plurality of user equipment 100 which participates the partial payment.

Further, the service providing device 300 sets an allotment for every participant based on a total payment amount and the number of the plurality of user equipment 100 which participates the partial payment. In this case, an allotment setting method may include a method of setting by 1/n (or equal split) based on the number of the plurality of user equipment 100, a method of setting an amount (or a ratio of an allotted amount) allotted to each user of an actual payment amount (or a total payment amount) for every user equipment in advance at the time of previously registering as the partial payment participants, and a method of transmitting an actual payment amount (or a total payment amount) to the plurality of user equipment 100 after checking the actual payment amount (or the total payment amount) in the service providing device 300 and receiving an allotted amount for every user equipment which is transmitted to each user equipment as a response thereof. Here, the actual payment amount is an amount obtained by applying benefit information to the payment amount. When the benefit information is not applied, the actual payment amount may be equal to the total payment amount.

For example, the service providing device 300 receives a total payment amount (for example, 250,000 won) for eleventh to thirteenth products and product information on the eleventh to thirteenth products, the payment card type for every user equipment (for example, including a payment card DD for the first user equipment, a payment card AA for the second user equipment, a payment card AA for the fourth user equipment, a payment card BB for the fifth user equipment, and a payment card CC for the ninth user equipment), PIN numbers for every user equipment (for example, including a first PIN number for the first user equipment, a second PIN number for the second user equipment, a fourth PIN number for the fourth user equipment, a fifth PIN number for the fifth user equipment, and a ninth PIN number for the ninth user equipment), and identification information of the user equipment for every user equipment transmitted from the POS terminal 400. Further, the service providing device 300 sets the same allotment of 50,000 won for every participant for every user equipment in accordance with a predetermined equal split based on the number (for example, 5) of user equipment which participates the partial payment for the first user equipment, the second user equipment, the fourth user equipment, the fifth user equipment, and the ninth user equipment which participate the partial payment for the total payment amount (for example, 250,000 won) for the eleventh to thirteenth products.

As another example, the service providing device 300 sets an allotment for every participant of 10,000 won (or 40% of total payment amount) for the first user equipment, 50,000 won (or 20% of total payment amount) for the second user equipment, 25,000 won (or 10% of total payment amount) for the fourth user equipment, 25,000 won (or 10% of total payment amount) for the fifth user equipment, 50,000 won (or 20% of total payment amount) for the ninth user equipment in accordance with the allotted amount for every user equipment which is set in advance for the first user equipment, the second user equipment, the fourth user equipment, the fifth user equipment, and the ninth user equipment which participate for the total payment amount (for example, 250,000 won) on the eleventh to thirteenth products (S1990).

Next, the service providing device 300 transmits information on one or more products or services to be paid, an allotment for every participant, card information corresponding to a PIN number for every user equipment, user information, and benefit information to the payment server 500. Here, the card information includes a card number, expiration date, a card verification code (CVC) number, and a user name. The user information includes a user name, birth date, an address, and an image. Further, the benefit information includes coupon information, membership benefit information, discount benefit information, and accumulation benefit information.

For example, the service providing device 300 transmits the product information on the eleventh to thirteenth products, an allotment for every participant (for example, the same allotment of 50,000 won in accordance with the equal split), eleventh card information, eleventh user information, eleventh benefit information corresponding to the first PIN number of the first user equipment, twelfth card information, twelfth user information, twelfth benefit information corresponding to the second PIN number of the second user equipment, fourteenth card information, fourteenth user information, fourteenth benefit information corresponding to the fourth PIN number of the fourth user equipment, fifteenth card information, fifteenth user information, fifteenth benefit information corresponding to the fifth PIN number of the fifth user equipment, nineteenth card information, nineteenth user information, nineteenth benefit information corresponding to the ninth PIN number of the ninth user equipment to the payment server 500 (S2000).

Further, the payment server 500 transmits information on one or more products or services to be paid, an allotment for every participant, card information corresponding to a PIN number for every user equipment, user information, and benefit information, transmitted from the service providing device 300.

Further, the payment server 500 performs a partial payment function for an allotment for every participant for every user equipment, based on the card information, the user information, and the benefit information corresponding to the received allotment for every participant and the PIN number for every user equipment. In this case, the payment server 500 may perform a payment function on a payment amount (or an actual payment amount) obtained by applying a benefit amount corresponding to the benefit information transmitted from the service providing device 300 (or benefit information which may be applied to the user of the user equipment 100) to the allotment for every participant.

For example, the payment server 500 receives the product information on the eleventh to thirteenth products, an allotment for every participant (for example, the same allotment of 50,000 won in accordance with the equal split), eleventh card information, eleventh user information, eleventh benefit information corresponding to the first PIN number of the first user equipment, twelfth card information, twelfth user information, twelfth benefit information corresponding to the second PIN number of the second user equipment, fourteenth card information, fourteenth user information, fourteenth benefit information corresponding to the fourth PIN number of the fourth user equipment, fifteenth card information, fifteenth user information, fifteenth benefit information corresponding to the fifth PIN number of the fifth user equipment, nineteenth card information, nineteenth user information, nineteenth benefit information corresponding to the ninth PIN number of the ninth user equipment, transmitted from the service providing device 300.

Further, the payment server 500 performs a payment function on a first actual payment amount (for example, 45,000 won) obtained by applying a first benefit amount (for example, 10% discount when 50,000 won or more is paid by the payment card DD) corresponding to the eleventh benefit information to a participating allotment (for example, 50,000 won) for the first user equipment, a payment function on a second actual payment amount (for example, 45,000 won) obtained by applying a second benefit amount (for example, 10% discount when 50,000 won or more is paid by the payment card AA) corresponding to the twelfth benefit information to a participating allotment (for example, 50,000 won) for the second user equipment, a payment function on a third actual payment amount (for example, 45,000 won) obtained by applying a fourteenth benefit amount (for example, 10% discount and 4% additional accumulation when 50,000 won or more is paid by the payment card AA) corresponding to the fourteenth benefit information to a participating allotment (for example, 50,000 won) for the fourth user equipment, a payment function for a fourth actual payment amount (for example, 50,000 won) without applying a benefit to a participating allotment (for example, 50,000 won) for the fifth user equipment, and a payment function on a fifth actual payment amount (for example, 50,000 won) obtained by applying a nineteenth benefit amount (for example, 10% accumulation when 50,000 won or more is paid by the payment card CC) corresponding to the nineteenth benefit information to a participating allotment (for example, 50,000 won) for the ninth user equipment. Further, the payment server accumulates (or provides) a fourteenth accumulated point (for example, 2,000 won) according to the fourteenth benefit information (for example, 10% discount and 4% additional accumulation when 50,000 won or more is paid by the payment card AA) to the fourth user equipment and accumulates (or provides) a nineteenth accumulated point (for example, 5,000 won) according to the nineteenth benefit information (for example, 10% accumulation when 50,000 won or more is paid by the payment card CC) to the ninth user equipment (S2010).

Next, the payment server 500 transmits the payment function performed result (or payment information for every user equipment) for every user equipment to the POS terminal 400 and the service providing device 300. Here, the payment function performed result (or the payment information for every user equipment) for every user equipment includes a product name (or a service name), a unique product code (a unique service code), a unit price, an amount, a discounted price, whether to apply a coupon, a price, an actual payment amount (a total payment price), payment date and time information, and a payment card type.

In this case, when an accumulated point which is accumulated in accordance with the performing of the payment function is generated, the payment server 500 may transmit the payment function performed result for every user equipment and accumulated point information for every user equipment in accordance with the performing of the payment function for every user equipment to the POS terminal 400 and the service providing device 300.

For example, the payment server 500 transmits a first payment function performed result related with the first user equipment, a second payment function performed result related with the second user equipment, a third payment function performed result related with the fourth user equipment, the third accumulated point information (including an accumulated point of 2,000 won corresponding to accumulation of 4% of an actual payment amount/total payment amount) related with the fourth user equipment, a fourth payment function performed result related with the fifth user equipment, a fifth payment function performed result related with the ninth user equipment, the fifth accumulated point information (including an accumulated point of 5,000 won corresponding to accumulation of 10% of an actual payment amount/total payment amount) related with the fourth user equipment to the POS terminal 400 and the service providing device 300 (S2020).

Next, after normally performing the payment function on the plurality of user equipment 100, the service providing device 300 receives a payment function performed result (or payment information for every user equipment) for every user equipment and accumulated point information in accordance with the performing of payment function for every user equipment, transmitted from the payment server 500.

Further, the service providing device 300 transmits the payment function performed result and the accumulated point information in accordance with the performing of payment function to the plurality of user equipment 100 which participates the partial payment.

Each of the plurality of user equipment 100 receives the payment function performed result and the accumulated point information in accordance with the performing of payment function transmitted from the service providing device 300 and displays the received payment function performed result and accumulated point information in accordance with the performing of payment function.

For example, the service providing device 300 receives the first payment function performed result related with the first user equipment, the second payment function performed result related with the second user equipment, the third payment function performed result related with the fourth user equipment, the third accumulated point information (including an accumulated point of 2,000 won corresponding to accumulation of 4% of an actual payment amount/total payment amount) related with the fourth user equipment, the fourth payment function performed result related with the fifth user equipment, the fifth payment function performed result related with the ninth user equipment, the fifth accumulated point information (including an accumulated point of 5,000 won corresponding to accumulation of 10% of an actual payment amount/total payment amount) related with the fourth user equipment which are partial payment performed results on the eleventh to thirteenth products transmitted from the payment server 500. Further, the service providing device 300 transmits the first payment function performed result to the first user equipment, transmits the second payment function performed result to the second user equipment, transmits the third payment function performed result and the third accumulated point information to the fourth user equipment, and transmits the fifth payment function performed result and the fifth accumulated point information to the ninth user equipment.

Further, the first user equipment displays the first payment function performed result transmitted from the service providing device 300, the second user equipment displays the second payment function performed result transmitted from the service providing device 300, the third user equipment displays the third payment function performed result and the third accumulated point information transmitted from the service providing device 300, the fourth user equipment displays the fourth payment function performed result transmitted from the service providing device 300, and the ninth user equipment displays the fifth payment function performed result and the fifth accumulated point information transmitted from the service providing device 300 (S2030).

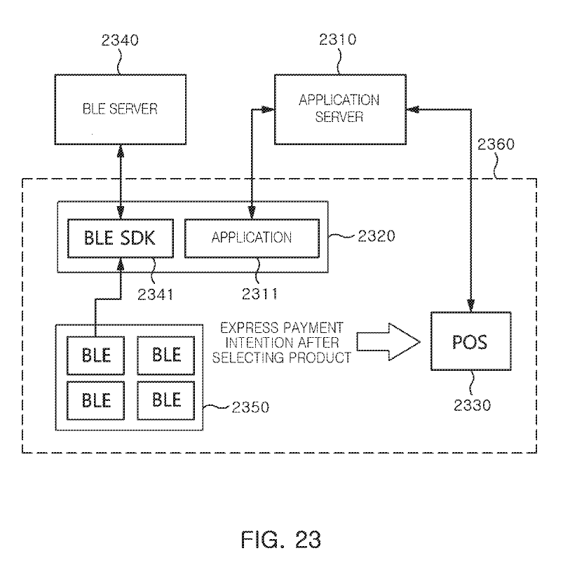

FIG. 23 is a block diagram illustrating an offline payment system using an application payment.

Referring to FIG. 23, the offline payment system using an application pay includes an application server 2310, a terminal 2320, a POS terminal 2330, a BLE server 2340, and a BLE device 2350.

In this case, an offline payment system illustrated in FIG. 23 may correspond to a system for performing offline payment using an application pay service based on an application installed in a mobile terminal of the user when a user purchases a product in an offline store.

The application server 2310 may be a server which provides an application 2311 for performing offline payment related with the offline payment to the terminal 2320 of the user to proceed a procedure corresponding to the offline payment.

In this case, the application server 2310 may correspond to an offline partial payment processing device according to an exemplary embodiment of the present invention. Further, the application server 2310 may include an offline partial payment processing device according to the present invention. For example, the application server 2310 may provide a service for partial payment by determining a partial payment situation when the offline payment is performed using the application server 2310.

In this case, the application server 2310 may transmit and receive data through a network.

In this case, the network corresponds to a passage through which data is transmitted between the application server 2310 and the terminal 2320 and is a concept including a network which is used in the related art and a network which may be developed in the future. For example, the network may be formed by one of a wired/wireless near field communication network which provides communication between various information devices in a limited area, a mobile communication network which provides communication between moving bodies and between a moving body and outside of the moving bode, and a satellite communication network which provides communication between a station and a station using a satellite, and a combination of two or more. In the meantime, the standard of the transmission method of the network is not limited to the existing transmission method standard, but may include all transmission method standards which will be developed in the future. Further, in FIG. 23, a network used between the application server 2310 and the terminal 2320 may be different from a network used between the application server 2320 and the POS terminal 2330 and between the BLE server 2340 and the terminal 2320 or equal to the network.

The terminal (or user equipment) 2320 receives information corresponding to the offline payment from the application server 2310 using the application 2311 to provide the information of the user. That is, when the partial payment is performed, information corresponding to the partial payment may be output to be provided to the user.

In this case, the terminal 2320 is a device which is connected to a communication network to execute an application and may be a mobile terminal having various mobile communication specifications such as a mobile phone, a portable multimedia played (PMP), a mobile internet device (MID), a smart phone, a tablet PC, a notebook computer, a Net book, a personal digital assistant (PDS), and information communication equipment.

Further, the terminal 2320 receives various information such as figure or character information and transmits a signal which is input to set various functions and control a function of the terminal 2320 to the control unit through an input unit. Further, the input unit of the terminal 2320 may be configured to include at least one of a key pad and a touch pad which generate an input signal in accordance with the touch or manipulation of the user. In this case, the input unit of the terminal 2320 and the display unit of the terminal 2320 are configured as one touch panel (or a touch screen) to simultaneously perform input and display functions. Further, as an input unit of the terminal 2320, all kinds of input units which will be developed in the future may be used in addition to an input device such as a keyboard, a keypad, a mouse, or a joystick. Specifically, the input unit of the terminal 2320 according to the present invention may transmit an input signal to select a card or perform the payment based on an optimal card recommending system to the control unit of the terminal 2320.

Further, the display unit of the terminal 2320 may display information on a series of operation status and operation result which occur while performing the function of the terminal 2320. For example, the display unit of the terminal 2320 displays a menu of the terminal 2320 and user data input by the user. Here, the display unit of the terminal 2320 may be configured by a liquid crystal display (LCD), a thin film transistor LCE (TFT-LCD), a light emitting diode (LED), an organic LED, an active matrix OLED (AMOLED), a retina display, a flexible display, and a three dimensional (3 Dimension) display. In this case, the display unit of the terminal 2320 is configured to be a touch screen type, the display unit of the terminal 2320 to perform all or a part of the function of the input of the terminal 2320. Specifically, the display unit of the terminal 2320 according to the present invention may display information related with the optimal recommended card and payment related information provided based on the optimal card recommend system.

Further, the storing unit of the terminal 2320 is a device which stores data and includes a main memory device and an auxiliary memory device and stores an application program required for a functional operation of the terminal 2320. The storing unit of the terminal 2320 mainly includes a program area and a data area. Here, when each function is activated in accordance with the request of the user, the terminal 2320 executes application programs under the control of the control unit to provide each function. Specifically, the storing unit of the terminal 2320 according to the present invention may store an operating system which boots the terminal 2320 and a program which recommends a card or performs a payment based on the optimal card recommending system. Further, the storing unit of the terminal 2320 may store contents DB which stores a plurality of contents and information of the terminal 2320. In this case, the content DB includes executing data for executing contents and attributes information of the contents and stores content usage information in accordance with the content performing. The information of the terminal 2320 may include terminal specification information.

Further, the communication unit of the terminal may perform a function for transmitting and receiving data with the application server 2310 through a network. Here, the communication unit of the terminal 2320 may include an RF transmitting unit which increases and amplifies a frequency of a signal transmitted and an RF receiving unit which amplifies the signal. The communication unit of the terminal 2320 may include at least one of a wireless communication module and a wired communication module. Further, the wireless communication module is configured to transmit and receive data according to a wireless communication method. When the terminal 2320 uses wireless communication, data may be transmitted/received to/from the application server 2310 using any one of a wireless network communication module, a wireless LAN communication module, and a wireless PAN communication module. Further, the wired communication module transmits/received data through a wire. The wired communication module accesses a network through a wired to transmit/received data to/from the application server. That is, the terminal accesses the network using a wireless communication module or a wired communication module and transmits/receiver data with the application server 2310 through a network. Specifically, in the network according to the present invention, the terminal 2320, the application server 2310, and the BLE server communicate with each other to transmit/received data required to recommend an optimal card based on the optimal card recommending system.

Further, the control unit of the terminal 2320 may be a processor device which drives an operating system (OS) and each configuration. For example, the control unit may control the entire process to access the application server 2310. When the terminal accesses the application server 2310 through a separate service application, the control unit controls the entire process of performing a service application in accordance with the request of the user and controls to transmit the service using request to the application server 2310. In this case, information of the terminal 2320 required for the user authentication is also transmitted together.

Further, the control unit of the terminal 2320 may perform a specific content stored in the storing unit of the terminal 2320 in accordance with the request of the user. In this case, the control unit may store the content using record in accordance with the content execution as content usage information.

Further, in the terminal 2320, an application 2311 for an application pay service is provided and the user of the terminal 2320 may be a member of the application pay service.

The POS terminal 2330 is a device which performs an offline payment of the product in the store 2360, and performs the offline payment based on communication with the application server 2310.

The BLE server 2340 may be used to find a location of the terminal 2320 using a Bluetooth low energy.

In this case, the Bluetooth low energy is a near field wireless communication technology which periodically transmits information of an object based on Bluetooth 4.0 within a predetermined radius range of the surroundings. That is, even though the user of the terminal 2320 does not take a separate behavior, the position of the user is detected based on the beacon signal which is received by the terminal 2320 so that information for an offline payment service is provided.

In this case, the beacon is a near field data communication technology using a Bluetooth low energy (BLE) and allows various application services such as object and situation recognition based on proximity measurement, content push, indoor position measurement, automatic check-in, or GeoFencing. As compared with the similar technique of the related art, the beacon is more convenience and provides a similar function at a reduced cost so that the beacon functions as a catalyst to form a new service market corresponding to a position based service.

Further, the beacon may refer to any of device which periodically transmits a signal to notify the signal. For example, the BLE device 2350 illustrated in FIG. 23 may be the beacon.

The beacon may be classified into a low frequency beacon based on a sound, an LED beacon, a Wi-Fi beacon, and a Bluetooth beacon, depending on a method of transmitting a signal. Further, the beacon may transmit a periodic signal by a small amount of packet corresponding to approximately 21 bytes, and there is no need to a separate paring with a target which receives the signal. Even though the beacon operates with a low power consumption, the ID value of the beacon transmitter and a signal corresponding to a reception signal intensity may be transmitted to 50 meters at maximum. Further, the beacon is cheap and has a small size so that the beacon may be attached on at anywhere. Therefore, it is possible to be freely used in the offline store.

For example, when a beacon is installed in a specific location of the store and the user who carries the terminal 2320 enters the beacon region, the terminal 2320 may receive the signal transmitted from the beacon,

Further, moving beacon devices corresponding to the mobile terminal or a tablet located in the store 2360 are detected based on the beacon installed in the store 2360 and beacons installed in other stores, and the position of the terminal 2320 is measured based on beacons signals of the moving beacon devices to determine whether the terminal 2320 enters the store.

In this case, the moving beacon devices located in the store 2360 may be a beacon having a narrow signal range as compared with the beacons installed in the other stores and a precise position of the terminal 2320 may be checked based on a time when the terminal 2320 receives a signal from the moving beacon devices.

The store 2360 corresponds to an offline store where the offline payment is performed and may correspond to an application pay agent and an application pay service affiliate in which the BLE device 2350 is installed.

In this case, a fixed beacon is not provided in all stores to use the application pay service but the fixed beacon is provided only in some of stores. In this case, the a position of moving beacon which moves in the store is detected using the fixed beacon to measure the position of the terminal 2320. For example, when several small stores are close to each other, check-in of the terminal 2320 is performed as described above so that a cost for installing the beacon is saved and more precisely check-in of the terminal may be performed.

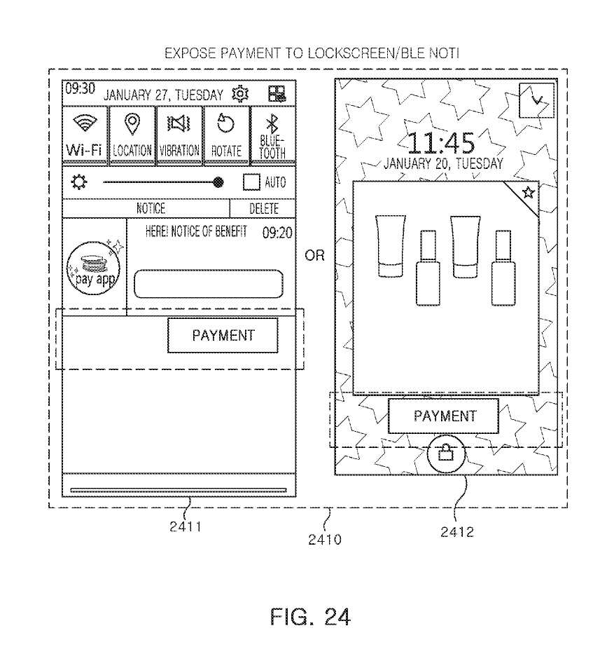

FIGS. 24 to 28 are views illustrating a payment proceeding screen using an offline payment system illustrated in FIG. 23.

Referring to FIGS. 24 to 28, according to an application pay service using the offline payment system illustrated in FIG. 23, a user who carries a terminal may enter the store.

In this case, it is detected that the user enters the store based on the beacon which is a BLE based near field data communication technology.

That is, a terminal in which a Bluetooth is activated receives the BLE signal transmitted from the beacon located in the store. In this case, the BLE signal may be received through an application installed in the terminal based on a BLE SDK.

Next, when the terminal transmits information included in the BLE signal to the BLE server, the BLE server may provide information related with a BLE benefit corresponding to the BLE signal to the terminal.

For example, as illustrated in FIG. 24, the product benefit screen 2410 may be output to the user through an application installed in the terminal.

In this case, the product benefit screen 2410 may include discount information or coupon information corresponding to the store where the user enters. When the terminal is locked, the product benefit screen 2410 may output the discount information and the coupon information together with a payment button on a Lockscreen 2412 of the terminal. Further, the product benefit screen 2410 may output the discount information and the coupon information together with a payment button on a BLE Noti 2411 of the terminal.

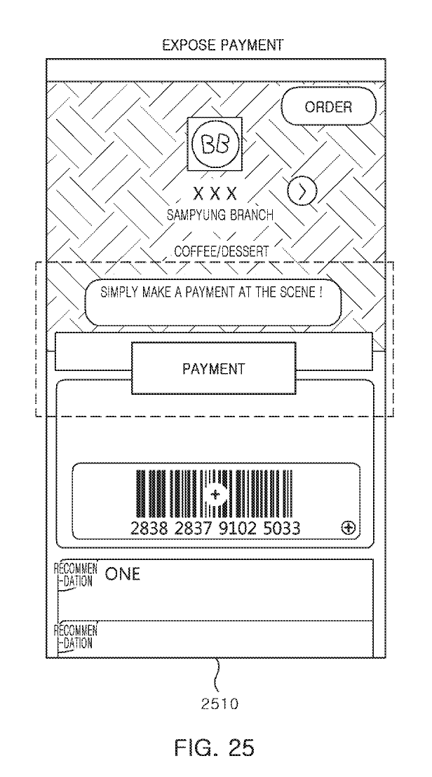

Next, the terminal may access the application server based on the product benefit screen 2410. For example, when the user selects a body area indicating the discount information and the coupon information on the product benefit screen 2410 of the terminal, as illustrated in FIG. 25, a detailed screen 2510 of the store which is provided by the application server may be output to the terminal.

In this case, the detailed screen 2510 of the store may include the information corresponding to the store, detailed discount information and coupon information. Further, a payment button is output through the detailed screen 2510 of the store, so that the user may perform a procedure for offline payment in the store at any time,

Therefore, the application server may include at least one module foe preforming offline payment.

For example, the application server may include a membership providing module which provides membership information based on user information corresponding to the terminal and the store information corresponding to a store where the user enters. In this case, the membership providing module may include a separate database which stores the user member information and store information.

As another example, the application server includes an application pay payment module to perform the payment through the application pay. In this case, the application pay payment module may include credit card information and bank information. That is, when the user purchases the application pay to purchase a product in the store, the application pay may be purchased at real time using a credit card based on the credit card information.

In this case, the application pay payment module may recommend an optimal payment card for the offline payment in consideration of the discount benefit, the store benefit, and accumulation among the credit card which is possessed by the user. For example, an optimal card may be recommended in accordance with the discount rate or accumulation rate by collecting the benefit information provided through the member ship card and benefit information when a target result for a previous month for every credit card is satisfied.

As another example, the application server includes a store information providing module which provides benefit information on the coupon or gift con which can be used by the user in the store or an event or marketing information which currently proceeds, together with the membership information through the membership providing module.

In this case, the store information providing module searches a gifticon or a coupon which can be used by the user in the store through the application to provide the gifticon or coupon to the application server so that the user may use the gifticon or the coupon through the application provided on the terminal. Further, the store information providing module provides event information and marketing information corresponding to a plurality of stores which provides an application pay service to the application server so that the information on the event or marketing which are performed in the store where the user visits is provided to the terminal of the user.

Next, the user which access the application server through the terminal may perform prior authentication based on the application pay service for offline purchasing corresponding to the store.

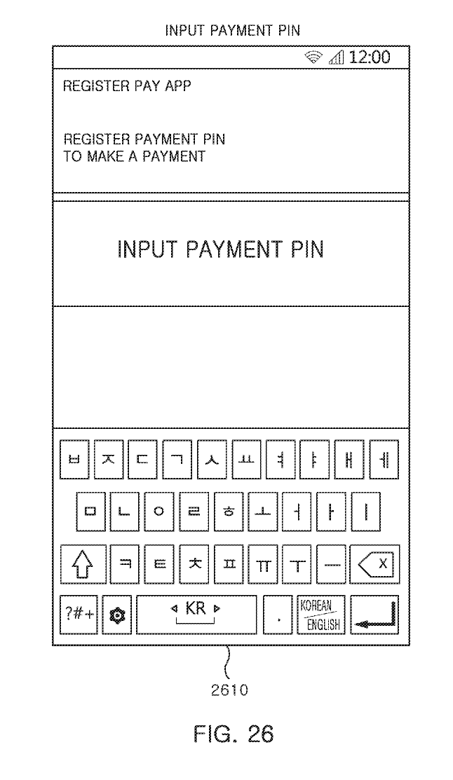

For example, when the user selects the payment button which is output on the detailed screen 2510 of the store or the product benefit screen 2410, as illustrated in FIG. 26, a payment PIN input screen 2610 is output to perform prior authentication corresponding to the purchase in the store. That is, the authentication information for offline payment in the store may be input using a terminal based on the application server which interlocks through the application.

In this case, the prior authentication may be performed using a method for authenticating a picture image gesture or a method for authenticating a touch gesture in addition to a method for inputting a PIN, as illustrated in FIG. 26.

In this case, the application server receives the authentication information input through the terminal to determine whether to perform authentication.

Thereafter, when the prior authentication of the user is completed, the user may moves to the POS terminal 2330 corresponding to the store with the product to be purchased in the store. In this case, the user may perform additional authentication to pay the product.

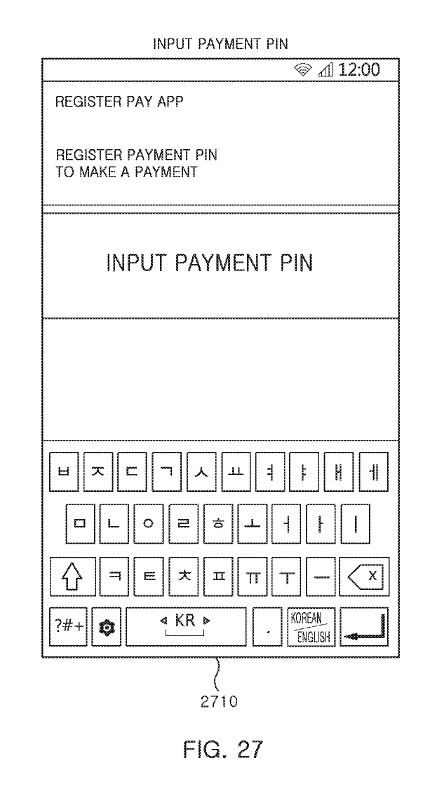

For example, when a product to be purchased by the user is present to the POS terminal 2330 to be recognized, as illustrated in FIG. 27, payment information using an application pay may be output on the payment screen 2710 of the POS terminal 2330 together with the user information in which prior authentication is completed. In this case, a shop assistant compares the information of the user which is output on the POS terminal 2330 and a purchaser who actually purchases the product to perform additional authentication. Alternatively, a method of locating the user who carries the terminal in a payment zone close to the POS terminal 2330, a method for generating a motion gesture pattern using a terminal in the payment zone, a method for inputting a touch pattern on a signature pattern connected to the POS terminal, a method for inputting a cross pattern on the signature pad, and a questioning method based on the user information based on the user information are added to perform additional authentication.

Next, when additional authentication is completed, the payment is performed through the application pay and the application server may notify whether the payment of the application pay is successively performed to the user terminal 2320 and the POS terminal 2330.

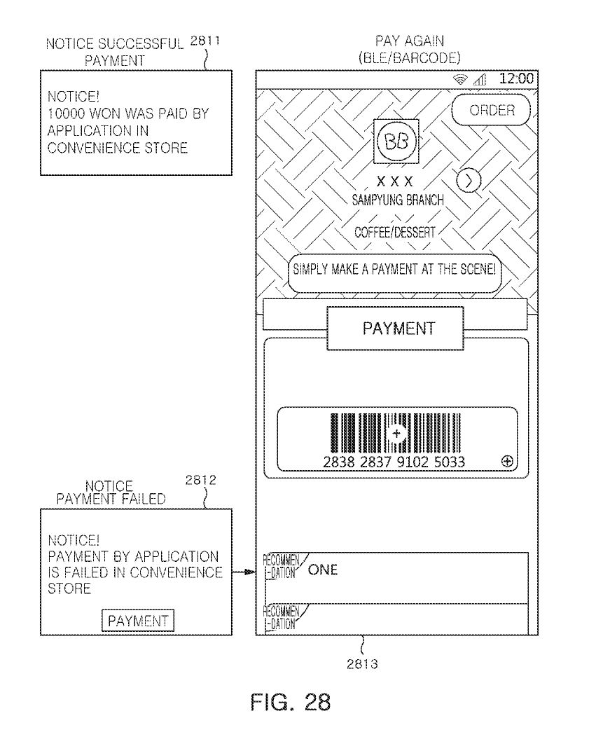

For example, as illustrated in FIG. 28, when the payment using the application pay is successfully performed, a payment success message 2811 is transmitted and when the payment using the application pay fails, a payment failure message 2812 may be transmitted.

In this case, in the payment success message 2811, a name of the store in which the payment is performed, payment means, payment means, and a payment amount are displayed.

In the payment failure message 2812, a payment button for performing the payment is provided. In this case, when the payment button is clicked, the re-payment screen 2013 may be provided to the terminal.

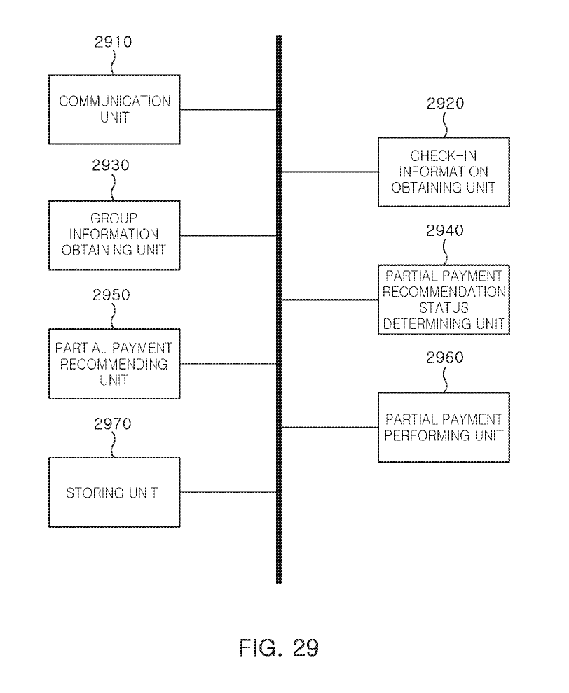

FIG. 29 is a block diagram illustrating an offline partial payment processing device according to an exemplary embodiment of the present invention.

Referring to FIG. 29, the offline partial payment processing device according to an exemplary embodiment of the present invention includes a communication unit 2910, the check-in information obtaining unit 2920, a group information obtaining unit 2930, a partial payment recommending situation determining unit 2940, a partial payment recommending unit 2950, a partial payment performing unit 2960, and a storing unit 2970.

The communication unit 2910 transmits/receives information required to perform the offline partial payment process with the user mobile terminal through a communication network such as a network. Specifically, the communication unit 2910 according to an exemplary embodiment of the present invention receives information needed for beacon signal based check-in and mobile authentication for partial payment from the mobile terminal. Further, the communication unit 2910 provides the mobile terminal with information on results of off-line partial payment.

In this case, information for processing the offline partial payment processing may be received from a separate application server or the POS terminal 2330 which is provided in the store.

The check-in information obtaining unit 2920 obtains check-in information corresponding to the store where the user enters.

In this case, it is detected that the user enters the store based on the beacon which is a BLE based near field data communication technology and check-in information corresponding to the store may be obtained. That is, check-in information of other users who enters the store where the user enters the store may be obtained.

In this case, check-in information of other users for the store where the user enters is obtained so that information of other users who enter the store may be obtained. For example, when check-in information is received from mobile terminals of other users, the information of the mobile terminal of other users is also received. Alternatively, when the other user who checks-in the store is a member of the application pay service, information of other user who checks in through an application may be obtained.

The group information obtaining unit 2930 obtains the group information extracted from the application installed in the mobile terminal of the user.

For example, information corresponding to a social group or a chatting group in which the user is included through a social application or a group chatting application installed in the mobile terminal of the user is extracted to be obtained as group information.

The partial payment recommending situation determining unit 2940 determines whether to necessary the partial payment based on the check-in information and the group information.

That is, it is checked whether users which may use the partial payment corresponding to the group information through the check-in information are in the store together with the user to recommend the partial payment situation.

In this case, when an attendance rate corresponding to a ratio of members who check in the store among the members of group corresponding to the group information is equal to or larger than a predetermined attendance rate, it is determined to be the partial payment recommending situation to the group.

For example, members included in a specific chatting room may be extracted as one group through a chatting application installed in the mobile terminal of the user. In this case, when it is assumed that a predetermined attendance rate is approximately 70% and members included in the chatting room are 10, if seven or more members including the user enter the store, it is determined to be the partial payment recommending situation.

In this case, the predetermined attendance rate may be set in consideration of at least one of a characteristic of the group, the number of members of the group, and an importance of the members.

For example, when the attendance rate is not so high from the characteristic of the group, the predetermined attendance rate is set to be low, to provide the partial payment service to the attending users.

As another example, when the number of members which belong to the group is 5 or smaller, the attendance is measured to be high even though just one or two participate. Therefore, the partial payment is actually effectively recommended.

As another example, when members having a high importance are included in the group, the predetermined attendance rate is increased so that as many as members are attended to recommend the partial payment. That is, when the partial payment is performed, the predetermined attendance rate is set to be high so that a possibility of including the members having a high importance is increased.

In this case, the importance of the member is considered to set a weight of the attendance rate corresponding to the members of the group and the weight of the attendance rate is applied to the members which check-in the store to calculate the present ratio.

For example, four members A1, A2, S3, and A4 included in the group A and 20% of a weight of attendance rate is set to the A1 who is the representative of the group A. In this case, when it is assumed that three of A1, A2, and A3 are check-in in the B store, the attendance rate of A1 is (100×0.25)+(100×0.25%×0.2)=30%. Here, when the attendance rates 25% of the remaining A2 and A3 are included, a final attendance rate obtained by adding a weight of the attendance rate A may be 80%. Therefore, if it is assumed that the predetermined attendance rate is 77%, the remaining three excluding A1 attend, it is not determined that it is a partial payment recommend. When three including A1 attend, it is determined that it is a partial payment recommending situation.

In this case, the group member information corresponding to the members of the group is obtained and the check-in information and the group member information are compared to detect the members who check-in the store.

For example, phone numbers of the mobile terminals corresponding to the members of the group may be obtained as group member information. Next, the phone numbers of the plurality of mobile terminal which check in the store and the group member information may be compared. When there is a phone number of the phone numbers of the plurality of mobile terminals, it is detected that the member corresponding to the matching phone number checks in the store.

In this case, the group member information is extracted from the mobile terminal of the user and corresponds to information obtained through the check in information for the store.

The partial payment recommending unit 2950 recommends the partial payment when it is determined that it is the partial payment recommending situation.

In this case, when the partial payment corresponding to the group is recommended, information of the group and at least one of the members of the group are transmitted to the mobile terminals corresponding to the members of the group to recommend the partial payment. In this case, the store which is recommended for the partial payment, that is, information of the store where the user enters is also transmitted.

For example, when the partial payment for a group B is recommended in the food store, information indicating an application through which the B group recommended for the partial payment is extracted and information of the members which belong to the group B and perform the partial payment are transmitted to the mobile terminal corresponding to the members of group N. Further, information indicating a location where the food store is located and the information of the store are also provided.

The partial payment performing unit 2960 performs mobile authentication corresponding to the members of the group. When the mobile authentication is completed, additional authentication for some of the members of the group is performed to perform the partial payment.

For example, when mobile authentication using the mobile terminals of the members of the group is all completed, the POS terminal 2330 of the store where the partial payment is performed checks that one of the members is the member of the group and additional authentication is performed. In this case, the additional authentication may be performed using the mobile terminal of the member who performs the additional authentication or a sign pad of the POS terminal 2330.

In this case, the mobile authentication may be one of several user authentication methods which may be performed using a mobile terminal. For example, various methods including a PIN input method, or finger print recognition, iris recognition may be used.

In this case, authentication information for mobile authentication may be transmitted to the mobile terminals corresponding to the members of the group.

For example, when the mobile authentication method is a PIN input method, an authentication screen which requests the PIN input is transmitted to the mobile terminal.

The storing unit 2970 stores various information generated during the offline partial payment processing service process as described exemplary embodiment of the present invention.

Depending on the exemplary embodiment, the storing unit 2970 is independently configured from the offline partial payment processing method to support the function for the offline partial payment processing service. In this case, the storing unit 2970 may operate as a separate large quantity of storage and include a control function.

In the offline partial payment processing device, a memory is loaded to store the information in the equipment. In one embodied example, the memory is a computer readable storage medium. In one embodied example, the memory I may be a volatile memory unit and in another embodiment example, the user equipment may be a non-volatile memory unit. In one embodied example, the storing device is a computer readable storage medium. In various different embodied examples, the storing device may include a hard disk device, an optical disk device, or any other of large quantity storing device.

The above-described offline partial payment processing device is used, so that the partial payment situation is quickly recognized when offline payment is performed through the mobile terminal to provide the partial payment service to the user.

Further, when offline payment is performed, it is possible to easily perform the partial payment by performing the authentication using each mobile terminal without directly performing the payment in the POS terminal by all users which participates the partial payment.

Further, primary authentication is performed on the members who perform the partial payment and the POS terminal performs authentication on a part of the members to more safely perform the offline partial payment.

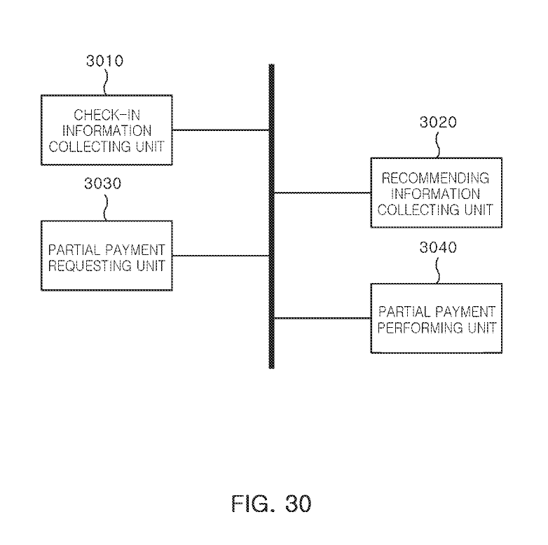

FIG. 30 is a block diagram illustrating a mobile terminal according to an exemplary embodiment of the present invention.

Referring to FIG. 30, the mobile terminal according to the exemplary embodiment of the present invention includes a check-in information collecting unit 3010, a recommending information collecting unit 3020, a partial payment requesting unit 3030, and a partial payment performing unit 3040.

The check-in information collecting unit 3010 obtains check-in information corresponding to the store where the user enters.

In this case, the check-in information may be obtained by using a Bluetooth low energy (BLE) technology, or WiFi or GPS technology. For example, when a user who carries a mobile terminal enters the store, the mobile terminal receives a beacon signal from the BLE beacon device provided in the entrance of the store. In this case, the beacon signal may include check-in signal including information of the store.

Therefore, check-in information corresponding to the user is collected and the store where the user enters is checked, and check-in information corresponding to other users who enter the store, that is, other purchasers may be obtained.

The recommending information collecting unit 3020 receives partial payment recommending information corresponding to the store from the server.

For example, the server may extract one or more groups based on social applications installed in the mobile terminal of the user. In this case, when a predetermined number or more of members of a specific group check in the store where the user enters, recommending information recommending the partial payment is provided to the members of the group.

In this case, the partial payment recommending information may include information on the group who recommends the partial payment, information on the members of the group which participates the partial payment, and information on a store which recommends the partial payment may be included.

The partial payment requesting unit 3030 requests the partial payment corresponding to the partial payment recommending information.

For example, a partial payment requesting button which is transmitted together with the partial payment recommending information is clicked to request the partial payment.

The partial payment performing unit 3040 transmits authentication information for performing the partial payment to the server and receives the partial payment result.

For example, when the partial payment is successfully performed, a payment success message including the name of the store corresponding to the partial payment, a partial payment group, a list of members who participates the partial payment and a partial payment amount may be received. Further, when the partial payment fails, a payment failure message briefly including a failure reason of the partial payment may be received.

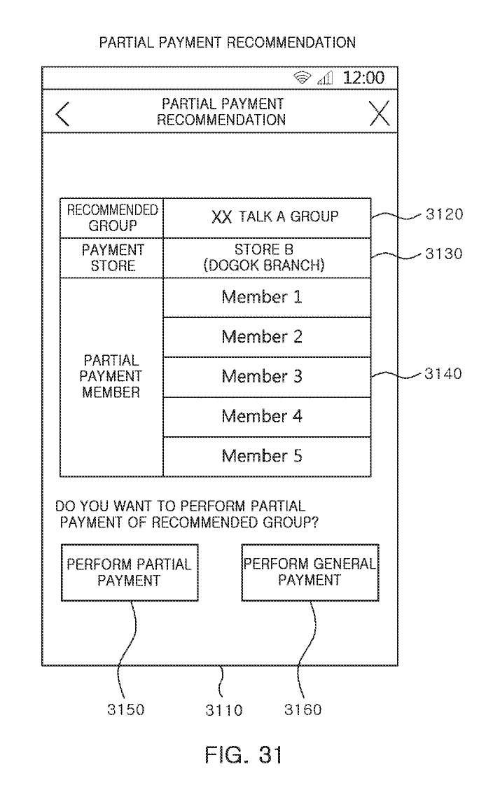

FIG. 31 is a view illustrating a partial payment recommendation screen according to an exemplary embodiment of the present invention.

Referring to FIG. 31, the partial payment recommending screen 3110 according to an exemplary embodiment of the present invention may be transmitted to the mobile terminal of the user from the server to recommend the partial payment.

In this case, on the partial payment recommending screen 3110, as illustrated in FIG. 31, at least one of a partial payment recommending group 3120, a partial payment store 3130, a partial payment group member 3140 may be represented.

In this case, the partial payment group member 3140 corresponds to a member which receives the partial payment recommending screen 3110 from the server.

Further, in the partial payment recommending screen 3110, the partial payment requesting button 3150 may be represented together to allow the user to check the information represented in the partial payment and request the partial payment to the server.

Further, a general payment request button 3160 is also represented to perform a general payment without performing the recommended partial payment.

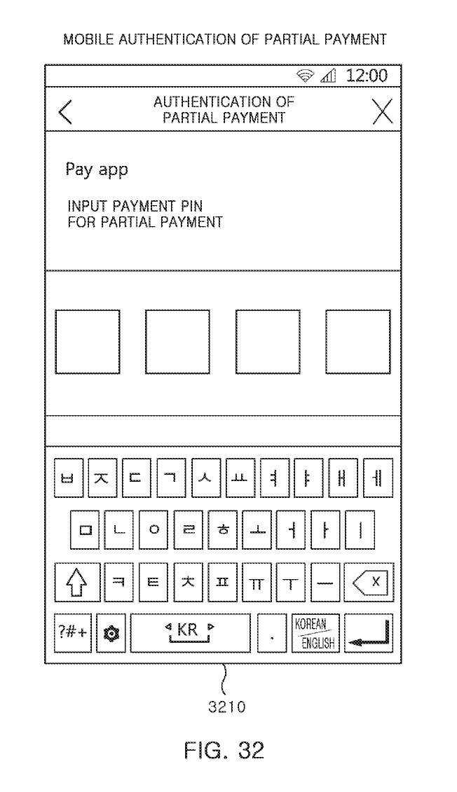

FIG. 32 is a view illustrating a mobile authentication screen when partial payment is performed according to an exemplary embodiment of the present invention.

Referring to FIG. 32, when the partial payment is performed on any one group extracted from the mobile terminal of the user, a mobile authentication screen 3210 may be transmitted to the mobile terminal corresponding to the members of the group.

In this case, the mobile authentication screen 3210 for inputting a PIN, as illustrated in FIG. 32 is transmitted in accordance with the mobile authentication method using the mobile terminal. Further, when the mobile authentication method is a fingerprint authentication method or an iris authentication method, the mobile authentication screen 3210 corresponding to the method is transmitted to the members of the group to perform the mobile authentication.

Further, when all the members of the group which perform the partial payment complete the mobile authentication, additional authentication on the partial payment is performed by some of the members of the group, to complete the partial payment.

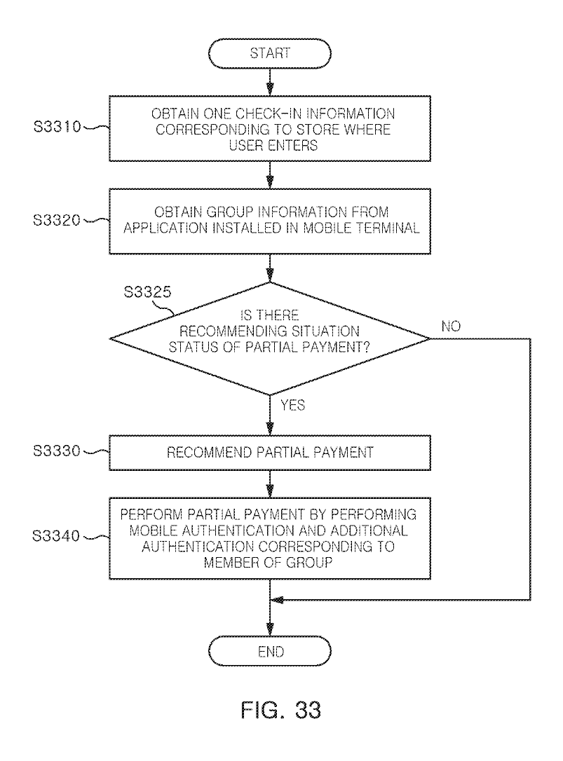

FIG. 33 is a flowchart illustrating an offline partial payment processing method according to a sixth exemplary embodiment of the present invention from a service side.

Referring to FIG. 33, an offline partial payment processing method according to an exemplary embodiment of the present invention obtains check-in information corresponding to a store where the user enters (S3310).

In this case, it is detected that the user enters the store based on the beacon which is a BLE based near field data communication technology and check-in information corresponding to the store may be obtained. That is, check-in information of other users who enters the store where the user enters the store may be obtained.

In this case, check-in information of other users for the store where the user enters is obtained so that information of other users who enter the store may be obtained. For example, when check-in information is received from mobile terminals of other users, the information of the mobile terminal of other users is also received. Alternatively, when the other user who checks-in the store is a member of the application pay service, information of other user who checks in through an application may be obtained.

Further, the offline partial payment processing method according to an exemplary embodiment of the present invention obtains group information extracted from an application installed in the mobile terminal of the user (S3320).

For example, information corresponding to a social group or a chatting group in which the user is included through a social application or a group chatting application installed in the mobile terminal of the user is extracted to be obtained as group information.

Further, the offline partial payment processing method according to the exemplary embodiment of the present invention determines whether it is a partial payment recommending situation which requires the partial payment based on the check-in information and the group information (S3325).

That is, it is checked whether users which may use the partial payment corresponding to the group information through the check-in information are in the store together with the user to recommend the partial payment situation.

In this case, when an attendance rate corresponding to a ratio of members who check in the store among the members of group corresponding to the group information is equal to or larger than a predetermined attendance rate, it is determined to be the partial payment recommending situation to the group.

For example, members included in a specific chatting room may be extracted as one group through a chatting application installed in the mobile terminal of the user. In this case, when it is assumed that a predetermined attendance rate is approximately 70% and members included in the chatting room are 10, if seven or more members including the user enter the store, it is determined to be the partial payment recommending situation.

In this case, the predetermined attendance rate may be set in consideration of at least one of a characteristic of the group, the number of members of the group, and an importance of the members.

For example, when the attendance rate is not so high from the characteristic of the group, the predetermined attendance rate is set to be low, to provide the partial payment service to the attending users.

As another example, when the number of members which belong to the group is 5 or smaller, the attendance is measured to be high even though just one or two participate. Therefore, the partial payment is actually effectively recommended.

As another example, when members having a high importance are included in the group, the predetermined attendance rate is increased so that as many as members are attended to recommend the partial payment. That is, when the partial payment is performed, the predetermined attendance rate is set to be high so that a possibility of including the members having a high importance is increased.

In this case, the importance of the member is considered to set a weight of the attendance rate corresponding to the members of the group and the weight of the attendance rate is applied to the members which check-in the store to calculate the present ratio.

For example, four members A1, A2, S3, and A4 included in the group A and 20% of a weight of attendance rate is set to the A1 who is the representative of the group A. In this case, when it is assumed that three of A1, A2, and A3 are check-in in the B store, the attendance rate of A1 is (100×0.25)+(100×0.25%×0.2)=30%. Here, when the attendance rates 25% of the remaining A2 and A3 are included, a final attendance rate obtained by adding a weight of the attendance rate A may be 80%. Therefore, if it is assumed that the predetermined attendance rate is 77%, the remaining three excluding A1 attend, it is not determined that it is a partial payment recommend. When three including A1 attend, it is determined that it is a partial payment recommending situation.

In this case, the group member information corresponding to the members of the group is obtained and check-in information and the group member information are compared to detect the members who checks in the store.

For example, phone numbers of the mobile terminals corresponding to the members of the group may be obtained as group member information. Next, the phone numbers of the plurality of mobile terminal which check in the store and the group member information may be compared. When there is a phone number of the phone numbers of the plurality of mobile terminals, it is detected that the member corresponding to the matching phone number checks in the store.

In this case, the group member information is extracted from the mobile terminal of the user and corresponds to information obtained through the check in information for the store.

When it is the partial payment recommending situation as a determination result of step S3325, the partial payment is recommended (S3330).

In this case, when the partial payment corresponding to the group is recommended, information of the group and at least one of the members of the group are transmitted to the mobile terminals corresponding to the members of the group to recommend the partial payment. In this case, the store which is recommended for the partial payment, that is, information of the store where the user enters is also transmitted.

For example, when the partial payment for a group B is recommended in the food store, information indicating an application through which the B group recommended for the partial payment is extracted and information of the members which belong to the group B and perform the partial payment are transmitted to the mobile terminal corresponding to the members of group N. Further, information indicating a location where the food store is located and the information of the store are also provided.

The offline partial payment processing method according to the exemplary embodiment of the present invention performs mobile authentication corresponding to the members of the group. When the mobile authentication is completed, additional authentication for some of the members of the group is performed to perform the partial payment (S3340).

For example, when mobile authentication using the mobile terminals of the members of the group is all completed, the POS terminal 2330 of the store where the partial payment is performed checks that one of the members is the member of the group and additional authentication is performed. In this case, the additional authentication may be performed using the mobile terminal of the member who performs the additional authentication or a sign pad of the POS terminal 2330.

In this case, the mobile authentication may be one of several user authentication methods which may be performed using a mobile terminal. For example, various methods including a PIN input method, or finger print recognition, iris recognition may be used.

In this case, authentication information for mobile authentication may be transmitted to the mobile terminals corresponding to the members of the group.

For example, when the mobile authentication method is a PIN input method, an authentication screen which requests the PIN input is transmitted to the mobile terminal.

Further, when it is not the partial payment recommending situation as a determination result of step S3325, the partial payment is not recommended and the procedure ends.

Further, even though not illustrated in FIG. 33, the offline partial payment processing method according to the exemplary embodiment of the present invention transmits/receives necessary information to perform the offline partial payment processing with the mobile terminal of the user through a communication network such as a network. Specifically, the method receives information needed for beacon signal based check-in and mobile authentication for partial payment from the mobile terminal. Further, the method provides the mobile terminal with information on results of off-line partial payment.

In this case, information for processing the offline partial payment processing may be received from a separate application server or the POS terminal 2330 which is provided in the store.

Further, even though not illustrated in FIG. 33, the offline partial payment processing method according to the exemplary embodiment of the present invention stores various information generated during the offline partial payment processing service process according to the exemplary embodiment of the present invention.

Depending on the exemplary embodiment, a storing module which stores information is independently configured from the offline partial payment processing method to support the function for the offline partial payment processing service. In this case, the storing module may operates as a separate large quantity of storage and include a control function.

According to the above-described offline partial payment processing method, the partial payment situation is quickly recognized when offline payment is performed through the mobile terminal to provide the partial payment service to the user.

Further, when offline payment is performed, it is possible to easily perform the partial payment by performing the authentication using each mobile terminal without directly performing the payment in the POS terminal by all users which participates the partial payment.

Further, primary authentication is performed on the members who perform the partial payment and the POS terminal performs authentication on a part of the members to more safely perform the offline partial payment.

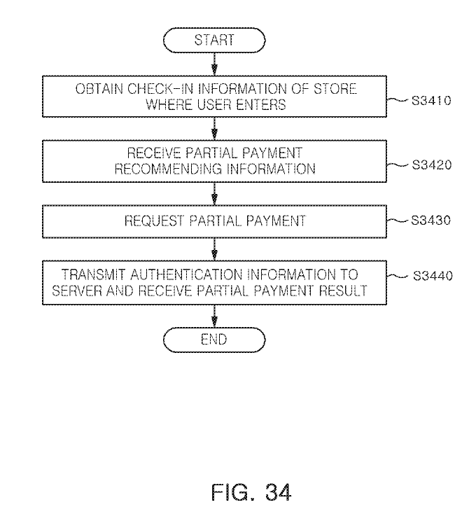

FIG. 34 is an operation flowchart illustrating an offline partial payment processing method according to a seventh exemplary embodiment of the present invention from a terminal side.

Referring to FIG. 34, an offline partial payment processing method according to an exemplary embodiment of the present invention obtains check-in information corresponding to a store where the user enters (S3410).

In this case, the check-in information may be obtained by using a Bluetooth low energy (BLE) technology, or WiFi or GPS technology. For example, when a user who carries a mobile terminal enters the store, the mobile terminal receives a beacon signal from the BLE beacon device provided in the entrance of the store. In this case, the beacon signal may include check-in signal including information of the store.

Therefore, check-in information corresponding to the user is collected and the store where the user enters is checked, and check-in information corresponding to other users who enter the store, that is, other purchasers may be obtained.

Further, the offline partial payment processing method according to the exemplary embodiment of the present invention receives partial payment recommending information corresponding to the store from the server (S3420).

For example, the server may extract one or more groups based on social applications installed in the mobile terminal of the user. In this case, when a predetermined number or more of members of a specific group check in the store where the user enters, recommending information recommending the partial payment is provided to the members of the group.

In this case, the partial payment recommending information may include information on the group who recommends the partial payment, information on the members of the group which participates the partial payment, and information on a store which recommends the partial payment may be included.

Further, the offline partial payment processing method according to the exemplary embodiment of the present invention requests partial payment corresponding to partial payment recommending information (S3430).

For example, a partial payment requesting button which is transmitted together with the partial payment recommending information is clicked to request the partial payment.

Further, the offline partial payment processing method according to the exemplary embodiment of the present invention transmits the authentication information for performing partial payment to the server and receives the result of the partial payment (S3440).

For example, when the partial payment is successfully performed, a payment success message including the name of the store corresponding to the partial payment, a partial payment group, a list of members who participates the partial payment and a partial payment amount may be received. Further, when the partial payment fails, a payment failure message briefly including a failure reason of the partial payment may be received.

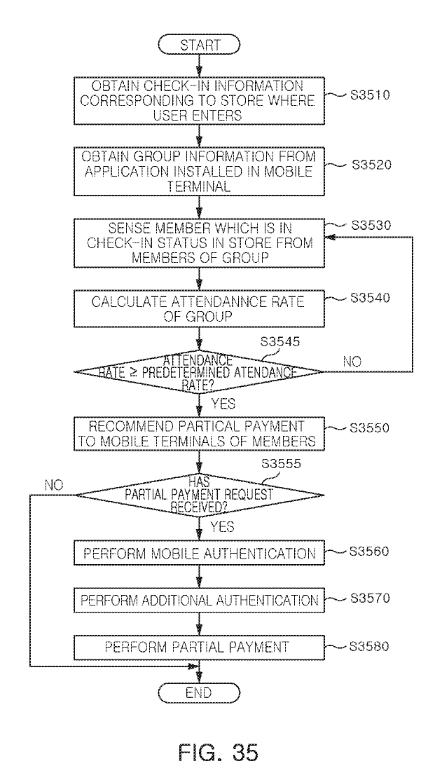

FIG. 35 is a detailed flowchart illustrating an offline partial payment processing method according to an eighth exemplary embodiment of the present invention from a service side.

Referring to FIG. 35, an offline partial payment processing method according to an exemplary embodiment of the present invention obtains check-in information corresponding to a store where the user enters (S3510).

In this case, it is detected that the user enters the store based on the beacon which is a BLE based near field data communication technology and check-in information corresponding to the store may be obtained. That is, check-in information of other users who enters the store where the user enters the store may be obtained.

In this case, check-in information of the users is obtained so that information on other users who enter the store is obtained. For example, when check-in information is received from mobile terminals of other users, the information of the mobile terminal of other users is also received. Alternatively, when the other user who checks-in the store is a member of the application pay service, information of other user who checks in through an application may be obtained.

Next, group information extracted from an application installed in a mobile terminal of the user is obtained (S3520).

For example, information corresponding to a social group or a chatting group in which the user is included through a social application or a group chatting application installed in the mobile terminal of the user is extracted to be obtained as group information.

Next, a member who checks in the store where the user enters is detected among members of a group corresponding to the group information (S3530).

In this case, the group member information corresponding to the members of the group is obtained and check-in information and the group member information are compared to detect the members who checks in the store.

For example, phone numbers of the mobile terminals corresponding to the members of the group may be obtained as group member information. Next, the phone numbers of the plurality of mobile terminal which check in the store and the group member information may be compared. When there is a phone number of the phone numbers of the plurality of mobile terminals, it is detected that the member corresponding to the matching phone number checks in the store.

In this case, the group member information is extracted from the mobile terminal of the user and corresponds to information obtained through the check in information for the store.

Next, an attendance rate of one or more groups is calculated based on members detected to check in the store (S3540).

In this case, the importance of the member is considered to set a weight of the attendance rate corresponding to the members of the group and the weight of the attendance rate is applied to the members which check-in the store to calculate the present ratio.

For example, four members A1, A2, S3, and A4 included in the group A and 20% of a weight of attendance rate is set to the A1 who is the representative of the group A. In this case, when it is assumed that three of A1, A2, and A3 are check-in in the B store, the attendance rate of A1 is (100×0.25)+(100×0.25%×0.2)=30%. Here, when the attendance rates 25% of the remaining A2 and A3 are included, a final attendance rate obtained by adding a weight of the attendance rate A may be 80%. Therefore, if it is assumed that the predetermined attendance rate is 77%, the remaining three excluding A1 attend, it is not determined that it is a partial payment recommend. When three including A1 attend, partial payment may be recommended.

Next, it is determined whether the attendance rate of the group corresponding to the group information is equal to or higher than a predetermined attendance rate of the group (S3545).

In this case, the predetermined attendance rate may be set in consideration of at least one of a characteristic of the group, the number of members of the group, and an importance of the members.

For example, when the attendance rate is not so high from the characteristic of the group, the predetermined attendance rate is set to be low, to provide the partial payment service to the attending users.

As another example, when the number of members which belong to the group is 5 or smaller, the attendance is measured to be high even though just one or two participate. Therefore, the partial payment is actually effectively recommended.

As another example, when members having a high importance are included in the group, the predetermined attendance rate is increased so that as many as members are attended to recommend the partial payment. That is, when the partial payment is performed, the predetermined attendance rate is set to be high so that a possibility of including the members having a high importance is increased.

When the attendance rate of the group corresponding to the group information is lower than a predetermined attendance rate of the group as the determination result of step (S3545), it is continuously detected whether the members of the group check in the store where the user enters.

Further, when the attendance rate of the group corresponding to the group information is equal to or higher than a predetermined attendance rate of the group as the determination result of step (S3545), it is determined that it is a partial payment recommending situation and the partial payment is recommended to the mobile terminal of the members of the group (S3550).

In this case, information of the group and at least one of the members of the group are transmitted to the mobile terminals corresponding to the members of the group to recommend the partial payment. In this case, the store which is recommended for the partial payment, that is, information of the store where the user enters is also transmitted.

For example, when the partial payment for a group B is recommended in the food store, information indicating an application through which the B group recommended for the partial payment is extracted and information of the members which belong to the group B and perform the partial payment are transmitted to the mobile terminal corresponding to the members of group N. Further, information indicating a location where the food store is located and the information of the store are also provided.

Next, it is determined whether to receive the partial payment request from the group which recommends the partial payment (S3555). That is, it is determined that at least one of the members of the group which recommends the partial payment checks the recommended partial payment information and requests the partial payment.

When the partial payment request is not received as the determination result of step (S3555), the proceeding partial payment may be stopped.

For example, when the members of the group which recommends the partial payment checks out from the store without receiving the partial payment request, the partial payment may not be performed.

As another example, when the partial payment request is not received until a predetermined time has elapsed after recommending the partial payment, the partial payment may not be performed.

Further, when the partial payment request is received as the determination result of step (S3555), the mobile authentication for the partial payment is performed (S3560).

In this case, the mobile authentication may be performed using a mobile terminal of the members of the group which performs the partial payment.

In this case, the authentication information or the authentication screen for mobile authentication may be transmitted to the mobile terminal of the members of the group which performs the partial payment.

For example, when it is assumed that the mobile authentication method is a PIN input method, an authentication screen for inputting a PIN may be transmitted to the mobile terminal of the members of the group. In this case, the mobile authentication method may use all methods which may be performed through the mobile terminal. That is, the mobile authentication through fingerprint recognition or iris recognition using a mobile terminal may be performed.

Next, when mobile authentication for all members of the group which recommends the partial payment is completed, additional authentication for the partial payment is performed (S3570).

In this case, the additional authentication may be performed by some of the members of the group which recommends the partial payment.

For example, a POS terminal 2330 of the store which performs the partial payment checks that any one of the members is the member of the group and performs the authentication. In this case, the additional authentication may be performed using the mobile terminal of the member who performs the additional authentication or a sign pad of the POS terminal 2330.

In this case, the additional authentication may be performed when the mobile authentication is completed.

Next, when the additional authentication is completed, the partial payment is performed (S3580).

In this case, the result of the partial payment may be transmitted to the members of the group which performs the partial payment.

For example, when the partial payment is successfully performed, a payment success message including the name of the store corresponding to the partial payment, a partial payment group, a list of members who participates the partial payment and a partial payment amount may be transmitted to the members of the group which performs the partial payment.

As another example, when the partial payment fails, a payment failure message briefly including a failure reason of the partial payment may be transmitted to the members of the group which performs the partial payment.

The user equipment, the service providing device, the POS terminal, and the payment system including the same according to the embodiment of the present invention may be prepared with a computer program, and codes and code segments configuring the computer program may easily deduced by a computer programmer in the art. Further, the corresponding computer program is stored in a non-transitory computer readable storage medium, and read and executed by the computer or the user equipment, the beacon, the service providing device, the POS terminal, and the payment server according to the exemplary embodiment of the present invention to implement the user equipment, the service providing device, the POS terminal, and the payment system including the same.

The non-transitory computer readable storage medium includes a magnetic storage medium, an optical storage medium, and a carrier wave medium. The computer program implementing the user equipment, the service providing device, the POS terminal, and the payment system including the same according to the embodiment of the present invention may be stored and installed in embedded memories of the user equipment, the beacon, the service providing device, the POS terminal, and the payment server. Alternatively, external memories such as a smart card storing and installing the computer program implementing the user equipment, the service providing device, the POS terminal, and the payment system including the same according to the embodiment of the present invention may be installed on the user equipment, the beacon, the service providing device, the POS terminal, and the payment server through an interface.

As described above, when the partial payment is performed, after making a payment by user equipment which is carried by the representative payer, the remaining participants accurately provide the allotments to the representative payer and a user who is not a member of the related service may also participate the partial payment so that the partial payment service may be invigorated.

According to the present invention, it is possible to divide points generated according to representative payment to transmit the divided points to the participants, so that all participants who participate the partial payment satisfy.

According to the present invention, it is possible to allow remaining participants for representative payment of partial payment to transmit allotments to a temporary account prior to actual payment and transmit the collected total allotments to a representative payer when the representative payer actually makes a payment. Therefore, the usage of the partial payment may be promoted.

According to the present invention, it is possible to allow a service providing device including payment means information for a user who participates partial payment to recommend an optimal partial payment method in consideration of a benefit for every payment means and an allotment for every participant when the partial payment is performed. Therefore, actual payment cost discount benefit may be achieved and satisfaction of the user may be enhanced.

According to the present invention, it is possible to readjust an allotment for every participant which is set in advance according to payment means related with a plurality of user equipment which participates partial payment when partial payment is performed or allow one or more user equipment which is a representative payer to make a payment as a representative and allow the remaining participants to transmit allotments (or adjusted allotments) to which a discounted amount is applied to the one or more user equipment which is the representative payer. Therefore, a benefit which may not be allowed when the allotment for every participant is distributed may be provided.

According to the present invention, when a user who carries user equipment visits a store, provide a check-in service for visiting the store by a service providing device, and when all user equipment of a group including the user equipment visit the store, perform a product recommending function, a promotion information providing function based on previous purchase records of the group. Therefore, not only the personal check-in status, but also a group heck-in status is checked to perform the group check-in so that a separate service for the group is provided, thereby increasing a marketing effect and increasing a convenience and satisfaction of the user.

According to the present invention, it is possible to effectively select participants which participate partial payment among information on users who actually visit the store when partial payment is performed, so that participants of the partial payment service may be easily selected.

According to the present invention, it is possible to display information on one or more user equipment on a phone book of the user equipment among a plurality of user equipment which is in a check-in status in a store when partial payment is performed, register the user equipment as partial payment participants for partial payment by interlocking with at least one user equipment selected from one or more displayed user equipment, collect an allotment for every participant from users who participate the partial payment when the partial payment is performed in a service providing device, collects payment means information which is issued in advance for every user equipment which is a user, and perform a payment function according to the allotment for every participant and payment means information for every participant by interlocking with the user equipment, a POS terminal, and a payment server. Therefore, a user in the phone book of the user equipment among the users who visit the store and other user located in the same beacon area are filtered so that the number of user lists is reduced so that it is easy to select the participants.

Hereinabove, although the present invention is described by specific matters such as concrete components, and the like, embodiments, and drawings, they are provided only for assisting in the entire understanding of the present invention. Therefore, the present invention is not limited to the embodiments. Various modifications and changes may be made by those skilled in the art to which the present invention pertains from this description. Therefore, the spirit of the present invention should not be limited to the above-described embodiments and the following claims as well as all modified equally or equivalently to the claims are intended to fall within the scope and spirit of the invention.

According to the present invention, when the partial payment is performed, after making a payment by user equipment which is carried by the representative payer, the remaining participants accurately provide the allotments to the representative payer and a user who is not a member of the related service may also participate the partial payment, thereby invigorating the partial payment service. Therefore, the present invention may be widely applied in a simple payment field, an advertisement field, a service providing device field, a user equipment field, a POS terminal field, a payment server field, and a partial payment field.

What is claimed is:

1. A payment system, comprising:
a POS terminal which transmits information on one or more products to be paid and identification information of the POS terminal when partial payment for one or more products is performed;
a service providing device which performs partial payment participating registration procedure for a plurality of user equipment which participates partial payment, creates a temporary account for partial payment, sets an allotment for every participant based on a total payment amount for one or more products to be paid and the number of the plurality of user equipment which participates the partial payment, and transmits the allotment for every participant and information on the temporary account to the plurality of user equipment which participates the partial payment; and
the plurality of user equipment which transmits the allotment set for every participant to the temporary account based on the allotment for every participant and the information on the temporary account transmitted from the service providing device.

2. The payment system according to claim 1, wherein the temporary account is one or more accounts of an account through which predetermined points commonly used in a plurality of predetermined sites are received, an account through which cash is transferred, and an account through which points and/or cash are received.

3. The payment system according to claim 1, wherein the allotment for every participant is set through any one of an equally splitting method, a method for registering for every user equipment at the time of partial payment participating registration, and a method for setting for every user equipment after checking an actual payment amount.

4. The payment system according to claim 1, wherein the service providing device transmits the information on the allotment for every participant and the temporary account to the user equipment which is not a member of the service providing device from the plurality of user equipment in the form of a text message, based on identification information of the user equipment corresponding to the non-member.

5. The payment system according to claim 1, wherein the allotment includes at least one of points and cash available in a predetermined specific site.

6. The payment system according to claim 1, wherein when all actual payment amount is collected to the temporary account, the service providing device transmits one or more benefit information, a recommended card list including one or more recommended cards, one or more product information to be paid, and an actual payment amount, which can be provided to the payment representing user equipment, to the payment representing user equipment which is set from the plurality of user equipment, and
the payment representing user equipment receives a payment card type in accordance with user input and a PIN number corresponding to the payment card type and transmits the payment card type, the PIN number, and identification information of the payment representing user equipment.

7. The payment system according to claim 6, wherein the service providing device checks the card information, user information, and benefit information, corresponding to the PIN number transmitted from the payment representing user equipment and transmits the one or more product information to be paid, the actual payment amount, and the card information, the user information, and the benefit information corresponding to the PIN number, and
the payment server performs a payment function on the actual payment amount corresponding to one or more product information to be paid based on the card information, the user information, and the benefit information and transmits a payment function performed result and accumulated points accumulated in accordance with performing of the payment function to the service providing device.

8. The payment system according to claim 7, wherein the service providing device transmits the payment function performed result to the plurality of user equipment which participates the partial payment and distributes the accumulated points based on the allotment for every participant when accumulated points accumulated in accordance with the performing of the payment function are generated.

9. A control method of a payment system, the method comprising:
transmitting information on one or more products to be paid and identification information of a POS terminal when partial payment for one or more products is performed, by means of the POS terminal;
performing a partial payment participating registration procedure by interlocking with a service providing device, by means of a plurality of user equipment;
creating a temporary account for partial payment, by means of the service providing device;
setting an allotment for every participant, based on a total payment amount for one or more products to be paid and the number of a plurality of user equipment which participates partial payment, by means of the service providing device;
transmitting the allotment for every participant and information on the temporary account to the plurality of user equipment which participates partial payment, by means of the service providing device; and
transmitting the allotment set for every participant to the temporary account based on the allotment for every participant and the information on the temporary account by means of the plurality of user equipment.

10. The method according to claim 9, further comprising:
when all actual payment amount is collected to the temporary account, transmitting one or more benefit information, a recommended card list including one or more recommended cards, one or more product information to be paid, and an actual payment amount, which can be provided to the payment representing user equipment, to the payment representing user equipment which is set from the plurality of user equipment, by means of the service providing device;
receiving a payment card type in accordance with user input and a PIN number corresponding to the payment card type, by means of the payment representing user equipment;
transmitting the payment card type, the PIN number, and identification information of the payment representing user equipment, by means of the payment representing user equipment;
checking the card information, user information, and benefit information, corresponding to the PIN number transmitted from the payment representing user equipment, by means of the service providing device;
transmitting one or more product information to be paid, the actual payment amount, and the card information, the user information, and the benefit information, corresponding to the PIN number, to a payment server, by means of the service providing device;
performing a payment function on the actual payment amount corresponding to the product information to be paid based on the card information, the user information, and the benefit information, by means of the payment server;
transmitting a payment function performed result and accumulated points accumulated in accordance with performing of a payment function to the service providing device, by means of the payment server;
transmitting the payment function performed result to the plurality of user equipment which participates the partial payment, by means of the service providing device;
providing the collected actual payment amount to the representative payment user equipment, by means of the service providing device; and
distributing the accumulated points based on the allotment for every participants when accumulated points accumulated in accordance with performing of a payment function is generated, by means of the service providing device.

11. A non-transitory computer readable storage medium storing a computer program recorded thereon configured to perform the method according to claim 9.

12. A non-transitory computer readable storage medium storing a computer program recorded thereon configured to perform the method according to claim 10.
